(19) United States
(12) Patent Application Publication
(10) Pub. No.: US 2015/0329808 A1
(43) Pub. Date: Nov. 19, 2015

(54) Remotely Operable And Self-Automated Beer Brewing System

(71) Applicant: Justin Ramsey, Vista, CA (US)

(72) Inventor: Justin Ramsey, Vista, CA (US)

(73) Assignee: Justin Ramsey, Vista, CA (US)

(21) Appl. No.: 14/278,175

(22) Filed: May 15, 2014

(51) Int. Cl. C12C 7/06; C12C 13/10; C12C 7/14; C12C 11/00

(52) U.S. Cl. CPC C12C 7/06; C12C 11/006; C12C 13/10; C12C 7/14

(57) ABSTRACT

The present disclosure provides a system and method for automatically brewing beer in a three-vessel system. The system comprises valves, flow-rate restrictors, pumps, various heating elements, a hot liquor tank, a mash tun, a boil kettle, a fermenter, and other elements for dispensing and collecting liquid, chiller plates, etc. All these elements are electrically inter-connected to each other and can be remotely operated. A person of ordinary skill in the art will recognize that there are various ways in which said elements can be electrically inter-connected and operated. In at least one embodiment, a system is shown in which beer is automatically brewed from the step in which heated water from the hot liquor tank is mixed with grains in the mash tun, to where the mixture of boiled, hopped, then cooled beer wort is transferred from the boil kettle to the fermenter.

### FIELD OF THE DISCLOSURE

This present disclosure concerns a method and apparatus for brewing beer. More specifically, the disclosure covers the field of automatic brewing of beer in a three vessel brew system. A goal of the disclosure is to enable a novice in beer-brewing to be able to brew a myriad of beers without deeply engaging in the intricacies of the brewing process, but still be able to produce high quality beer.

### BACKGROUND OF THE DISCLOSURE

Typically, all grain brewing is accomplished in a 3 or 4 vessel system. If a 3 vessel system is used, vessel 1 is the water tank, vessel 2 is the mash and lauter tun, and vessel 3 is the boil kettle. Accordingly, first water is preheated in vessel 1 (hot liquor tank), then the preheated water and crushed grain is added to the mash tun. Grains have been malted before the brewer ever sees them, and the grains are crushed to expose the grain contents to the water in the mash tun. Conversion of grain starches to fermentable grain sugars is accomplished in the mash tun through the various time and temperature rests specifically selected to achieve the desired characteristics of the beer. The resulting sugary water (i.e., the wort) is then filtered from the grains and any residual grain sugars are rinsed off the grains with fresh hot water; a process called lautering or sparging. These rinses are then collected into the boil kettle and boiled. Hop additions occur at various times throughout the 60 to 90 minute boil.

In view of the excess time and labor requirements, attempts in the past have been made to ease the process of brewing beer, while not compromising on the final beer product. Conventional brewing apparati seek to achieve a closed, single-vessel brewing process, which protects the fermentable product from oxidation and microbial contamination. However, many of the traditional beer brewing processes are not possible with the aforementioned brewing apparatus. This and other conventional home brewing apparati also require the user to be present through the majority of the brewing cycle to monitor and adjust vessel temperatures/turn heat sources on and off, open and close valves, set and reset timers, and turn pumps on and off. In this way, since the user (or brewer) is fully responsible for executing the entire brewing process, human error and other extraneous variables are introduced leading to beer batch-to-batch variance resulting in an inconsistent final beer product. Full automation of the entire brewing process would allow the user (or brewer) to simply program the desired brewing cycle into a recipe file, upload the recipe file to the automation controller, add the grains to the mash tun, and allow the automation controller to execute the entire brewing cycle with the utmost precision, accuracy, and repeatability without any human intervention. Additionally, technologies exist that allow such an automation controller to be monitored off-site or from a remote location. However, this level of automation of the brewing cycle and the remote monitoring of such an automated system has yet to be seen in the aforementioned conventional brewing apparati.

Thus, there exists a need for a beer brewing apparatus that does not have the aforementioned limitations, can be automatically controlled, and can be remotely monitored.

### SUMMARY OF THE DISCLOSURE

The present disclosure overcomes these and other aforementioned deficiencies in the existing technologies by providing a traditional three-vessel brewing apparatus that is automated and can be remotely monitored.

The present disclosure provides a cost-effective and efficient automated beer brewing system for producing beer with desired characteristics in a three-vessel system.

In an exemplary embodiment, an automated beer brewing system comprises a hot liquor tank comprising a tank inlet and a tank outlet, wherein said hot liquor tank comprises a means for heating liquid; a mash tun comprising a tun inlet and a tun outlet; wherein said mash tun optionally comprises a means for heating liquid; a boil kettle comprising a kettle inlet and a kettle outlet, wherein said boil kettle comprises a means for heating liquid; a valve 3 comprising an inlet in fluid communication with said hot liquor tank outlet, and further comprising an outlet in fluid communication with a pump 1; a valve 5 comprising an inlet in fluid communication with said pump 1, and further comprising an outlet in fluid communication with said hot liquor tank inlet; a valve 7 comprising an inlet in fluid communication with a valve 6 and a valve 10, and further comprising an outlet in fluid communication with said mash tun inlet; a valve 11 comprising an inlet in fluid communication with said mash tun outlet, and further comprises an outlet in fluid communication with a pump 2; wherein said valve 10 comprises an inlet in fluid communication with said pump 2, and further comprises an outlet in fluid communication with said valve 7; wherein said valve 6 comprises an inlet in fluid communication with said pump 1, and further comprises an outlet in fluid communication with said valve 7; a heat exchanger located between said valve 7 and said mash tun inlet, said heat exchanger containing means for heating beer wort; wherein said pump 1 disposed between the outflow side of said valve 3 and the inflow side of said valves 5 and 6; a valve 16 comprising an inlet in fluid communication with said pump 2, and further comprising an outlet in fluid communication with said boil kettle inlet; a valve 13 comprising an inlet in fluid communication with said boil kettle outlet, and further comprising an outlet in fluid communication with said pump 2; a fermenter comprising a fermenter inlet, a fermenter outlet, and a means for fermenting beer wort with yeast; a valve 15 comprising an inlet in fluid communication with said boil kettle outlet, and further comprising an outlet in fluid communication with said fermenter inlet; wherein said pump 2 is disposed between the outflow sides of said valves 11 and 13, and the inflow sides of said valves 10 and 16; a first T-connection comprising: (i) an inlet from the output of said pump 1, (ii) a first outlet to the input of said valve 5, and (iii) a second outlet to the input of said valve 6; a second T-connection comprising: (i) an inlet from the output of said pump 2, (ii) a first outlet to the input of said valve 10, and (iii) a second outlet to the input of said valve 16; a third T-connection comprising: (i) an inlet from the output of said boil kettle outlet, (ii) a first outlet to the input of said valve 13, and (iii) a second outlet to the input of said valve 15; a fourth T-connection comprising: (i) a first inlet from the output of said valve 11, (ii) a second inlet from the output of said valve 13, (iii) an outlet connected to the input of said pump 2; and a fifth T-connection comprising: (i) a first inlet from the output of said valve 6, (ii) a second inlet from the output of said valve 10, and (iii) an outlet connected to the input of said valve 7; wherein said hot liquor tank, mash tun, boil kettle, valves and pumps are all electrically interconnected to a power source.

In another exemplary embodiment of the automated beer brewing system, said liquid in said hot liquor tank is heated; said valve 3 is open, providing a fluid flow path from said hot liquor tank outlet to said pump 1; said pump 1 pumps said liquid to said inlet of valve 5; said valve 5 is open, providing a fluid flow path from said outlet of valve 5 to said hot liquor tank inlet; said valves 6, 7, 10,11, 13, 15, and 16 are closed and said pump 2 is off, providing a recirculating fluid flow path from said hot liquor tank outlet to said hot liquor tank inlet.

In another exemplary embodiment of the automated beer brewing system, said valve 3 is open, providing a fluid flow path from said hot liquor tank outlet to said pump 1; said pump 1 pumps said liquid to said inlet of valve 6; said valve 6 is open, providing a fluid flow path from said outlet of valve 6 to said inlet of valve 7; said valve 7 is open, providing a fluid flow path from said outlet of valve 7 to said mash tun inlet; and said valves 5, 10, 11, 13, 15, and 16 are closed, and pump 2 is off, providing a non-recirculating fluid flow path from said hot liquor tank outlet to said mash tun inlet.

In yet another exemplary embodiment of the automated beer brewing system, said valve 3 is open, providing a fluid flow path from said hot liquor tank outlet to said pump 1; said pump 1 pumps said liquid to said inlet of valve 5; said valve 5 is open, providing a fluid flow path from said outlet of valve 5 to said hot liquor tank inlet; said valve 11 is open, providing a fluid flow path from said mash tun outlet to said pump 2; said pump 2 pumps said liquid to said inlet of valve 10; said valve 10 is open, providing a fluid flow path from said outlet of valve 10 to said inlet of valve 7; said valve 7 is open, providing a fluid flow path from said outlet of valve 7 to said mash tun inlet; said heat exchanger located between said valve 7 and said mash tun inlet heats said fluid from outlet of valve 7 to mash tun inlet; and said valves 6, 13, 15, and 16 are closed, providing a first recirculating fluid flow path from said hot liquor tank outlet to said hot liquor tank inlet, and a second recirculating fluid flow path from said mash tun outlet to said mash tun inlet.

In still another exemplary embodiment of the automated beer brewing system, said valve 3 is open, providing a fluid flow path from said hot liquor tank outlet to said pump 1; said pump 1 pumps said liquid to said inlet of valve 6; said valve 6 is open, providing a fluid flow path from said outlet of valve 6 to said inlet of valve 7; said valve 7 is open, providing a fluid flow path from said outlet of valve 7 to said mash tun inlet; said valve 11 is open, providing a fluid flow path from said mash tun outlet to said pump 2; said pump 2 pumps said liquid to said inlet of valve 16; said valve 16 is open, providing a fluid flow path from said outlet of valve 16 to said boil kettle inlet; and said valves 5, 10, 13, and 15 are closed, providing a first non-recirculating fluid flow path from said hot liquor tank outlet to said mash tun inlet, and providing a second non-recirculating fluid flow path from said mash tun outlet to said boil kettle inlet.

In yet another exemplary embodiment of the automated beer brewing system, said liquid in said boil kettle is heated; said valve 13 is open, providing a fluid flow path from said boil kettle outlet to said pump 2; said pump 2 pumps said liquid to said inlet of valve 16; said valve 16 is open, providing a fluid flow path from said outlet of valve 16 to said boil kettle inlet; and said valves 3, 5-7, 10, 11, and 15 are closed, and said pump 1 is off, providing a recirculating fluid flow path from said boil kettle outlet to said boil kettle inlet.

In still another exemplary embodiment of the automated beer brewing system, said valve 15 is open, providing a fluid flow path from said outlet of valve 15 to said fermenter inlet; and said valves 3, 5-7, 10, 11, 13, and 16 are closed, and said pumps 1 and 2 are off, providing a fluid flow path from said kettle outlet to said fermenter inlet.

In an exemplary embodiment of the disclosure, an automated beer brewing system comprises a hot liquor tank comprising a tank inlet and a tank outlet, wherein said hot liquor tank comprises a HLT to MT heat exchanger and comprises a means of heating liquid; wherein said HLT to MT heat exchanger comprising a coil physically located inside said hot liquor tank and where the fluid-in and fluid-out connections to said coil are physically located outside said hot liquor tank, wherein said HLT to MT heat exchanger comprises a means for heating liquid; a mash tun comprising a tun inlet and a tun outlet; wherein said mash tun optionally comprises a means for heating liquid; a boil kettle comprising a kettle inlet and a kettle outlet, wherein said boil kettle comprises a means for heating liquid; a water-source; a chiller comprising a series of alternating plates containing counter-flow beer and water, wherein said chiller plates contain a means for heat exchange between said beer and said water without mixing said fluids; a drain, wherein said drain comprises a means for collecting liquid; a valve 1 comprising an inlet in fluid communication with said water source, and further comprising an outlet in fluid communication with said hot liquor tank outlet; a valve 2 comprising an inlet in fluid communication with said water source, and further comprising an outlet in fluid communication with a HLT Water-In Flow Rate Restrictor; wherein said HLT Water-In Flow Rate Restrictor comprises an inlet in fluid communication with said valve 2, and further comprises an outlet in fluid communication with said hot liquor tank inlet; a valve 3 comprising an inlet in fluid communication with said hot liquor tank outlet, and further comprising an outlet in fluid communication with a pump 1; a valve 5 comprising an inlet in fluid communication with said pump 1, and further comprising an outlet in fluid communication with said hot liquor tank inlet; a valve 6 comprising an inlet in fluid communication with said pump 1, and further comprising an outlet in fluid communication with a valve 9, a valve 7, and a valve 8; wherein said pump 1 disposed between the inflow sides of said valves 5 and 6, and outflow side of said valve 3; wherein said valve 9 comprises an inlet in fluid communication with said valve 6, and further comprises an outlet in fluid communication with a bi-directional valve 11; wherein said bi-directional valve 11 comprises an inlet in fluid communication with said valve 9, and further comprises an outlet in fluid communication with said mash tun outlet; wherein said valve 8 comprises an inlet in fluid communication with said valve 6 and a valve 10, and further comprises an outlet in fluid communication with a MT Recirculation Flow Rate Restrictor; wherein said MT Recirculation Flow Rate Restrictor comprises an inlet in fluid communication with said valve 8, and further comprises an outlet in fluid communication with said HLT to MT heat exchanger fluid-in connector; wherein said HLT to MT heat exchanger fluid-out connector is in fluid communication with said mash tun inlet; wherein said bi-directional valve 11 comprises an inlet in fluid communication with said mash tun outlet, and further comprises an outlet in fluid communication with a valve 12; wherein said valve 12 comprises an inlet in fluid communication with said bi-directional valve 11 and a valve 13, and further comprises an outlet in fluid communication with a pump 2; wherein said valve 10 comprises an inlet in fluid communication with said pump 2, and further comprises an outlet in fluid communication with said valve 8; a MT to BK Flow Rate Restrictor comprising an inlet in fluid communication with said pump 2, and further comprising an outlet in fluid communication with a valve 14; a valve 16 comprising an inlet in fluid communication with said pump 2, and further comprising an outlet in fluid communication with said counter-flow beer chiller plates; wherein said pump 2 is disposed between the inflow sides of said valves 10, 16, said MT to BK Flow Rate Restrictor, and the outflow side of said valve 12; wherein said valve 7 comprises an inlet in fluid communication with said valve 6, and further comprises an outlet in fluid communication with a HLT to MT Flow Rate Restrictor; wherein said HLT to MT Flow Rate Restrictor comprises an inlet in fluid communication with said valve 7, and further comprises an outlet in fluid communication with said HLT to MT heat exchanger fluid-in connector; wherein said valve 14 comprises an inlet in fluid communication with said MT to BK Flow Rate Restrictor, and further comprises an outlet in fluid communication with said boil kettle outlet; wherein said chiller is in fluid communication with said boil kettle inlet; wherein said valve 13 comprises an inlet in fluid communication with said boil kettle outlet, and further comprises an outlet in fluid communication with said valve 12; a valve 4 comprising an inlet in fluid communication with said water-source, and further comprising an outlet in fluid communication with the water side of said chiller; wherein said chiller counter-flow water plates is in fluid communication with said drain; a fermenter comprising a fermenter inlet, a fermenter outlet, and a means for fermenting beer wort with yeast; a valve 15 comprising an inlet in fluid communication with said boil kettle outlet, and further comprising an outlet in fluid communication with said fermenter inlet; a first four-way connection comprising (i) an inlet from the output of said water source, (ii) a first outlet to the input of said valve 1, and (iii) a second outlet to the input of said valve 2, and (iii) a third outlet to the input of said valve 4; a first T-connection comprising (i) an inlet from the output of said pump 1, (ii) a first outlet to the input of said valve 5; and (iii) a second outlet to the input of said valve 6; a second T-connection comprising (i) an inlet from the output of said valve 6, (ii) a second inlet from the output of said valve 10; and (iii) an outlet to the input of a third T-connection; said third T-connection comprising (i) an inlet from the output of said second T-connection, (ii) a first outlet to the input of said valve 8; and (iii) a second outlet to the input of a fourth T-connection; said fourth T-connection comprising (i) an inlet from the output of said third T-connection, (ii) a first outlet to the input of said valve 7; and (iii) a second outlet to the input of said valve 9; a second four-way connection comprising (i) a bi-directional connection to said bi-directional valve 11, (ii) a second inlet from the output of said valve 13, (iii) a third inlet from the output of said valve 9, and (iv) an outlet to the input of said valve 12; a third four-way connection comprising (i) an inlet from the output of said pump 2, (ii) a first outlet to the input of said valve 10, (iii) a second outlet to the input of said valve 16 and (iv) a third outlet to the input of said MT to BK Sparge Flow Rate Restrictor; a fifth T-connection comprising (i) a first inlet from the output of said MT Recirculation Flow Rate Restrictor, (ii) a second inlet from the output of said HLT to MT Flow Rate Restrictor, and (iii) an outlet to the HLT to MT heat exchanger fluid-in connector; a fourth four-way connection comprising (i) a bi-directional connection to said boil kettle outlet, (ii) a first outlet to the input of said valve 13, (iii) a second outlet to the input of said valve 15, and (iv) an inlet from the output of said valve 14; a sixth T-connection comprising (i) a bi-directional connection to said hot liquor tank outlet, (ii) an outlet to the input of said valve 3; and (iii) an inlet from the output of said valve 1; and a seventh T-connection comprising (i) a first inlet from the output of said HLT Water-In Flow Rate Restrictor, (ii) a second inlet from the output of said valve 5; and (iii) an outlet to the said hot liquor tank input; wherein said hot liquor tank, mash tun, boil kettle, valves, flow-rate restrictors, heat exchanger, direct heat sources, water source, chiller, drain, and pumps are all electrically interconnected to a power source.

In still another exemplary embodiment of the automated beer brewing system, said water source is on; said valve 1 is open, providing a fluid flow path from said outlet of valve 1 to said hot liquor tank inlet; and said valves 2-16 are closed, said HLT Water-In, HLT to MT Sparge, MT Recirculation, and MT to BK Sparge Flow Rate Restrictors are not in use, and said pumps 1 and 2 are off, providing a non-recirculating fluid flow path from said water source to said hot liquor tank outlet.

In another exemplary embodiment of the automated beer brewing system said water source is on; said valve 2 is open, providing a fluid flow path from said outlet of valve 2 to said inlet of the HLT Water-In Flow Rate Restrictor; said HLT Water-In Flow Rate Restrictor is open, providing a fluid flow path from said outlet of the HLT Water-In Flow Rate Restrictor to said hot liquor tank inlet; and said valves 1, and 3-16 are closed, said HLT to MT Sparge, MT Recirculation, and MT to BK Sparge Flow Rate Restrictors are not in use, and said pumps 1 and 2 are off, providing a non-recirculating fluid flow path from said water source to said hot liquor tank inlet.

In still another exemplary embodiment of the automated beer brewing system, said valve 3 is open, providing a fluid flow path from said outlet of valve 3 to pump 1; said pump 1 pumps said fluid to inlet of valve 5; said valve 5 is open, providing a fluid flow path from said outlet of valve 5 to said hot liquor tank inlet; and said valves 1, 2, 4, and 6-16 are closed, said HLT Water-In, HLT to MT Sparge, MT Recirculation, and MT to BK Sparge Flow Rate Restrictors are not in use, and said pump 2 is off, providing a recirculating fluid flow path from said hot liquor tank outlet to said hot liquor tank inlet.

In still another exemplary embodiment of the automated beer brewing system said valve 3 is open, providing a fluid flow path from said outlet of valve 3 to pump 1; said pump 1 pumps said fluid to inlet of valve 6; said valve 6 is open, providing a fluid flow path from said outlet of valve 6 to said inlet of valve 9; said valve 9 is open, providing a fluid flow path from said outlet of valve 9 to said inlet of bi-directional valve 11; said bi-directional valve 11 is open, providing a fluid flow path from said outlet of bi-directional valve 11 to said mash tun outlet; said valves 1, 2, 4, 5, 7, 8, 10, and 12-16 are closed, said HLT Water-In, HLT to MT Sparge, MT Recirculation, and MT to BK Sparge Flow Rate Restrictors are not in use, and said pump 2 is off, providing a non-recirculating fluid flow path from said hot liquor tank outlet to said mash tun outlet.

In still another exemplary embodiment of the automated beer brewing system, said valve 3 is open, providing a fluid flow path from said outlet of valve 3 to pump 1; said pump 1 pumps said fluid to inlet of valve 6; said valve 6 is open, providing a fluid flow path from said outlet of valve 6 to said inlet of valve 8; said valve 8 is open, providing a fluid flow path from said outlet of valve 8 to said inlet of the MT Recirculation Flow Rate Restrictor; said MT Recirculation Flow Rate Restrictor is open, providing a fluid flow path from said outlet of the MT Recirculation Flow Rate Restrictor to said HLT to MT heat exchanger fluid-in connector; said HLT to MT heat exchanger fluid-in connector is in fluid communication with said HLT to MT heat exchanger fluid-out connector, providing a fluid flow path from said HLT to MT heat exchanger fluid-in connector to said mash tun inlet; and said valves 1, 2, 4, 5, 7, and 9-16 are closed, said HLT Water-In, HLT to MT Sparge, and MT to BK Sparge Flow Rate Restrictors are not in use, and said pump 2 is off, providing a non-recirculating fluid flow path from said hot liquor tank outlet to said mash tun inlet.

In another exemplary embodiment of the automated beer brewing system, said valve 3 is open, providing a fluid flow path from said outlet of valve 3 to pump 1; said pump 1 pumps said fluid to inlet of valve 5; said valve 5 is open, providing a fluid flow path from said outlet of valve 5 to said hot liquor tank inlet; said water source is on; said valve 2 is open, providing a fluid flow path from said outlet of valve 2 to said inlet of the HLT Water-In Flow Rate Restrictor; said HLT Water-In Flow Rate Restrictor is open, providing a fluid flow path from said outlet of the HLT Water-In Flow Rate Restrictor to said hot liquor tank inlet; and said valves 1, 4, and 6-16 are closed, said HLT to MT Sparge, MT Recirculation, and MT to BK Sparge Flow Rate Restrictors are not in use, and said pump 2 is off, providing a first recirculating fluid flow path from said hot liquor tank outlet to said hot liquor tank inlet, and a second non-recirculating fluid flow path from said water source to said hot liquor tank inlet.

In a further exemplary embodiment of the automated beer brewing system, said valve 3 is open, providing a fluid flow path from said outlet of valve 3 to pump 1; said pump 1 pumps said fluid to inlet of valve 5; said valve 5 is open, providing a fluid flow path from said outlet of valve 5 to said hot liquor tank inlet; said bi-directional valve 11 is open, providing a fluid flow path from said mash tun outlet to said inlet of valve 12; said valve 12 is open, providing a fluid flow path from said outlet of valve 12 to said pump 2; said pump 2 pumps said fluid to said inlet of valve 10; said valve 10 is open, providing a fluid flow path from said outlet of valve 10 to said inlet of valve 8; said valve 8 is open, providing a fluid flow path from said outlet of valve 8 to said inlet of the MT Recirculation Flow Rate Restrictor; said MT Recirculation Flow Rate Restrictor is open, providing a fluid flow path from said outlet of the MT Recirculation Flow Rate Restrictor to said HLT to MT heat exchanger fluid-in connector; said HLT to MT heat exchanger fluid-in connector is in fluid communication with said HLT to MT heat exchanger fluid-out connector, providing a fluid flow path from said HLT to MT heat exchanger fluid-in connector to said mash tun inlet; and said valves 1, 2, 4, 6, 7, 9, and 13-16 are closed, said HLT Water-In, HLT to MT Sparge, and MT to BK Sparge Flow Rate Restrictors are not in use, providing a first recirculating fluid flow path from said hot liquor tank outlet to said hot liquor tank inlet, and a second recirculating fluid flow path from said mash tun outlet to said mash tun inlet.

In another exemplary embodiment of the automated beer brewing system, said valve 3 is open, providing a fluid flow path from said outlet of valve 3 to said pump 1; said pump 1 pumps said fluid to inlet of said valve 6; said valve 6 is open, providing a fluid flow path from said outlet of valve 6 to said inlet of valve 7; said valve 7 is open, providing a fluid flow path from said outlet of valve 7 to said inlet of the HLT to MT Sparge Flow Rate Restrictor; said HLT to MT Sparge Flow Rate Restrictor is open, providing a fluid flow path from said outlet of the HLT to MT Sparge Flow Rate Restrictor to said HLT to MT heat exchanger fluid-in connector; said HLT to MT heat exchanger fluid-in connector is in fluid communication with said HLT to MT heat exchanger fluid-out connector, providing a fluid flow path from said HLT to MT heat exchanger fluid-in connector to said mash tun inlet; said bi-directional valve 11 is open, providing a fluid flow path from said mash tun outlet to said inlet of valve 12; said valve 12 is open, providing a fluid flow path from said outlet of valve 12 to said pump 2; said pump 2 pumps said fluid to said inlet of the MT to BK Sparge Flow Rate Restrictor; said MT to BK Sparge Flow Rate Restrictor is open, providing a fluid flow path from said outlet of the MT to BK Sparge Flow Rate Restrictor to said inlet of valve 14; said valve 14 is open, providing a fluid flow path from said outlet of valve 14 to said boil kettle outlet; and said valves 1, 2, 4, 5, 8-10, 13, 15, and 16 are closed, said HLT Water-In, and MT Recirculation Flow Rate Restrictors are not in use, providing a first non-recirculating fluid flow path from said hot liquor tank outlet to said mash tun inlet, and a second non-recirculating fluid flow path from said mash tun outlet to said boil kettle outlet.

In still another exemplary embodiment of the automated beer brewing system, said valve 3 is open, providing a fluid flow path from said outlet of valve 3 to said pump 1; said pump 1 pumps said fluid to inlet of said valve 6; said valve 6 is open, providing a fluid flow path from said outlet of valve 6 to said inlet of valve 7; said valve 7 is open, providing a fluid flow path from said outlet of valve 7 to said inlet of the HLT to MT Sparge Flow Rate Restrictor; said HLT to MT Sparge Flow Rate Restrictor is open, providing a fluid flow path from said outlet of the HLT to MT Sparge Flow Rate Restrictor to said HLT to MT heat exchanger fluid-in connector; said HLT to MT heat exchanger fluid-in connector is in fluid communication with said HLT to MT heat exchanger fluid-out connector, providing a fluid flow path from said HLT to MT heat exchanger fluid-in connector to said mash tun inlet; said bi-directional valve 11 is open, providing a fluid flow path from said mash tun outlet to said inlet of valve 12; said valve 12 is open, providing a fluid flow path from said outlet of valve 12 to said pump 2; said pump 2 pumps said fluid to said inlet of valve 16; said valve 16 is open, providing a fluid flow path from said outlet of valve 16 to said counter-flow beer chiller plates; said counter-flow beer chiller plates are in fluid communication with said boil kettle inlet, providing a fluid flow path from said chiller to said boil kettle inlet; and said valves 1, 2, 4, 5, 8-10, 13, 14, and 15 are closed, and said HLT Water-In, and MT Recirculation, and MT to BK Flow Rate Restrictors are not in use, providing a first non-recirculating fluid flow path from said hot liquor tank outlet to said mash tun inlet, and a second non-recirculating fluid flow path from said mash tun outlet to said boil kettle inlet.

In still another exemplary embodiment of the automated beer brewing system, said valve 13 is open, providing a fluid flow path from said boil kettle outlet to said inlet of valve 12; said valve 12 is open, providing a fluid flow path from said outlet of valve 12 to said pump 2; said pump 2 pumps said fluid to said inlet of valve 16; said valve 16 is open, providing a fluid flow path from said outlet of valve 16 to said counter-flow beer chiller plates; said counter-flow beer chiller plates are in fluid communication with said boil kettle inlet, providing a fluid flow path from said counter-flow beer chiller plates to said boil kettle inlet; and said valves 1-11, 14, and 15 are closed, said HLT Water-In, HLT to MT Sparge, MT Recirculation, and MT to BK Sparge Flow Rate Restrictors are not in use, and said pump 1 is off, providing a recirculating fluid flow path from said boil kettle outlet to said boil kettle inlet.

In yet another exemplary embodiment of the automated beer brewing system, said valve 13 is open, providing a fluid flow path from said boil kettle outlet to said inlet of valve 12; said valve 12 is open, providing a fluid flow path from said outlet of valve 12 to said pump 2; said pump 2 pumps said fluid to said inlet of valve 16; said valve 16 is open, providing a fluid flow path from said outlet of valve 16 to said counter-flow beer chiller plates; said counter-flow beer chiller plates are in fluid communication with said boil kettle inlet, providing a fluid flow path from said counter-flow beer chiller plates to said boil kettle inlet; said water source is on; said valve 4 is open, providing a fluid flow path from said outlet of valve 4 to said counter-flow water chiller plates; said counter-flow water chiller plates are in fluid communication with said drain, providing a fluid flow path from said counter-flow water chiller plates to said drain; and said valves 1, 2, 3, 5-11, 14, and 15 are closed, said HLT Water-In, HLT to MT Sparge, MT Recirculation, and MT to BK Sparge Flow Rate Restrictors are not in use, and said pump 1 is off, providing a first recirculating fluid flow path from said boil kettle outlet to said boil kettle inlet, and a second non-recirculating fluid flow path from said water source to said drain.

In further exemplary embodiment of the automated beer brewing system, said valve 15 is open, providing a fluid flow path from said boil kettle outlet to said fermenter inlet; and said valves 1-14, and 16 are closed, said HLT Water-In, HLT to MT Sparge, MT Recirculation, and MT to BK Sparge Flow Rate Restrictors are not in use, and said pumps 1 and 2 are off, providing a non-recirculating fluid flow path from said boil kettle outlet to said fermenter inlet.

In another exemplary embodiment, an automated beer brewing system comprises a hot liquor tank comprising a tank inlet and a tank outlet, wherein said hot liquor tank comprises a means for heating liquid and a means for agitating liquid inside said liquor tank; a mash tun comprising a tun inlet and a tun outlet; wherein said mash tun optionally comprises a means for heating liquid; a boil kettle comprising a kettle inlet and a kettle outlet, wherein said boil kettle comprises a means for heating liquid; a valve 1 comprising an inlet in fluid communication with said hot liquor tank outlet, and further comprising an outlet in fluid communication with a pump 1; a valve 6 comprising an inlet in fluid communication with said pump 1, and further comprising an outlet in fluid communication with said hot liquor tank inlet; a valve 5 comprising an inlet in fluid communication with said pump 1, and further comprising an outlet in fluid communication with said mash tun inlet; a valve 8 comprising an inlet in fluid communication with said mash tun outlet, and further comprising an outlet in fluid communication with said pump 1; wherein said pump 1 disposed between the outflow sides of said valves 1 and 8, and the inflow sides of said valves 6 and 5; a heat exchanger located between said valve 5 and said mash tun inlet, wherein said heat exchanger containing means for heating beer wort when it travels between said mash tun outlet and said mash tun inlet; a valve 10 comprising an inlet in fluid communication with said mash tun outlet, and further comprising an outlet in fluid communication with a pump 2; a valve 11 comprising an inlet in fluid communication with said pump 2, and further comprising an outlet in fluid communication with said boil kettle inlet; a valve 13 comprising an inlet in fluid communication with said boil kettle outlet, and further comprising an outlet in fluid communication with said pump 2 and a valve 14; a fermenter comprising a fermenter inlet, a fermenter outlet, and a means for fermenting said beer wort with yeast; a HLT Agitator contained within the hot liquor tank, wherein said HLT Agitator contains a means for mechanical agitation or mixing of the HLT contents; said valve 14 comprises an inlet in fluid communication with said valve 13, and further comprises an outlet in fluid communication with said fermenter inlet; wherein said pump 2 disposed between the outflow sides of said valves 10 and 13, and the inflow side of said valve 11; a first T-connection comprising: (i) a first inlet from the output of said valve 1, (ii) a second inlet from the output of said valve 8, and (iii) an outlet connected to the input of said pump 1; a second T-connection comprising: (i) an inlet from the output of said pump 1, (ii) a first outlet connected to the input of said valve 6, and (iii) a second outlet connected to the input of said valve 5; a third T-connection comprising: (i) an inlet from the output of said mash tun outlet, (ii) a first outlet connected to the input of said valve 8, and (iii) a second outlet connected to the input of said valve 10; and a first four-way cross connection comprising: (i) a first inlet from the output of said valve 10, (ii) a second inlet from the output of said valve 13, (iii) a first outlet connected to the input side of said pump 2, and (iv) a second outlet to the input side of said valve 14; wherein said hot liquor tank, mash tun, boil kettle, valves, direct heat sources, HLT agitator, and pumps are all electrically interconnected to a power source.

In still another exemplary embodiment of the automated beer brewing system, said liquid in said hot liquor tank is heated; said valve 1 is open, providing a fluid flow path from said hot liquor tank outlet to said pump 1; said pump 1 pumps said liquid to said inlet of valve 6; said valve 6 is open, providing a fluid flow path from said outlet of valve 6 to said hot liquor tank inlet; and said valves 5, 8, 10, 11, 13, and 14 are closed, and said pump 2 is off, providing a recirculating fluid flow path from said hot liquor tank outlet to said hot liquor tank inlet.

In still another exemplary embodiment of the automated beer brewing system, said valve 1 is open, providing a fluid flow path from said hot liquor tank outlet to said pump 1; said pump 1 pumps said liquid to said inlet of valve 5; said valve 5 is open, providing a fluid flow path from said outlet of valve 5 to said mash tun inlet; and said valves 6, 8, 10, 11,13, 14 are closed, and said pump 2 is off, providing a non-recirculating fluid flow path from said hot liquor tank outlet to said mash tun inlet.

In still another exemplary embodiment of the automated beer brewing system, said valve 8 is open, providing a fluid flow path from said mash tun outlet to said pump 1; said pump 1 pumps said liquid to said inlet of valve 5; said valve 5 is open, providing a fluid flow path from said outlet of valve 5 to said mash tun inlet; said heat exchanger located between valve 5 and mash tun inlet heats said fluid from outlet of valve 5 to mash tun inlet; a stir motor located within said hot liquor tank; said stir motor comprises means for agitating liquid inside said hot liquor tank; and said valves, 1, 6, 10, 11, 13, and 14 are closed, and said pump 2 is off, providing a recirculating fluid flow path from said mash tun outlet to said mash tun inlet, and a recirculating fluid flow path within said hot liquor tank as a result of the stir motor agitating its contents.

In still another exemplary embodiment of the automated beer brewing system, said valve 1 is open, providing a fluid flow path from said hot liquor tank outlet to said pump 1; said pump 1 pumps said liquid to said inlet of valve 5; said valve 5 is open, providing a fluid flow path from said outlet of valve 5 to said mash tun inlet; said valve 10 is open, providing a fluid flow path from said mash tun outlet to said pump 2; said pump 2 pumps said liquid to said inlet of valve 11; said valve 11 is open, providing a fluid flow path from said outlet of valve 11 to said boil kettle inlet; and said valves 6, 8, 13, and 14 are closed, providing a first non-recirculating fluid flow path from said hot liquor tank outlet to said mash tun inlet, and a second non-recirculating fluid flow path from said mash tun outlet to said boil kettle inlet.

In yet another exemplary embodiment of the automated beer brewing system, said liquid in said boil kettle is heated; said valve 13 is open, providing a fluid flow path from said boil kettle outlet to said pump 2; said pump 2 pumps said liquid to said inlet of valve 11; said valve 11 is open, providing a fluid flow path from said outlet of valve 11 to said boil kettle inlet; and said valves 1, 5, 6, 8, 10, and 14 are closed, and said pump 1 is off, providing a recirculating fluid flow path from said boil kettle outlet to said boil kettle inlet.

In still another exemplary embodiment of the automated beer brewing system, said valve 13 is open, providing a fluid flow path from said boil kettle outlet to said inlet of valve 14; said valve 14 is open, providing a fluid flow path from said outlet of valve 14 to said fermenter inlet; and said valves 1, 5, 6, 8, 10, and 11 are closed, and said pumps 1 and 2 are off, providing a non-recirculating fluid flow path from said boil kettle outlet to said fermenter inlet.

In an exemplary embodiment, an automated beer brewing system comprises a hot liquor tank comprising a tank inlet and a tank outlet, wherein said hot liquor tank comprises a HLT to MT heat exchanger, a means for heating liquid, and a means for agitating liquid inside said liquor tank; wherein said HLT to MT heat exchanger comprising a coil physically located inside said hot liquor tank and where the fluid-in and fluid-out connections to said coil are physically located outside said hot liquor tank, wherein said HLT to MT heat exchanger comprises a means for heating liquid; a mash tun comprising a tun inlet and a tun outlet, wherein said mash tun optionally comprises a means for heating liquid; a boil kettle comprising a kettle inlet and a kettle outlet, wherein said boil kettle comprises a means for heating liquid; a fermenter comprising a fermenter inlet and a fermenter outlet, wherein said fermenter comprises a means for fermenting beer wort with yeast; a water source, wherein said water source comprises a means for dispensing water; a drain, wherein said drain comprises a means for draining liquid; a chiller comprising a series of alternating plates containing counter-flowing beer and water, wherein said chiller plates contain a means for heat exchange between said beer and said water without mixing said fluids; a valve 2 comprising an inlet in fluid communication with said water source, and further comprising an outlet in fluid communication with a bi-directional valve 1 and a pump 1; wherein said bi-directional valve 1 comprises an inlet in fluid communication with said valve 2, and further comprises an outlet in fluid communication with said hot liquor tank outlet; a valve 6 comprising an inlet in fluid communication with said pump 1, and further comprising an outlet in fluid communication with said hot liquor tank inlet; wherein said bi-directional valve 1 comprises an inlet in fluid communication with said hot liquor tank outlet, and further comprises an outlet in fluid communication with said pump 1 and a bi-directional valve 8; a valve 7 comprising an inlet in fluid communication with said pump 1, and further comprising an outlet in fluid communication with said mash tun outlet; a valve 5 comprising an inlet in fluid communication with said pump 1, and further comprises an outlet in fluid communication with a MT Recirculation Flow Rate Restrictor; wherein said MT Recirculation Flow Rate Restrictor comprises an inlet in fluid communication with said valve 5, and further comprises an outlet in fluid communication with said HLT to MT heat exchanger fluid-in connector; wherein said HLT to MT heat exchanger fluid-out connector is in fluid communication with said mash tun inlet; a valve 9 comprising an inlet in fluid communication with said mash tun outlet, and further comprising an outlet in fluid communication with a valve 10, and said bi-directional valve 8; wherein said bi-directional valve 8 comprises an inlet in fluid communication with said valve 9, and further comprises an outlet in fluid communication with said pump 1; wherein said bi-directional valve 8 comprises an inlet in fluid communication with said bi-directional valve 1, and further comprises an outlet in fluid communication with said valve 10; a HLT to MT Sparge Flow Rate Restrictor comprising an inlet in fluid communication with said pump 1, and further comprising an outlet in fluid communication with a valve 4; wherein said valve 4 comprises an inlet in fluid communication with said HLT to MT Sparge Flow Rate Restrictor, and further comprises an outlet in fluid communication with said HLT to MT heat exchanger fluid-in connector; wherein said valve 10 comprises an inlet in fluid communication with said valve 9 and said bi-directional valve 8, and further comprises an outlet in fluid communication with a pump 2 and a valve 15; a valve 11 comprising an inlet in fluid communication with said pump 2, and further comprising an outlet in fluid communication with a MT to BK Flow Rate Restrictor; wherein said MT to BK Flow Rate Restrictor comprises an inlet in fluid communication with said valve 11, and further comprises an outlet in fluid communication with said alternating counter-flow beer chiller plates; wherein said alternating counter-flow beer chiller plates are in fluid communication with said boil kettle inlet; a valve 13 comprising an inlet in fluid communication with said boil kettle outlet, and further comprising an outlet in fluid communication with said pump 2 and a valve 14; a BK Recirculation Flow Rate Restrictor comprising an inlet in fluid communication with said pump 2, and further comprising an outlet in fluid communication with a valve 12; wherein said valve 12 comprises an inlet in fluid communication with said BK Recirculation Flow Rate Restrictor, and further comprises an outlet in fluid communication with the beer side of said chiller; a valve 3 comprising an inlet in fluid communication with said water source, and further comprises an outlet in fluid communication with the water side of said chiller; wherein said water side of said chiller is in fluid communication with said drain; wherein said valve 14 comprises an inlet in fluid communication with said valve 13, and further comprises an outlet in fluid communication with said fermenter inlet; wherein said valve 15 comprises an inlet in fluid communication with said valves 13 and 10, and further comprises an outlet in fluid communication with said drain; wherein said pump 1 disposed at the outflow side of said valves 2, 1 and 8, the inflow side of said valves 5, 6, 7 and said HLT to MT Flow Rate Restrictor; wherein said pump 2 disposed at the outflow side of said valves 10 and 13, the inflow side of said valve 11 and said BK Recirculation Flow Rate Restrictor; wherein said HLT Agitator is contained within the hot liquor tank and contains a means for mechanical agitation or mixing of the HLT contents; a first T-connection comprising: (i) an inlet from the output of said water source, (ii) a first outlet to the input of said valve 2, and (iii) a second outlet to the input of said valve 3; a first four-way connection comprising: (i) an inlet from the output of valve 2, (ii) a connection to said bi-directional valve 1, (iii) a connection to said bi-directional valve 8, and (iv) an outlet to the input of said pump 1; a second T-connection comprising: (i) a first inlet from the output of said valve 4, (ii) a second inlet from the output of said MT Recirculation Flow Rate Restrictor, and (iii) an outlet to the input of said HLT to MT heat exchanger fluid-in connector; a second four-way connection comprising: (i) a first outlet to the input of said valve 6, (ii) a second outlet to the inlet of said valve 7, (iii) an third outlet to the input of a third T-connection, and (iv) an input from the output of said pump 1; a third T-connection comprising: (i) an inlet from the output of said second four-way connector, (ii) a first outlet to the input of said HLT to MT Flow Rate Restrictor, and (iii) a second outlet to the input of said valve 5; a third four-way connection comprising: (i) a first inlet from the output of said valve 10, (ii) a second inlet from the output of said valve 13, (iii) first outlet to the input of said pump 2, and (iv) a second outlet to the input of a fourth T-connection; a fourth T-connection comprising: (i) an inlet from the output of said third four-way connection, (ii) a first outlet to the input of said valve 15, and (iii) a second outlet to the input of said valve 14; a fifth T-connection comprising: (i) an first inlet from the output of said valve 15, (ii) a second inlet from the output of said counter-flow water side chiller plates, and (iii) an outlet to the input of said drain; a sixth T-connection comprising: (i) an inlet from the output of said pump 2, (ii) a first outlet to the input of said valve 11, and (ii) a second outlet to the input of said BK Recirculation Flow Rate Restrictor; a seventh T-connection comprising: (i) a first inlet from the output of said MT to BK Flow Rate Restrictor, (ii) a second inlet from the output of said valve 12, and (iii) an outlet to the input of said alternating counter-flow beer chiller plates; an eighth T-connection comprising: (i) a first inlet from the output of said valve 7, (ii) a second inlet from the output of said mash tun outlet, and (iii) an outlet to the input of said valve 9; and a ninth T-connection comprising: (i) a first connection to said bi-directional valve 8, (ii) first outlet to the input of said valve 9, and (iii) a second outlet to the input of said valve 10; wherein said hot liquor tank, mash tun, boil kettle, valves, flow-rate restrictors, heat exchanger, water source, chiller, direct heat sources, HLT Agitator, drain, and pumps are all electrically interconnected to a power source.

In still another exemplary embodiment of the automated beer brewing system, said water source is on; said valve 2 is open, providing a fluid flow path from said water source to said inlet of bi-directional valve 1; said valve 1 is open, providing a fluid flow path from said outlet of bi-directional valve 1 to said hot liquor tank outlet; and said valves 3-15 are closed, said MT Recirculation, HLT to MT Sparge, MT to BK Sparge, and BK Recirculation Flow Rate Restrictors are not in use, and said pumps 1 and 2 are off, providing a non-recirculating fluid flow path from said water source to said hot liquor tank outlet.

In another exemplary embodiment of the automated beer brewing system, said water source is on; said valve 2 is open, providing a fluid flow path from said water source to said pump 1; said pump 1 pumps said liquid to said inlet of valve 6; said valve 6 is open, providing a fluid flow path from said outlet of valve 6 to said hot liquor tank inlet; and said valves 1, 3-5, and 7-15 are closed, said MT Recirculation, HLT to MT Sparge, MT to BK Sparge, and BK Recirculation Flow Rate Restrictors are not in use, and said pump 2 is off, providing a non-recirculating fluid flow path from said water source to said hot liquor tank inlet.

In still another exemplary embodiment of the automated beer brewing system, said bi-directional valve 1 is open, providing a fluid flow path from said hot liquor tank outlet to said pump 1; said pump 1 pumps said liquid to said inlet of valve 6; said valve 6 is open, providing a fluid flow path from said outlet of valve 6 to said hot liquor tank inlet; and said valves 2-5, and 7-15 are closed, said MT Recirculation, HLT to MT Sparge, MT to BK Sparge, and BK Recirculation Flow Rate Restrictors are not in use, and said pump 2 is off, providing a recirculating fluid flow path from said hot liquor tank outlet to said hot liquor tank inlet.

In another exemplary embodiment of the automated beer brewing system, said bi-directional valve 1 is open, providing a fluid flow path from said hot liquor tank outlet to said pump 1; said pump 1 pumps said liquid to said inlet of valve 7; said valve 7 is open, providing a fluid flow path from said outlet of valve 7 to said mash tun outlet; and said valves 2-6, and 8-15 are closed, said MT Recirculation, HLT to MT Sparge, MT to BK Sparge, and BK Recirculation Flow Rate Restrictors are not in use, and said pump 2 is off, providing a non-recirculating fluid flow path from said hot liquor tank outlet to said mash tun outlet.

In still another exemplary embodiment of the automated beer brewing system, said bi-directional valve 1 is open, providing a fluid flow path from said hot liquor tank outlet to said pump 1; said pump 1 pumps said liquid to said inlet of valve 5; said valve 5 is open, providing a fluid flow path from said outlet of valve 5 to the inlet of said MT Recirculation Flow Rate Restrictor; said MT Recirculation Flow Rate Restrictor is open, providing a fluid flow path from said outlet of said MT Recirculation Flow Rate Restrictor to said heat exchanger fluid-in connector; said heat exchanger fluid-in connector is in fluid communication with said heat exchanger fluid-out connector, providing a fluid flow path from said heat exchanger fluid-in connector to said mash tun inlet; and said valves 2-4, and 6-15 are closed, said HLT to MT Sparge, MT to BK Sparge, and BK Recirculation Flow Rate Restrictors are not in use, and said pump 2 is off, providing a non-recirculating fluid flow path from said hot liquor tank outlet to said mash tun inlet.

In further exemplary embodiment of the automated beer brewing system, said bi-directional valve 1 is open, providing a fluid flow path from said hot liquor tank outlet to said pump 1; said water source is on; said valve 2 is open, providing a fluid flow path from said water source to said pump 1; said pump 1 pumps said liquid to said inlet of valve 6; said valve 6 is open, providing a fluid flow path from said outlet of valve 6 to said hot liquor tank inlet; and said valves 3-5, and 7-15 are closed, said MT Recirculation, HLT to MT Sparge, MT to BK Sparge, and BK Recirculation Flow Rate Restrictors are not in use, and said pump 2 is off, providing a first recirculating fluid flow path from said hot liquor tank outlet to said hot liquor tank inlet, and a second non-recirculating fluid flow path from said water source to said hot liquor tank inlet.

In still another exemplary embodiment of the automated beer brewing system, said valve 9 is open, providing a fluid flow path from said mash tun outlet to said inlet of bi-directional valve 8; said bi-directional valve 8 is open, providing a fluid flow path from said outlet of bi-directional valve 8 to said pump 1; said pump 1 pumps said liquid to said inlet of valve 5; said valve 5 is open, providing a fluid flow path from said outlet of valve 5 to the inlet of said MT Recirculation Flow Rate Restrictor; said MT Recirculation Flow Rate Restrictor is open, providing a fluid flow path from said outlet of said MT Recirculation Flow Rate Restrictor to said heat exchanger fluid-in connector; said heat exchanger fluid-in connector is in fluid communication with said heat exchanger fluid-out connector, providing a fluid flow path from said heat exchanger fluid-in connector to said mash tun inlet; said HLT Agitator is on, providing mechanical agitation of the HLT contents, and said valves 1-4, 6, 7, 10, and 11-15 are closed, said HLT to MT Sparge, MT to BK Sparge, and BK Recirculation Flow Rate Restrictors are not in use, and said pump 2 is off, providing a first recirculating fluid flow path from said mash tun outlet to said mash tun inlet, and providing a second recirculating fluid flow path within the HLT from the HLT Agitator.

In another exemplary embodiment of the automated beer brewing system, said bi-directional valve 1 is open, providing a fluid flow path from said hot liquor tank outlet to said pump 1; said pump 1 pumps said liquid to said inlet of the HLT to MT Sparge Flow Rate Restrictor; said HLT to MT Sparge Flow Rate Restrictor is open, providing a fluid flow path from said outlet of said HLT to MT Sparge Flow Rate Restrictor to said inlet of valve 4; said valve 4 is open, providing a fluid flow path from said outlet of valve 4 to said heat exchanger fluid-in connector; said heat exchanger fluid-in connector is in fluid communication with said heat exchanger fluid-out connector, providing a fluid flow path from said heat exchanger fluid-in connector to said mash tun inlet; said valve 9 is open, providing a fluid flow path from said mash tun outlet to said inlet of valve 10; said valve 10 is open, providing a fluid flow path from said outlet of valve 10 to said pump 2; said pump 2 pumps said liquid to said inlet of valve 11; said valve 11 is open, providing a fluid flow path from said outlet of valve 11 to said inlet of the MT to BK Sparge Flow Rate Restrictor; said MT to BK Sparge Flow Rate Restrictor is open, providing a fluid flow path from the outlet of said MT to BK Sparge Flow Rate Restrictor to said counter-flow beer chiller plates; said counter-flow beer chiller plates are in fluid communication with said boil kettle inlet, providing a fluid flow path from said counter-flow beer chiller plates to said boil kettle inlet; and said valves 2, 3, 5-8, and 12-15 are closed, said MT Recirculation, and BK Recirculation Flow Rate Restrictors are not in use, providing a first non-recirculating fluid flow path from said hot liquor tank outlet to said mash tun inlet, and a second non-recirculating fluid flow path from said mash tun outlet to said boil kettle inlet.

In yet another exemplary embodiment of the automated beer brewing system, said valve 13 is open, providing a fluid flow path from said boil kettle outlet to said pump 2; said pump 2 pumps said liquid to said inlet of the BK Recirculation Flow Rate Restrictor; said BK Recirculation Flow Rate Restrictor is open, providing a fluid flow path from said outlet of the BK Recirculation Flow Rate Restrictor to said inlet of valve 12; said valve 12 is open, providing a fluid flow path from said outlet of valve 12 to said counter-flow beer chiller plates; said counter-flow beer chiller plates are in fluid communication with said boil kettle inlet, providing a fluid flow path from said counter-flow beer chiller plates to said boil kettle inlet; and said valves 1-11, 14, and 15 are closed, said MT Recirculation, HLT to MT Sparge, and MT to BK Sparge Flow Rate Restrictors are not in use, and said pump 1 is off, providing a recirculating fluid flow path from said boil kettle outlet to said boil kettle inlet.

In further exemplary embodiment of the automated beer brewing system, said valve 13 is open, providing a fluid flow path from said boil kettle outlet to said pump 2; said pump 2 pumps said liquid to said inlet of the BK Recirculation Flow Rate Restrictor; said the BK Recirculation Flow Rate Restrictor is open, providing a fluid flow path from said outlet of the BK Recirculation Flow Rate Restrictor to said inlet of valve 12; said valve 12 is open, providing a fluid flow path from said outlet of valve 12 to said counter-flow beer chiller plates; said counter-flow beer chiller plates are in fluid communication with said boil kettle inlet, providing a fluid flow path from said counter-flow beer chiller plates to said boil kettle inlet; said valve 3 is open, providing a fluid flow path from said water source to said counter-flow water chiller plates; said counter-flow water chiller plates are in fluid communication with said drain, providing a fluid flow path from said counter-flow water chiller plates to said drain; said valves 1, 2, 4-11, 14, and 15 are closed, said MT Recirculation, HLT to MT Sparge, and MT to BK Sparge Flow Rate Restrictors are not in use, and said pump 1 is off, providing a first recirculating fluid flow path from said boil kettle outlet to said boil kettle inlet, and a second non-recirculating fluid flow path from said water source to said drain.

In yet another exemplary embodiment of the automated beer brewing system, said valve 13 is open, providing a fluid flow path from said boil kettle outlet to said inlet of valve 14; said valve 14 is open, providing a fluid flow path from said outlet of valve 14 to said fermenter inlet; and said valves 1-12, and 15 are closed, said MT Recirculation, HLT to MT Sparge, MT to BK Sparge, and BK Recirculation Flow Rate Restrictors are not in use, and said pumps 1 and 2 are off, providing a non-recirculating fluid flow path from said boil kettle outlet to said fermenter inlet.

In another exemplary embodiment of the automated beer brewing system, said valve bi-directional 1 is open, providing a fluid flow path from said hot liquor tank outlet to said inlet of bi-directional valve 8; said bi-directional valve 8 is open, providing a fluid flow path from said outlet of bi-directional valve 8 to said inlet of valve 10; said valve 10 is open, providing a fluid flow path from said outlet of valve 10 to said inlet of valve 15; said valve 15 is open, providing a fluid flow path from said outlet of valve 15 to said drain; and said valves 2-7, 9, 11-13, and 14 are closed, said MT Recirculation, HLT to MT Sparge, MT to BK Sparge, and BK Recirculation Flow Rate Restrictors are not in use, and said pumps 1 and 2 are off, providing a non-recirculating fluid flow path from said hot liquor tank outlet to said drain.

In further exemplary embodiment of the automated beer brewing system, said valve 9 is open, providing a fluid flow path from said mash tun outlet to said inlet of valve 10; said valve 10 is open, providing a fluid flow path from said outlet of valve 10 to said inlet of valve 15; said valve 15 is open, providing a fluid flow path from said outlet of valve 15 to said drain; and said valves 1-8, and 11-14, are closed, said MT Recirculation, HLT to MT Sparge, MT to BK Sparge, and BK Recirculation Flow Rate Restrictors are not in use, and said pumps 1 and 2 are off, providing a non-recirculating fluid flow path from said mash tun outlet to said drain.

In still another exemplary embodiment of the automated beer brewing system, said valve 13 is open, providing a fluid flow path from said boil kettle outlet to said inlet of valve 15; said valve 15 is open, providing a fluid flow path from said outlet of valve 15 to said drain; and said valves 1-12, and 14 are closed, said MT Recirculation, HLT to MT Sparge, MT to BK Sparge, and BK Recirculation Flow Rate Restrictors are not in use, and said pumps 1 and 2 are off, providing a non-recirculating fluid flow path from said boil kettle outlet to said drain.

An exemplary embodiment of an automated beer brewing system comprises a hot liquor tank comprising a tank inlet and a tank outlet, wherein said hot liquor tank comprises a means for heating liquid; a mash tun having a tun inlet and a tun outlet; wherein said mash tun optionally comprises a means for heating liquid; a boil kettle comprising a kettle inlet and a kettle outlet, wherein said boil kettle comprises a means for heating liquid; a valve 6 comprising an inlet in fluid communication with said hot liquor tank outlet, and further comprising an outlet in fluid communication with a pump 1; a valve 1 comprising an inlet in fluid communication with said pump 1, and further comprising an outlet in fluid communication with said hot liquor tank inlet; a valve 11 comprising an inlet in fluid communication with said pump 1, and further comprising an outlet in fluid communication with said mash tun inlet; said pump 1 disposed between the outflow side of said valve 6, and the inflow side of said valves 1 and 11; a valve 10 comprising an inlet in fluid communication with said mash tun outlet, and further comprising an outlet in fluid communication with a pump 2; a valve 12 comprising an inlet in fluid communication with said pump 2, and further comprising an outlet in fluid communication with said mash tun inlet; wherein said pump 2 disposed between the outflow side of said valve 10, and the inflow side of said valve 12; a heat exchanger located between the outflow side of said valve 12 and said mash tun inlet; said heat exchanger containing means for heating beer wort as it travels from said mash tun outlet to said mash tun inlet; a valve 9 comprising an inlet in fluid communication with said mash tun outlet, and further comprising an outlet in fluid communication with a pump 3; a valve 15 comprising an inlet in fluid communication with said pump 3, and further comprising an outlet in fluid communication with said boil kettle inlet; a valve 14 comprising an inlet in fluid communication with said boil kettle outlet, and further comprising an outlet in fluid communication with said pump 3; wherein said pump 3 disposed between the outflow side of said valves 9 and 14, and the inflow side of said valve 15; a fermenter comprising a fermenter inlet, and a fermenter outlet, and a means for fermenting beer wort with yeast; a valve 17 comprising an inlet in fluid communication with the output of said valve 14, and further comprising an outlet in fluid communication with said fermenter inlet; a first T-connection comprising (i) an inlet from the output of said pump 1, (ii) a first outlet to the input of said valve 11, and (iii) a second outlet to the input of said valve 1; a second T-connection comprising (i) a first inlet from the output of said 11, (ii) a second inlet from the output of said valve 12, and (iii) an outlet to the input of said mash tun inlet; a third T-connection comprising (i) an inlet from the output of said mash tun outlet, (ii) a first outlet to the input of said valve 9, and (iii) a second outlet to the input of said valve 10; and a first four-way cross connection comprising (i) a first inlet from the output of said valve 9, (ii) a second inlet from the output of said valve 14, (iii) an outlet to the input of said pump 3, and (iv) a second outlet to the input of said valve 17; wherein said hot liquor tank, mash tun, boil kettle, valves and pumps are all electrically interconnected to a power source.

In further exemplary embodiment of the automated beer brewing system, said liquid in hot liquor tank is heated; said valve 6 is open, providing a fluid flow path from said hot liquor tank outlet to said pump 1; said pump 1 pumps said liquid to said inlet of valve 1; said valve 1 is open, providing a fluid flow path from said outlet of valve 1 to said hot liquor tank inlet; and said valves 9-12, 14, 15, and 17 are closed, and said pumps 2 and 3 are off, providing a recirculating fluid flow path from said hot liquor tank outlet to said hot liquor tank inlet.

In still another exemplary embodiment of the automated beer brewing system, said valve 6 is open, providing a fluid flow path from said hot liquor tank outlet to said pump 1; said pump 1 pumps said liquid to said inlet of valve 11; said valve 11 is open, providing a fluid flow path from said outlet of valve 11 to said mash tun inlet; and said valves 1, 9, 10, 12, 14, 15, and 17 are closed, and said pumps 2 and 3 are off, providing a non-recirculating fluid flow path from said hot liquor tank outlet to said mash tun inlet.

In further exemplary embodiment of the automated beer brewing system, said valve 6 is open, providing a fluid flow path from said hot liquor tank outlet to said pump 1; said pump 1 pumps said liquid to said inlet of valve 1; said valve 1 is open, providing a fluid flow path from said outlet of valve 1 to said hot liquor tank inlet; said valve 10 is open, providing a fluid flow path from said mash tun outlet to said pump 2; said pump 2 pumps said liquid to said inlet of valve 12; said valve 12 is open, providing a fluid flow path from said outlet of valve 12 to said mash tun inlet; said heat exchanger located between the outlet of said valve 12 and said mash tun inlet heats said liquid from said outlet of valve 12 to said mash tun inlet; and said valves 9, 11, 14, 17, and 15 are closed, and said pump 3 is off, providing a first recirculating fluid flow path from said hot liquor tank outlet to said hot liquor inlet, and a second recirculating fluid flow path from said mash tun outlet to said mash tun inlet.

In yet another exemplary embodiment of the automated beer brewing system, said valve 6 is open, providing a fluid flow path from said hot liquor tank outlet to said pump 1; said pump 1 pumps said liquid to said inlet of valve 11; said valve 11 is open, providing a fluid flow path from said outlet of valve 11 to said mash tun inlet; said valve 9 is open, providing a fluid flow path from said mash tun outlet to said pump 3; said pump 3 pumps said liquid to said inlet of valve 15; said valve 15 is open, providing a fluid flow path from said outlet of valve 15 to said boil kettle inlet; and said valves 1, 10, 12, 14, and 17 are closed, and said pump 2 is off, providing a first non-recirculating fluid flow path from said hot liquor tank outlet to said mash tun inlet, and a second non-recirculating fluid flow path from said mash tun outlet to said boil kettle inlet.

In another exemplary embodiment of the automated beer brewing system, said liquid in said boil kettle is heated; said valve 14 is open, providing a fluid flow path from said boil kettle outlet to said pump 3; said pump 3 pumps said liquid to said inlet of valve 15; said valve 15 is open, providing a fluid flow path from said outlet of valve 15 to said boil kettle inlet; and said valves 1, 6, 9-12, and 17 are closed, and said pumps 1 and 2 are off, providing a recirculating fluid flow path from said boil kettle outlet to said boil kettle inlet.

In further exemplary embodiment of the automated beer brewing system, said valve 14 is open, providing a fluid flow path from said boil kettle outlet to said inlet of valve 17; and said valve 17 is open, providing a fluid flow path from said outlet of valve 14 to said fermenter inlet; and said valves 1, 6, 9-12, and 15 are closed, and said pumps 1, 2, and 3 are off, providing a fluid flow path from said boil kettle outlet to said fermenter inlet.

Another exemplary embodiment of the automated beer brewing system, comprises a hot liquor tank comprising a tank inlet and a tank outlet, wherein said hot liquor tank comprises a HLT to MT heat exchanger and comprises a means for heating liquid; wherein said HLT to MT heat exchanger comprising a coil physically located inside the hot liquor tank and where the fluid-in and fluid-out connections to the coil are physically located outside the hot liquor tank, wherein said HLT to MT heat exchanger comprises a means for heating liquid; a mash tun comprising a tun inlet and a tun outlet, wherein said mash tun optionally comprises a means for heating liquid; a boil kettle comprising a kettle inlet and a kettle outlet, wherein said boil kettle comprises a means for heating liquid; a water source, wherein said water source comprises a means for dispensing water; a drain, wherein said drain comprises a means for draining liquid; a chiller comprising a series of alternating plates containing counter-flow beer and water, wherein said chiller plates contain a means for heat exchange between said beer and said water without mixing said fluids; a valve 3 comprising an inlet in fluid communication with said water source, and further comprises an outlet in fluid communication with a bi-directional valve 7, a valve 6, and a bi-directional valve 5; wherein said bi-directional valve 5 comprises an inlet in fluid communication with said valve 3, and further comprises an outlet in fluid communication with said hot liquor tank outlet; wherein said bi-directional valve 7 comprises an inlet in fluid communication with said valve 3, and further comprises an outlet in fluid communication with a bi-directional valve 9; wherein said bi-directional valve 9 comprises an inlet in fluid communication with said bi-directional valve 7, and further comprises an outlet in fluid communication with a valve 18; wherein said valve 18 comprises an inlet in fluid communication with said bi-directional valve 9 and a bi-directional valve 14, and further comprises an outlet in fluid communication with a pump 3; a valve 16 comprising an inlet in fluid communication with said pump 3, and further comprises an outlet in fluid communication with said boil kettle inlet; wherein said bi-directional valve 5 comprises an inlet in fluid communication with said hot liquor tank outlet, and further comprises an outlet in fluid communication with said valve 6; wherein said valve 6 comprises an inlet in fluid communication with said bi-directional valve 5 and said valve 3, and further comprises an outlet in fluid communication with a pump 1; a valve 1 comprising an inlet in fluid communication with said pump 1, and further comprises an outlet in fluid communication with a HLT Recirculation Flow Rate Restrictor; wherein said HLT Recirculation Flow Rate Restrictor comprises an inlet in fluid communication with said valve 1, and further comprises an outlet in fluid communication with said hot liquor tank inlet; wherein said chiller is in fluid communication with said boil kettle outlet, said bi-directional valve 14, said drain, and a valve 4; wherein said valve 4 comprises an inlet in fluid communication with said water source, and further comprises an outlet in fluid communication with said chiller; wherein said bi-directional valve 14 comprises an inlet in fluid communication with said chiller, and further comprises an outlet in fluid communication with said valve 18, said bi-directional valve 9, and a valve 17; a valve 11 comprises an inlet in fluid communication with said pump 1, and further comprising an outlet in fluid communication with a valve 2, a valve 13, and a valve 19; wherein said valve 13 comprises an inlet in fluid communication with said valve 11 and a valve 12, and further comprises an outlet in fluid communication with said mash tun outlet; wherein said valve 2 comprises an inlet in fluid communication with said valve 11 and said valve 12, and further comprises an outlet in fluid communication with a MT Recirculation Flow Rate Restrictor; wherein said MT Recirculation Flow Rate Restrictor comprises an inlet in fluid communication with said valve 2, and further comprises an outlet in fluid communication with said HLT to MT heat exchanger fluid-in connector; wherein said HLT to MT heat exchanger fluid-in connector is in fluid communication with said MT Recirculation Flow Rate Restrictor and a HLT to MT Sparge Flow Rate Restrictor, and said HLT to MT heat exchanger fluid-out connector is in fluid communication with said mash tun inlet; wherein said bi-directional valve 9 comprises an inlet in fluid communication with said bi-directional valve 14, and further comprises an outlet in fluid communication with a valve 10 and a valve 8; wherein said valve 10 comprises an inlet in fluid communication with said bi-directional valve 9 and said valve 8, and further comprises an outlet in fluid communication with a pump 2; wherein said valve 12 comprises an inlet in fluid communication with said pump 2, and further comprises an outlet in fluid communication with said valves 2, 19, and 13; wherein said valve 8 comprises an inlet in fluid communication with said mash tun outlet, and further comprises an outlet in fluid communication with said valve 10 and said bi-directional valve 9; a MT to BK Sparge Flow Rate Restrictor comprising an inlet in fluid communication with said pump 3, and further comprises an outlet in fluid communication with a valve 15; wherein said valve 15 comprises an inlet in fluid communication with said MT to BK Sparge Flow Rate Restrictor, and further comprises an outlet in fluid communication with said boil kettle inlet; wherein said valve 19 comprises an inlet in fluid communication with said valve 11, and further comprises an outlet in fluid communication with said HLT to MT Sparge Flow Rate Restrictor; wherein said HLT to MT Sparge Flow Rate Restrictor comprises an inlet in fluid communication with said valve 19, and further comprises an outlet in fluid communication with said HLT to MT heat exchanger fluid-in connector; a fermenter comprising a fermenter inlet and a fermenter outlet, wherein said fermenter comprises a means for fermenting beer wort with yeast; wherein said valve 17 comprises an inlet in fluid communication with said bi-directional valve 14, and further comprises an outlet in fluid communication with said fermenter inlet; wherein said pump 3 disposed between the outflow side of said valve 18, and the inflow sides of said MT to BK Sparge Flow Rate Restrictor and said valve 16; wherein said pump 2 disposed between the outflow side of said valve 10, and the inflow side of said valve 12; wherein said pump 1 disposed between the outflow side of said valve 6, and the inflow side of said valves 1 and 11; a first T-connection comprising: (i) an inlet from the output of said water source, (ii) a first outlet to the input of said valve 3, and (iii) a second outlet to the input of said valve 4; a second T-connection comprising: (i) an inlet from the output of said pump 1, (ii) a first outlet to the input of said valve 11, and (iii) a second outlet to the input of said valve 1; a third T-connection comprising: (i) an inlet from the output of said pump 3, (ii) a first outlet to the input of said MT to BK Sparge Flow Rate Restrictor, (iii) a second outlet to the input of said valve 16; a fourth T-connection comprising: (i) a first inlet from the output of said valve 16, (ii) a second inlet from the output of said valve 15, and (iii) an outlet in fluid communication with said boil kettle inlet; a fifth T-connection comprising: (i) a first inlet from the output of said MT Recirculation Flow Rate Restrictor, (ii) a second inlet from the output of said HLT to MT Sparge Flow Rate Restrictor, and (iii) an outlet to the input of said HLT to MT heat exchanger fluid-in connector; a sixth T-connection comprising: (i) a first inlet from the output of said valve 11, (ii) a second inlet from the output of said valve 12, and (iii) an outlet to the first four-way connection; a seventh T-connection comprises: (i) an inlet from the output of said valve 13, (ii) a bi-directional connection to the mash tun bottom outlet, (iii) and an outlet to the input of said valve 8; wherein said first four-way connection comprising: (i) an inlet from the output of said sixth T-connection, (ii) a first outlet to the input of said valve 19, (iii) a second outlet to the input of said valve 2, (iv) and a third outlet to the input of said valve 13; a second four-way connection comprising: (i) a first connection to said bi-directional valve 7, (ii) a second connection to said bi-directional valve 9, (iii) an inlet from the output of said valve 8, (iv) and an outlet to the input of said valve 10; a third four-way connection comprising: (i) a first connection to said bi-directional valve 14, (ii) a second connection to said bi-directional valve 9, (ii) a first outlet to the input of said valve 18, and (iii) a second outlet to the input of said valve 17; and a fourth four-way connection comprising: (i) a first connection to said bi-directional valve 7, (ii) an inlet from the output of said valve 3, (ii) a second connection to said bi-directional valve 5, and (iii) an outlet to the input of said valve 6; wherein said hot liquor tank, mash tun, boil kettle, valves, flow-rate restrictors, heat exchanger, direct heat sources, water source, chiller, drain, and pumps are all electrically interconnected to a power source.

In still another exemplary embodiment of the automated beer brewing system, said water source is on; said valve 3 is open, providing a fluid flow path from said water source to said inlet of bi-directional valve 5; said bi-directional valve 5 is open, providing a fluid flow path from said outlet of bi-directional valve 5 to said hot liquor tank outlet; and said valves 1, 2, 4, 6-19 are closed, said HLT Recirculation, MT Recirculation, HLT to MT Sparge, and MT to BK Sparge Flow Rate Restrictors are not in use, and said pumps 1, 2, and 3 are off, providing a non-recirculating fluid flow path from said water source to said hot liquor tank outlet.

In another exemplary embodiment of the automated beer brewing system, said water source is on; said valve 3 is open, providing a fluid flow path from said water source to said inlet of bi-directional valve 7; said bi-directional valve 7 is open, providing a fluid flow path from said outlet of bi-directional valve 7 to said inlet of bi-directional valve 9; said bi-directional valve 9 is open, providing a fluid flow path from said outlet of bi-directional valve 9 to said inlet of valve 18; said valve 18 is open, providing a fluid flow path from said outlet of valve 18 to said pump 3; said pump 3 pumps said liquid to said inlet of valve 16; said valve 16 is open, providing a fluid flow path from said outlet of valve 16 to said boil kettle inlet; and said valves 1, 2, 4-6, 8, 10-15, 17, and 19 are closed, said HLT Recirculation, MT Recirculation, HLT to MT Sparge, and MT to BK Sparge Flow Rate Restrictors are not in use, and said pumps 1 and 2 are off, providing a non-recirculating fluid flow path from said water source to said boil kettle inlet.

In further exemplary embodiment of the automated beer brewing system, said bi-directional valve 5 is open, providing a fluid flow path from said hot liquor tank outlet to said inlet of valve 6; said valve 6 is open, providing a fluid flow path from said outlet of valve 6 to said pump 1; said pump 1 pumps said liquid to said inlet of valve 1; said valve 1 is open, providing a fluid flow path from said outlet of valve 1 to said inlet of the HLT Recirculation Flow Rate Restrictor; said HLT Recirculation Flow Rate Restrictor is open, providing a fluid flow path from said outlet of the HLT Recirculation Flow Rate Restrictor to said hot liquor tank inlet; and said valves 2-4, and 7-19 are closed, said HLT to MT Sparge, MT Recirculation, and MT to BK Sparge Flow Rate Restrictors are not in use, and said pumps 2 and 3 are off, providing a recirculating fluid flow path from said hot liquor tank outlet to said hot liquor tank inlet.

In another exemplary embodiment of the automated beer brewing system, said counter-flow water chiller plates are in fluid communication with said boil kettle outlet and said valve 14; said valve 14 is open, providing a fluid flow path from said counter-flow beer chiller plates to said inlet of valve 18; said valve 18 is open, providing a fluid flow path from said outlet of valve 18 to said pump 3; said pump 3 pumps said liquid to said inlet of valve 16; said valve 16 is open, providing a fluid flow path from said outlet of valve 16 to said boil kettle inlet; and said valves 1-13, 15, 17, and 19 are closed, said HLT Recirculation, MT Recirculation, HLT to MT Sparge, and MT to BK Sparge Flow Rate Restrictors are not in use, and said pumps 1 and 2 are off, providing a recirculating fluid flow path from said boil kettle outlet to said boil kettle inlet.

In still another exemplary embodiment of the automated beer brewing system, said bi-directional valve 5 is open, providing a fluid flow path from said hot liquor tank outlet to said inlet of valve 6; said valve 6 is open, providing a fluid flow path from said outlet of valve 6 to said pump 1; said pump 1 pumps said liquid to said inlet of valve 11; said valve 11 is open, providing a fluid flow path from said outlet of valve 11 to said inlet of valve 13; said valve 13 is open, providing a fluid flow path from said outlet of valve 13 to said mash tun outlet; and said valves 1-4, 7-10, 12, 14, and 15-19 are closed, said HLT Recirculation, MT Recirculation, HLT to MT Sparge, and MT to BK Sparge Flow Rate Restrictors are not in use, and said pumps 2 and 3 are off, providing a non-recirculating fluid flow path from said hot liquor tank outlet to said mash tun outlet.

In yet another exemplary embodiment of the automated beer brewing system, said bi-directional valve 5 is open, providing a fluid flow path from said hot liquor tank outlet to said inlet of valve 6; said valve 6 is open, providing a fluid flow path from said outlet of valve 6 to said pump 1; said pump 1 pumps said liquid to said inlet of valve 11; said valve 11 is open, providing a fluid flow path from said outlet of valve 11 to said inlet of valve 2; said valve 2 is open, providing a fluid flow path from said outlet of valve 2 to said inlet of the MT Recirculation Flow Rate Restrictor; said MT Recirculation Flow Rate Restrictor is open, providing a fluid flow path from said outlet of the MT Recirculation Flow Rate Restrictor to said HLT to MT heat exchanger fluid-in connector; said HLT to MT heat exchanger fluid-in connector is in fluid communication with said HLT to MT heat exchanger fluid-out connector, providing a fluid flow path from said HLT to MT heat exchanger fluid-in connector to said mash tun inlet; and said valves 1, 3, 4, 7-10, and 12-19 are closed, said HLT Recirculation, HLT to MT Sparge, and MT to BK Sparge Flow Rate Restrictors are not in use, and said pumps 2 and 3 are off, providing a non-recirculating fluid flow path from said hot liquor tank outlet to said mash tun inlet.

In further exemplary embodiment of the automated beer brewing system, said counter-flow water chiller plates are in fluid communication with said boil kettle outlet and said valve 14; said valve 14 is open, providing a fluid flow path from said counter-flow beer chiller plates to said inlet of bi-directional valve 9; said bi-directional valve 9 is open, providing a fluid flow path from said inlet of bi-directional valve 9 to said valve 10; said valve 10 is open, providing a fluid flow path from said outlet of valve 10 to said pump 2; said pump 2 pumps said liquid to said inlet of valve 12; said valve 12 is open, providing a fluid flow path from said outlet of valve 12 to said inlet of valve 13; said valve 13 is open, providing a fluid flow path from said outlet of valve 13 to said mash tun outlet; and said valves 1-8, 11, and 15-19 are closed, said HLT Recirculation, MT Recirculation, HLT to MT Sparge, and MT to BK Sparge Flow Rate Restrictors are not in use, and said pumps 1 and 3 are off, providing a non-recirculating fluid flow path from said boil kettle outlet to said mash tun outlet.

In another exemplary embodiment of the automated beer brewing system, said counter-flow water chiller plates are in fluid communication with said boil kettle outlet and said valve 14; said valve 14 is open, providing a fluid flow path from said counter-flow beer chiller plates to said inlet of bi-directional valve 9; said bi-directional valve 9 is open, providing a fluid flow path from said inlet of bi-directional valve 9 to said valve 10; said valve 10 is open, providing a fluid flow path from said outlet of valve 10 to said pump 2; said pump 2 pumps said liquid to said inlet of valve 12; said valve 12 is open, providing a fluid flow path from said outlet of valve 12 to said inlet of valve 2; said valve 2 is open, providing a fluid flow path from said outlet of valve 2 to said inlet of the MT Recirculation Flow Rate Restrictor; said MT Recirculation Flow Rate Restrictor is open, providing a fluid flow path from said outlet of the MT Recirculation Flow Rate Restrictor to said HLT to MT heat exchanger fluid-in connector; said HLT to MT heat exchanger fluid-in connector is in fluid communication with said HLT to MT heat exchanger fluid-out connector, providing a fluid flow path from said HLT to MT heat exchanger fluid-in connector to said mash tun inlet; and said valves 1, 3-8, 11, 13, and 15-19 are closed, said HLT Recirculation, HLT to MT Sparge, and MT to BK Sparge Flow Rate Restrictors are not in use, and said pumps 1 and 3 are off, providing a non-recirculating fluid flow path from said boil kettle outlet to said mash tun inlet.

In yet another exemplary embodiment of the automated beer brewing system, said water source is on; said valve 3 is open, providing a fluid flow path from said water source to said inlet of valve 6; said bi-directional valve 5 is open, providing a fluid flow path from said hot liquor tank outlet to said inlet of valve 6; said valve 6 is open, providing a fluid flow path from said outlet of valve 6 to said pump 1; said pump 1 pumps said liquid to said inlet of valve 1; said valve 1 is open, providing a fluid flow path from said outlet of valve 1 to said inlet of the HLT Recirculation Flow Rate Restrictor; said HLT Recirculation Flow Rate Restrictor is open, providing a fluid flow path from said outlet of the HLT Recirculation Flow Rate Restrictor to said hot liquor tank inlet; and said valves 2, 4, and 7-19 are closed, said MT Recirculation, HLT to MT Sparge, and MT to BK Sparge Flow Rate Restrictors are not in use, and said pumps 2 and 3 are off, providing a first non-recirculating fluid flow path from said water source to said hot liquor tank inlet, and a second recirculating fluid flow path from said hot liquor tank outlet to said hot liquor tank inlet. Fluid flow paths one and two can be alternated such that only one or the other is flowing at a given time.

In still another exemplary embodiment of the automated beer brewing system, said bi-directional valve 5 is open, providing a fluid flow path from said hot liquor tank outlet to said inlet of valve 6; said valve 6 is open, providing a fluid flow path from said outlet of valve 6 to said pump 1; said pump 1 pumps said liquid to said inlet of valve 1; said valve 1 is open, providing a fluid flow path from said outlet of valve 1 to said inlet of the HLT Recirculation Flow Rate Restrictor; said HLT Recirculation Flow Rate Restrictor is open, providing a fluid flow path from said outlet of the HLT Recirculation Flow Rate Restrictor to said hot liquor tank inlet; said valve 8 is open, providing a fluid flow path from said mash tun outlet to said inlet of valve 10; said valve 10 is open, providing a fluid flow path from said outlet of valve 10 to said pump 2; said pump 2 pumps said liquid to said inlet of valve 12; said valve 12 is open, providing a fluid flow path from said outlet of valve 12 to said inlet of valve 2; said valve 2 is open, providing a fluid flow path from said outlet of valve 2 to said inlet of the MT Recirculation Flow Rate Restrictor; said MT Recirculation Flow Rate Restrictor is open, providing a fluid flow path from said outlet of the MT Recirculation Flow Rate Restrictor to said HLT to MT heat exchanger fluid-in connector; said HLT to MT heat exchanger fluid-in connector is in fluid communication with said HLT to MT heat exchanger fluid-out connector, providing a fluid flow path from said HLT to MT heat exchanger fluid-in connector to said mash tun inlet; and said valves 3, 4, 7, 9, 11, and 13-19 are closed, said HLT to MT Sparge, and MT to BK Sparge Flow Rate Restrictors are not in use, and said pump 3 is off, providing a first recirculating fluid flow path from said hot liquor tank outlet to said hot liquor tank inlet, and a second recirculating fluid flow path from said mash tun outlet to said mash tun inlet.

In another exemplary embodiment of the automated beer brewing system, said bi-directional valve 5 is open, providing a fluid flow path from said hot liquor tank outlet to said inlet of valve 6; said valve 6 is open, providing a fluid flow path from said outlet of valve 6 to said pump 1; said pump 1 pumps said liquid to said inlet of valve 11; said valve 11 is open, providing a fluid flow path from said outlet of valve 11 to said inlet of valve 19; said valve 19 is open, providing a fluid flow path from said outlet of valve 19 to said inlet of the HLT to MT Sparge Flow Rate Restrictor; said HLT to MT Sparge Flow Rate Restrictor is open, providing a fluid flow path from said outlet of the HLT to MT Sparge Flow Rate Restrictor to said HLT to MT heat exchanger fluid-in connector; said HLT to MT heat exchanger fluid-in connector is in fluid communication with said HLT to MT heat exchanger fluid-out connector, providing a fluid flow path from said HLT to MT heat exchanger fluid-in connector to said mash tun inlet; said valve 8 is open, providing a fluid flow path from said mash tun outlet to said inlet of bi-directional valve 9; said bi-directional valve 9 is open, providing a fluid flow path from said outlet of bi-directional valve 9 to said inlet of valve 18; said valve 18 is open, providing a fluid flow path from said outlet of valve 18 to said pump 3; said pump 3 pumps said liquid to said inlet of the MT to BK Sparge Flow Rate Restrictor; said MT to BK Sparge Flow Rate Restrictor is open, providing a fluid flow path from said outlet of the MT to BK Sparge Flow Rate Restrictor to said inlet of valve 15; said valve 15 is open, providing a fluid flow path from said outlet of valve 15 to said boil kettle inlet; and said valves 1-4, 7, 10, 12-14, 16, and 17 are closed, said HLT Recirculation, MT Recirculation Flow Rate Restrictors are not in use, and said pump 2 is off, providing a first non-recirculating fluid flow path from said hot liquor tank outlet to said mash tun inlet, and a second non-recirculating fluid flow path from said mash tun outlet to said boil kettle inlet.

In still another exemplary embodiment of the automated beer brewing system, said counter-flow beer chiller plates are in fluid communication with said boil kettle outlet and said inlet of valve 14; said valve 14 is open, providing a fluid flow path from said counter-flow beer chiller plates to said inlet of valve 18; said valve 18 is open, providing a fluid flow path from said inlet of valve 18 to said pump 3; said pump 3 pumps said liquid to said inlet of valve 16; said valve 16 is open, providing a fluid flow path from said outlet of valve 16 to said boil kettle inlet; and said valves 1-13, 15, 17, and 19 are closed, said HLT Recirculation, MT Recirculation, HLT to MT Sparge, and MT to BK Sparge Flow Rate Restrictors are not in use, and said pumps 1 and 2 are off, providing a recirculating fluid flow path from said boil kettle outlet to said boil kettle inlet.

In yet another exemplary embodiment of the automated beer brewing system, said counter-flow beer chiller plates are in fluid communication with said boil kettle outlet and said inlet of valve 14; said valve 14 is open, providing a fluid flow path from said counter-flow beer chiller plates to said inlet of valve 18; said valve 18 is open, providing a fluid flow path from said inlet of valve 18 to said pump 3; said pump 3 pumps said liquid to said inlet of valve 16; said valve 16 is open, providing a fluid flow path from said outlet of valve 16 to said boil kettle inlet; said water source is on; said valve 4 is open, providing a fluid flow path from said outlet of valve 4 to said counter-flow water chiller plates; said counter-flow water chiller plates are in fluid communication with said drain, providing a fluid flow path from said counter-flow water chiller plates to said drain; and said valves 1-3, 5-13, 15, 17, and 19 are closed, said HLT Recirculation, MT Recirculation, HLT to MT Sparge, and MT to BK Sparge Flow Rate Restrictors are not in use, and said pumps 1 and 2 are off, providing a first recirculating fluid flow path from said boil kettle outlet to said boil kettle inlet, and a second non-recirculating fluid flow path from said water source to said drain.

In another exemplary embodiment of the automated beer brewing system, said counter-flow beer chiller plates are in fluid communication with said boil kettle outlet and said inlet of valve 14; said valve 14 is open, providing a fluid flow path from said counter-flow beer chiller plates to said inlet of valve 17; said valve 17 is open, providing a fluid flow path from said outlet of valve 14 to said fermenter inlet; and said valves 1-13, 15, 16, 18, and 19 are closed, said HLT Recirculation, MT Recirculation, HLT to MT Sparge, and MT to BK Sparge Flow Rate Restrictors are not in use, and said pumps 1, 2, and 3 are off, providing a non-recirculating fluid flow path from said boil kettle outlet to said fermenter inlet.

An exemplary embodiment of an automated beer brewing system comprising a hot liquor tank comprising a tank inlet and a tank outlet, wherein said hot liquor tank comprises a means for heating liquid; a mash tun having a tun inlet and a tun outlet; wherein said mash tun optionally comprises a means for heating liquid; a boil kettle comprising a kettle inlet and a kettle outlet, wherein said boil kettle comprises a means for heating liquid; a valve 4 comprising an inlet in fluid communication with said hot liquor tank outlet, and further comprising an outlet in fluid communication with a pump 1; a valve 2 comprising an inlet in fluid communication with said pump 1, and further comprising an outlet in fluid communication with said hot liquor tank inlet; a valve 6 comprises an inlet in fluid communication with said pump 1, and further comprising an outlet in fluid communication with a valve 8; wherein said pump 1 disposed between the outflow side of said valve 4, and the inflow sides of said valves 2 and 6; wherein said valve 8 comprises an inlet in fluid communication with said valve 6 and a valve 10, and further comprises an outlet in fluid communication with said heat exchanger and said mash tun inlet; a valve 11 comprising an inlet in fluid communication with said mash tun outlet, and further comprising an outlet in fluid communication with a pump 2; wherein said valve 10 comprises an inlet in fluid communication with said pump 2, and an further comprises outlet in fluid communication with said valve 8; a heat exchanger located between said valve 8 and said mash tun inlet, said heat exchanger containing means for heating beer wort; a valve 12 comprising an inlet in fluid communication with said pump 2, and further comprising an outlet in fluid communication with a valve 13; wherein said pump 2 disposed between the outflow side of said valve 11, and the inflow side of said valves 10 and 12; wherein said valve 13 comprises an inlet in fluid communication with said valve 12 and a valve 15, and further comprises an outlet in fluid communication with said boil kettle inlet; wherein said valve 15 comprises an inlet in fluid communication with a pump 3, and further comprises an outlet in fluid communication with said valve 13; a valve 16 comprising an inlet in fluid communication with said boil kettle outlet, and further comprising an outlet in fluid communication with said pump 3; wherein said pump 3 disposed between the outflow side of said valve 16, and the inflow side of said valve 15; a fermenter comprising a fermenter inlet, and a fermenter outlet, and a means for fermenting beer wort with yeast; a valve 17 comprising an inlet in fluid communication with said boil kettle outlet, and further comprising an outlet in fluid communication with said fermenter inlet; a first T-connection comprising: (i) an inlet from the output of said pump 1, (ii) a first outlet to the input of said valve 2, and (iii) a second outlet to the input of said valve 6; a second T-connection comprising: (i) a first inlet from the output of said valve 6, (ii) a second inlet from the output of said valve 10, (iii) an outlet to the input of said valve 8; a third T-connection comprising: (i) an inlet from the output of said pump 2, (ii) a first outlet to the input of said valve 10, and (iii) a second outlet to the input of said valve 12; a fourth T-connection comprising: (i) a first inlet from the output of said valve 12, (ii) a second inlet from the output of said valve 15 and (iii) an outlet to the input of said valve 13; and a fifth T-connection comprising: (i) an inlet from the output of said boil kettle outlet, (ii) a first outlet to the input of said valve 17, and (iii) a second outlet to the input of said valve 16; wherein said hot liquor tank, mash tun, boil kettle, valves, direct heat sources, and pumps are all electrically interconnected to a power source.

In further exemplary embodiment of the automated beer brewing system, said liquid in said hot liquor tank is heated; said valve 4 is open, providing a fluid flow path from said hot liquor tank outlet to said pump 1; said pump 1 pumps said liquid to said inlet of valve 2; said valve 2 is open, providing a fluid flow path from said outlet of valve 2 to said hot liquor tank inlet; and said valves 6, 8, 10, 11, 12, 13, 15, 16, and 17 are closed, and said pumps 2 and 3 are off, providing a recirculating fluid flow path from said hot liquor tank outlet to said hot liquor tank inlet.

In further exemplary embodiment of the automated beer brewing system, said valve 4 is open, providing a fluid flow path from said hot liquor tank outlet to said pump 1; said pump 1 pumps said liquid to said inlet of valve 6; said valve 6 is open, providing a fluid flow path from said outlet of valve 6 to said inlet of valve 8; said valve 8 is open, providing a fluid flow path from said outlet of valve 8 to said mash tun inlet; and said valves 2, 10-13, and 15-17 are closed, and said pumps 2 and 3 are off, providing a non-recirculating fluid flow path from said hot liquor tank outlet to said mash tun inlet.

In further exemplary embodiment of the automated beer brewing system, said valve 4 is open, providing a fluid flow path from said hot liquor tank outlet to said pump 1; said pump 1 pumps said liquid to said inlet of valve 2; said valve 2 is open, providing a fluid flow path from said outlet of valve 2 to said hot liquor tank inlet; said valve 11 is open, providing a fluid flow path from said mash tun outlet to said pump 2; said pump 2 pumps said liquid to said inlet of valve 10; said valve 10 is open, providing a fluid flow path from said outlet of valve 10 to said inlet of valve 8; said valve 8 is open, providing a fluid flow path from said outlet of valve 8 to said mash tun inlet; said heat exchanger located between said valve 8 and said mash tun inlet heats said fluid from the outlet of said valve 8 to said mash tun inlet; and said valves 6, 12, 13, 15, 16, and 17 are closed, and said pump 3 is off, providing a first recirculating fluid flow path from said hot liquor tank outlet to said hot liquor tank inlet, and a second recirculating fluid flow path from said mash tun outlet to said mash tun inlet.

In further exemplary embodiment of the automated beer brewing system, said valve 4 is open, providing a fluid flow path from said hot liquor tank outlet to said pump 1; said pump 1 pumps said liquid to said inlet of valve 6; said valve 6 is open, providing a fluid flow path from said outlet of valve 6 to said inlet of valve 8; said valve 8 is open, providing a fluid flow path from said outlet of valve 8 to said mash tun inlet; said valve 11 is open, providing a fluid flow path from said mash tun outlet to said pump 2; said pump 2 pumps said liquid to said inlet of valve 12; said valve 12 is open, providing a fluid flow path from said outlet of valve 12 to said inlet of valve 13; said valve 13 is open, providing a fluid flow path from said outlet of valve 13 to said boil kettle inlet; and said valves 2, 10, and 15-17 are closed, and said pump 3 is off, providing a first non-recirculating fluid flow path from said hot liquor tank outlet to said mash tun inlet, and providing a second non-recirculating fluid flow path from said mash tun outlet to said boil kettle inlet.

In further exemplary embodiment of the automated beer brewing system, said liquid in said boil kettle is heated; said valve 16 is open, providing a fluid flow path from said boil kettle outlet to said pump 3; said pump 3 pumps said liquid to said inlet of valve 15; said valve 15 is open, providing a fluid flow path from said outlet of valve 15 to said inlet of valve 13; said valve 13 is open, providing a fluid flow path from said outlet of valve 13 to said boil kettle inlet; and said valves 2, 4, 6, 8, 10-12, and 17 are closed, and said pumps 1 and 2 are off, providing a recirculating fluid flow path from said boil kettle outlet to said boil kettle inlet.

In further exemplary embodiment of the automated beer brewing system, said valve 17 is open, providing a fluid flow path from said boil kettle outlet to said inlet of valve 17; said valves 2, 4, 6, 8, 10-13, 15, and 16 are closed, and said pumps 1, 2, and 3 are off, providing a fluid flow path from said outlet of valve 17 to said fermenter inlet.

An exemplary automated beer brewing system comprises a hot liquor tank comprising a tank inlet and a tank outlet, wherein said hot liquor tank comprises a HLT to MT heat exchanger and comprises a means for heating liquid; wherein said HLT to MT Heat Exchanger comprises a coil physically located inside said hot liquor tank and where the fluid-in and fluid-out connections to said coil are physically located outside said hot liquor tank, wherein said HLT to MT Heat Exchanger comprises a means for heating liquid; a mash tun comprising a tun inlet and a tun outlet, wherein said mash tun optionally comprises a means for heating liquid; a boil kettle comprising a kettle inlet and a kettle outlet, wherein said boil kettle comprises a means for heating liquid; a fermenter comprising a fermenter inlet and a fermenter outlet, wherein said fermenter comprises a means for fermenting beer wort with yeast; a water source, wherein said water source comprises a means for dispensing water; a drain, wherein said drain comprises a means for draining liquid; a chiller comprising a series of alternating plates containing counter-flow beer and water, wherein said chiller plates contain a means for heat exchange between said beer and said water without mixing said fluids; a valve 3 comprising an inlet in fluid communication with said water source, and further comprising an outlet in fluid communication with a valve 2 and a valve 6; wherein said valve 2 comprises an inlet in fluid communication with said valve 3 and a pump 1, and further comprises an outlet in fluid communication with a HLT Recirculation Flow Rate Restrictor; wherein said HLT Recirculation Flow Rate Restrictor comprises an inlet in fluid communication with said valve 2, and further comprises an outlet in fluid communication with said hot liquor tank inlet; wherein said valve 6 comprises an inlet in fluid communication with said valve 3 and said pump 1, and further comprises an outlet in fluid communication with a valve 9, a MT Recirculation Flow Rate Restrictor, and a bi-directional valve 10; wherein said bi-directional valve 10 comprises an inlet in fluid communication with said valve 6, and further comprises an outlet in fluid communication with a bi-directional valve 12; wherein said bi-directional valve 12 comprises an inlet in fluid communication with said bi-directional valve 10, and further comprises an outlet in fluid communication with a BK Recirculation Flow Rate Restrictor; wherein said BK Recirculation Flow Rate Restrictor comprises an inlet in fluid communication with said bi-directional valve 12 and a valve 15, and further comprises an outlet in fluid communication with a valve 13; wherein said valve 13 comprises an inlet in fluid communication with said BK Recirculation Flow Rate Restrictor, and further comprises an outlet in fluid communication with said boil kettle inlet; a valve 4 comprising an inlet in fluid communication with said hot liquor tank outlet, and further comprising an outlet in fluid communication with said pump 1; wherein said pump 1 disposed between the outflow side of said valve 4 and the inflow side of said valves 2 and 6; wherein said valve 15 comprises an inlet in fluid communication with a pump 3, and further comprises an outlet in fluid communication with said BK Recirculation Flow Rate Restrictor and said bi-directional valve 12; a valve 16 comprising an inlet in fluid communication with said alternating beer chiller plates, and further comprising an outlet in fluid communication with said pump 3; wherein said alternating beer chiller plates are in fluid communication with said boil kettle outlet and a valve 17; wherein said pump 3 disposed between the outflow side of said valve 16, and the inflow side of said valve 15; wherein said valve 9 comprises an inlet in fluid communication with said valve 6 and said bi-directional valve 10, and further comprises an outlet in fluid communication with said mash tun outlet; wherein said bi-directional valve 12 comprises an inlet in fluid communication with said valve 15, and further comprises an outlet in fluid communication with said bi-directional valve 10; wherein said bi-directional valve 10 comprises an inlet in fluid communication with said bi-directional valve 12 and said pump 2, and further comprises an outlet in fluid communication with said valve 9 and a MT Recirculation Flow Rate Restrictor; a valve 11 comprising an inlet in fluid communication with said mash tun outlet, and further comprising an outlet in fluid communication with a pump 2; wherein said MT Recirculation Flow Rate Restrictor comprises an inlet in fluid-communication with said bi-directional valve 10, and further comprises an outlet in fluid communication with a valve 8; wherein said valve 8 comprises an inlet in fluid communication with said MT Recirculation Flow Rate Restrictor, and further comprises an outlet in fluid communication with said HLT to MT Heat Exchanger fluid-in connector; wherein said HLT to MT Heat Exchanger fluid-out connector is in fluid communication with said mash tun inlet; wherein said MT to BK Sparge Flow Rate Restrictor comprises an inlet in fluid communication with said bi-directional valve 12, and further comprises an outlet in fluid communication with a valve 14; wherein said valve 14 comprises an inlet in fluid communication with said MT to BK Sparge Flow Rate Restrictor, and further comprises an outlet in fluid communication with said boil kettle inlet; wherein said HLT to MT Sparge Flow Rate Restrictor comprises an inlet in fluid communication with said valve 6, and further comprises an outlet in fluid communication with a valve 7; wherein said valve 7 comprises an inlet in fluid communication with said HLT to MT Sparge Flow Rate Restrictor, and further comprises an outlet in fluid communication with said HLT to MT Heat Exchanger fluid-in connector; a valve 5 comprising an inlet in fluid communication with said water source, and further comprising an outlet in fluid communication with said alternating water chiller plates; wherein said alternating water chiller plates are in fluid communication with said drain; wherein said valve 17 comprises an inlet in fluid communication with said alternating beer chiller plates, and further comprises an outlet in fluid communication with said fermenter inlet; wherein said pump 2 disposed between the outflow side of said valve 11 and the inflow side of said bi-directional valves 12 and 10; a first T-connection comprising: (i) an inlet from the output of said water source, (ii) a first outlet to the input of said valve 3, and (iii) a second outlet to the input of said valve 5; a second T-connection comprising: (i) an inlet from the output of said pump 2, (ii) a first outlet to the input of said bi-directional valve 10, and (iii) a second outlet to the input of said bi-directional valve 12; a third T-connection comprising: (i) an inlet from the output of said alternating beer chiller plates, (ii) a first outlet to the input of said valve 17, and (iii) a second outlet to the input of said valve 16; a fourth T-connection comprising: (i) a first inlet from the output of said valve 7, (ii) a second inlet from the output of said valve 8, and (iii) an outlet to the input of said HLT to MT Heat Exchanger fluid-in connector; a fifth T-connection comprising: (i) a first inlet from the output of said valve 13, (ii) a second inlet from the output of said valve 14, and (iii) an outlet to the input of said boil kettle inlet; a sixth T-connection comprising: (i) a first inlet from the output of said valve 15, (ii) a second inlet from the output of said bi-directional valve 12, and (iii) a first outlet to the input of a seventh T-connection; a seventh T-connection comprising: (i) an inlet from the output of said sixth T-connection, (ii) a first outlet to the input of said BK Recirculation Flow Rate Restrictor, and (iii) a second outlet to the input of said MT to BK Sparge Flow Rate Restrictor; an eighth T-connection comprising: (i) an inlet from the output of said bi-directional valve 10, (ii) a second inlet from the output of said valve 6, and (iii) an outlet to the input of a first four-way connection; a first four-way connection comprising: (i) an inlet from the output of said eighth T-connection, (ii) a first outlet to the input of said HLT to MT Sparge Flow Rate Restrictor, (ii) a second outlet to the input of said MT Recirculation Flow Rate Restrictor, and (iii) a third outlet to the input of said valve 9; a ninth T-connection comprising (i) a bi-directional connection to said mash tun outlet, (ii) an outlet to the input of said valve 11; and (iii) an inlet from the output of said valve 9; and a second four-way connection comprising: (i) a first inlet from the output of said valve 3, (ii) a second inlet from the output of said pump 1, (ii) a first outlet to the input of said valve 2, and (iii) a second outlet to the input of said valve 6; wherein said hot liquor tank, mash tun, boil kettle, valves, flow-rate restrictors, heat exchanger, water source, direct heat sources, chiller, drain, and pumps are all electrically interconnected to a power source.

In still another exemplary embodiment of the automated beer brewing system, said water source is on; said valve 3 is open, providing a fluid flow path from said water source to said inlet of valve 2; said valve 2 is open, providing a fluid flow path from said outlet of valve 2 to said inlet of the HLT Recirculation Flow Rate Restrictor; said HLT Recirculation Flow Rate Restrictor is open, providing a fluid flow path from said outlet of the HLT Recirculation Flow Rate Restrictor to said hot liquor tank inlet; and said valves 4-17 are closed, said MT Recirculation, BK Recirculation, HLT to MT Sparge, and MT to BK Sparge Flow Rate Restrictors are not in use, and said pumps 1, 2, and 3 are off, providing a non-recirculating fluid flow path from said water source to said hot liquor tank inlet.

In further exemplary embodiment of the automated beer brewing system, said water source is on; said valve 3 is open, providing a fluid flow path from said water source to said inlet of valve 6; said valve 6 is open, providing a fluid flow path from said outlet of valve 6 to said inlet of bi-directional valve 10; said bi-directional valve 10 is open, providing a fluid flow path from said outlet of bi-directional valve 10 to said inlet of bi-directional valve 12; said bi-directional valve 12 is open, providing a fluid flow path from said outlet of bi-directional valve 12 to said inlet of the BK Recirculation Flow Rate Restrictor; said BK Recirculation Flow Rate Restrictor is open, providing a fluid flow path from said outlet of the BK Recirculation Flow Rate Restrictor to said inlet of valve 13; said valve 13 is open, providing a fluid flow path from said outlet of valve 13 to said boil kettle inlet; and said valves 2, 4, 5, 7-9, 11, and 14-17 are closed, said HLT Recirculation, MT Recirculation, HLT to MT Sparge, and MT to BK Sparge Flow Rate Restrictors are not in use, and said pumps 1, 2, and 3 are off, providing a non-recirculating fluid flow path from said water source to said boil kettle inlet.

In yet another exemplary embodiment of the automated beer brewing system, said valve 4 is open, providing a fluid flow path from said hot liquor tank outlet to pump 1; said pump 1 pumps said liquid to said inlet of valve 2; said valve 2 is open, providing a fluid flow path from said outlet of valve 2 to said inlet of the HLT Recirculation Flow Rate Restrictor; said HLT Recirculation Flow Rate Restrictor is open, providing a fluid flow path from said outlet of the HLT Recirculation Flow Rate Restrictor to said hot liquor tank inlet; and said valves 3, and 5-17 are closed, said MT Recirculation, BK Recirculation, HLT to MT Sparge, and MT to BK Sparge Flow Rate Restrictors are not in use, and said pumps 2 and 3 are off, providing a recirculating fluid flow path from said hot liquor tank outlet to said hot liquor tank inlet.

In another exemplary embodiment of the automated beer brewing system, said counter-flow water chiller plates are in fluid communication with said boil kettle outlet and said inlet of valve 16; said valve 16 is open, providing a fluid flow path from said counter-flow water chiller plates to said pump 3; said pump 3 pumps said liquid to said inlet of valve 15; said valve 15 is open, providing a fluid flow path from said outlet of valve 15 to said inlet of the BK Recirculation Flow Rate Restrictor; said BK Recirculation Flow Rate Restrictor is open, providing a fluid flow path from said outlet of the BK Recirculation Flow Rate Restrictor to said inlet of valve 13; said valve 13 is open, providing a fluid flow path from said outlet of valve 13 to said boil kettle inlet; said valves 2-12, 14, and 17 are closed, said HLT Recirculation, MT Recirculation, HLT to MT Sparge, and MT to BK Sparge Flow Rate Restrictors are not in use, and said pumps 1 and 2 are off, providing a recirculating fluid flow path from said boil kettle outlet to said boil kettle inlet.

In further exemplary embodiment of the automated beer brewing system, said valve 4 is open, providing a fluid flow path from said hot liquor tank outlet to said pump 1; said pump 1 pumps said liquid to said inlet of valve 6; said valve 6 is open, providing a fluid flow path from said outlet of valve 6 to said inlet of valve 9; said valve 9 is open, providing a fluid flow path from said outlet of valve 9 to said mash tun outlet; and said valves 2, 3, 5, 7, 8, and 10-17 are closed, said HLT Recirculation, MT Recirculation, BK Recirculation, HLT to MT Sparge, and MT to BK Sparge Flow Rate Restrictors are not in use, and said pumps 2 and 3 are off, providing a non-recirculating fluid flow path from said hot liquor tank outlet to said mash tun outlet.

In another exemplary embodiment of the automated beer brewing system, said counter-flow water chiller plates are in fluid communication with said boil kettle outlet and said inlet of valve 16; said valve 16 is open, providing a fluid flow path from said counter-flow water chiller plates to said pump 3; said pump 3 pumps said liquid to said inlet of valve 15; said valve 15 is open, providing a fluid flow path from said outlet of valve 15 to said inlet of bi-directional valve 12; said bi-directional valve 12 is open, providing a fluid flow path from said outlet of valve 12 to said inlet of bi-directional valve 10; said bi-directional valve 10 is open, providing a fluid flow path from said outlet of bi-directional valve 10 to said inlet of valve 9; said valve 9 is open, providing a fluid flow path from said outlet of valve 9 to said mash tun outlet; and said valves 2-8, 11, 13, 14, and 17 are closed, said HLT Recirculation, MT Recirculation, BK Recirculation, HLT to MT Sparge, and MT to BK Sparge Flow Rate Restrictors are not in use, and said pumps 1 and 2 are off, providing a non-recirculating fluid flow path from said boil kettle outlet to said mash tun outlet.

In another exemplary embodiment of the automated beer brewing system, said valve 3 is open, providing a fluid flow path from said water source to said inlet of valve 2; said valve 4 is open, providing a fluid flow path from said hot liquor tank outlet to pump 1; said pump 1 pumps said liquid to said inlet of valve 2; said valve 2 is open, providing a fluid flow path from said outlet of valve 2 to said inlet of the HLT Recirculation Flow Rate Restrictor; said HLT Recirculation Flow Rate Restrictor is open, providing a fluid flow path from said outlet of the HLT Recirculation Flow Rate Restrictor to said hot liquor tank inlet; and said valves 5-17 are closed, said MT Recirculation, BK Recirculation, HLT to MT Sparge, and MT to BK Sparge Flow Rate Restrictors are not in use, and said pumps 2 and 3 are off, providing a first non-recirculating fluid flow path from said water source to said hot liquor tank inlet, and a second recirculating fluid flow path from said hot liquor outlet to said hot liquor tank inlet.

In further exemplary embodiment of the automated beer brewing system, said valve 4 is open, providing a fluid flow path from said hot liquor tank outlet to pump 1; said pump 1 pumps said liquid to said inlet of valve 2; said valve 2 is open, providing a fluid flow path from said outlet of valve 2 to said inlet of the HLT Recirculation Flow Rate Restrictor; said HLT Recirculation Flow Rate Restrictor is open, providing a fluid flow path from said outlet of the HLT Recirculation Flow Rate Restrictor to said hot liquor tank inlet; said valve 11 is open, providing a fluid flow path from said mash tun outlet to said pump 2; said pump 2 pumps said liquid to said inlet of bi-directional valve 10; said bi-directional valve 10 is open, providing a fluid flow path from said outlet of bi-directional valve 10 to said inlet of the MT Recirculation Flow Rate Restrictor; said MT Recirculation Flow Rate Restrictor is open, providing a fluid flow path from said outlet of the MT Recirculation Flow Rate Restrictor to said inlet of valve 8; said valve 8 is open, providing a fluid flow path from said outlet of valve 8 to said HLT to MT Heat Exchanger fluid-in connector; said HLT to MT Heat Exchanger fluid-in connector is in fluid communication with said HLT to MT Heat Exchanger fluid-out connector, providing a fluid flow path from said HLT to MT Heat Exchanger fluid-in connector to said mash tun inlet; and said valves 3, 5-7, 9, and 12-17 are closed, said BK Recirculation, HLT to MT Sparge, and MT to BK Sparge Flow Rate Restrictors are not in use, and said pump 3 is off, providing a first recirculating fluid flow path from said hot liquor tank outlet to said hot liquor tank inlet, and a second recirculating fluid flow path from said mash tun outlet to said mash tun inlet.

In still another exemplary embodiment of the automated beer brewing system, said valve 4 is open, providing a fluid flow path from said hot liquor tank outlet to said pump 1; said pump 1 pumps said liquid to said inlet of valve 6; said valve 6 is open, providing a fluid flow path from said outlet of valve 6 to said inlet of the HLT to MT Sparge Flow Rate Restrictor; said HLT to MT Sparge Flow Rate Restrictor is open, providing a fluid flow path from said outlet of the HLT to MT Sparge Flow Rate Restrictor to said inlet of valve 7; said valve 7 is open, providing a fluid flow path from said outlet of valve 7 to said HLT to MT Heat Exchanger fluid-in connector; said HLT to MT Heat Exchanger fluid-in connector is in fluid communication with said HLT to MT Heat Exchanger fluid-out connector, providing a fluid flow path from said HLT to MT Heat Exchanger fluid-in connector to said mash tun inlet; said valve 11 is open, providing a fluid flow path from said mash tun outlet to said pump 2; said pump 2 pumps said liquid to said inlet of bi-directional valve 12; said bi-directional valve 12 is open, providing a fluid flow path from said outlet of bi-directional valve 12 to said inlet of the MT to BK Sparge Flow Rate Restrictor; said MT to BK Sparge Flow Rate Restrictor is open, providing a fluid flow path from said outlet of the MT to BK Sparge Flow Rate Restrictor to said inlet of valve 14; said valve 14 is open, providing a fluid flow path from said outlet of valve 14 to said boil kettle inlet; and said valves 2, 3, 5, 8-10, 13, and 15-17 are closed, said HLT Recirculation, MT Recirculation, and BK Recirculation Flow Rate Restrictors are not in use, and said pump 3 is off, providing a first non-recirculating fluid flow path from said hot liquor tank outlet to said mash tun inlet, and a second non-recirculating fluid flow path from said mash tun outlet to said boil kettle inlet.

In another exemplary embodiment of the automated beer brewing system, said counter-flow beer chiller plates are in fluid communication with said boil kettle outlet and said inlet of valve 16; said valve 16 is open, providing a fluid flow path from said counter-flow beer chiller plates to said pump 3; said pump 3 pumps said liquid to said inlet of valve 15; said valve 15 is open, providing a fluid flow path from said outlet of valve 15 to said inlet of the BK Recirculation Flow Rate Restrictor; said BK Recirculation Flow Rate Restrictor is open, providing a fluid flow path from said outlet of the BK Recirculation Flow Rate Restrictor to said inlet of valve 13; said valve 13 is open, providing a fluid flow path from said outlet of valve 13 to said boil kettle inlet; said valves 2-12, 14, and 17 are closed, said HLT Recirculation, MT Recirculation, HLT to MT Sparge, and MT to BK Sparge Flow Rate Restrictors are not in use, and said pumps 1 and 2 are off, providing a recirculating fluid flow path from said boil kettle outlet to said boil kettle inlet.

In still another exemplary embodiment of the automated beer brewing system, said counter-flow beer chiller plates are in fluid communication with said boil kettle outlet and said inlet of valve 16; said valve 16 is open, providing a fluid flow path from said counter-flow beer chiller plates to said pump 3; said pump 3 pumps said liquid to said inlet of valve 15; said valve 15 is open, providing a fluid flow path from said outlet of valve 15 to said inlet of the BK Recirculation Flow Rate Restrictor; said BK Recirculation Flow Rate Restrictor is open, providing a fluid flow path from said outlet of the BK Recirculation Flow Rate Restrictor to said inlet of valve 13; said valve 13 is open, providing a fluid flow path from said outlet of valve 13 to said boil kettle inlet; said water source is on; said valve 5 is open, providing a fluid flow path from said outlet of valve 5 to said counter-flow water chiller plates; said counter-flow water chiller plates are in fluid communication with said drain, providing a fluid flow path from said counter-flow water chiller plates to said drain; and said valves 2-4, 6-12, 14, and 17 are closed, said HLT Recirculation, MT Recirculation, HLT to MT Sparge, and MT to BK Sparge Flow Rate Restrictors are not in use, said pumps 1 and 2 are off, providing a first recirculating fluid flow path from said boil kettle outlet to said boil kettle inlet, and a second non-recirculating fluid flow path from said water source to said drain.

In another exemplary embodiment of the automated beer brewing system, said valve 17 is open, providing a fluid flow path from said boil kettle outlet to said inlet of valve 17; and said valves 2-16 are closed, said HLT Recirculation, MT Recirculation, BK Recirculation, HLT to MT Sparge, and MT to BK Sparge Flow Rate Restrictors are not in use, and said pumps 1, 2, and 3 are off, providing a non-recirculating fluid flow path from said boil kettle outlet to said fermenter inlet.

The foregoing, and other features and advantages of the disclosure, will be apparent from the following, more particular description of the exemplary embodiments of the disclosure, the accompanying drawings, and the claims.

### BRIEF DESCRIPTION OF THE DRAWINGS

For a more complete understanding of the present disclosure, the objects and advantages thereof, reference is now made to the ensuing description taken in connection with the accompanying drawings briefly described as follows.

FIG. 1 is an exemplary embodiment of a simple version of a two-pump brewing system.

FIG. 2 is an exemplary embodiment of complex version of another two-pump brewing system.

FIG. 3 is an exemplary embodiment of a simple version of another two-pump brewing system.

FIG. 4 is an exemplary embodiment of complex version of a further two-pump brewing system.

FIG. 5 is an exemplary embodiment of a simple version of a three-pump brewing system.

FIG. 6 is an exemplary embodiment of a complex version of another three-pump brewing system.

FIG. 7 is an exemplary embodiment of simple version of another three-pump brewing system.

FIG. 8 is an exemplary embodiment of a complex version of a further three-pump brewing system.

### DETAILED DESCRIPTION

The present disclosure provides an automated three-vessel brewing apparatus. As used in the description herein and throughout the claims that follow, the meaning of “a”, “an”, and “the” includes plural reference unless the context clearly dictates otherwise. Also, as used in the description herein, the meaning of “in” includes “into” and “on” unless the context clearly dictates otherwise. As used in the description herein and throughout the claims that follow, the terms “use” and “configured” may be used interchangeably.

The process of brewing beer can be divided into two main steps. The first step is making the wort. Wort is an aqueous solution of extracted grain sugars, proteins, gums, and non-fermentable low molecular weight carbohydrates (called dextrins) which does not contain alcohol. The process of making the wort begins with the brewer adding water to crushed malted grains. The mixture of crushed malted grains and water (called grist) is taken through one or more temperature rests for various times to result in a desired wort consistency. The conversion of grist to wort through these temperature and time rests is known as mashing. The goal of mashing is to convert the grain starches into sugars and less complex carbohydrates using the natural enzymes found in the malted grain. At the end of the mash, the brewer raises the temperature of the mash high enough to denature the natural grain enzymes such that no further carbohydrate conversion takes place (i.e., mashing out).

The next step in making the wort involves adding hot water to the top of the grains to rinse the grains and extract the sugars from the grain husks while simultaneously draining and filtering out the sugary water from the bottom of the grains and collecting it into a boil kettle (i.e., lautering or sparging). The brewer then boils the wort with hops to concentrate the wort and to impart the desired hop bitterness, hop flavor, and hop aroma. Finally, the boiled and hopped wort is strained off all hop particulates and coagulated proteins and is cooled to yeast pitching temperatures, thereby yielding fermentable wort. It is important to note that much of the process of making the wort involves very tight temperature control as mash temperature fluctuations of less than 2° F. can lead to beer with drastically different characteristics. Furthermore, the process of making the wort involves fluid transfers between/among multiple separate brewing vessels.

The second step of brewing beer is fermentation. After the wort is created and cooled, the wort is fermented by adding yeast. Yeast converts the fermentable sugars into ethanol and carbon dioxide, eventually resulting in beer.

The present disclosure is directed to, but not exclusively limited to, 8 exemplary brewing systems, each of which automates the process of making wort such that the temperature and time rests, the fluid transfers among multiple brewing vessels, the boiling of the wort, and the cooling of the wort are all computer-controlled. In this way, after initial setup of ingredient additions into the proper vessels and programming of the automation controller by the brewer, each of the 8 brewing systems described herein executes the various steps of the brewing process without human intervention and with the utmost precision, accuracy, and repeatability. After each of the 8 exemplary brewing systems generates the cooled fermentable wort, the brewer is then in charge of fermenting the mixture into beer. It should be noted that it in some exemplary embodiments, each of the 8 exemplary brewing systems may also automate the fermentation process.

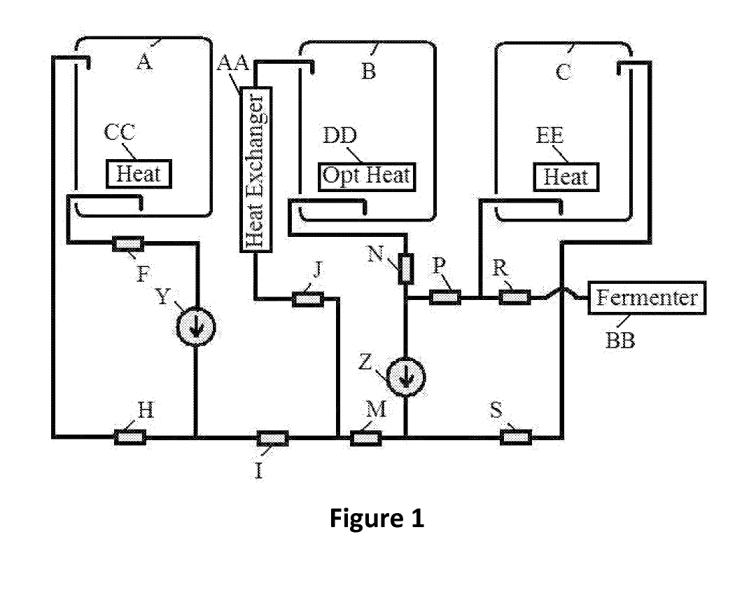

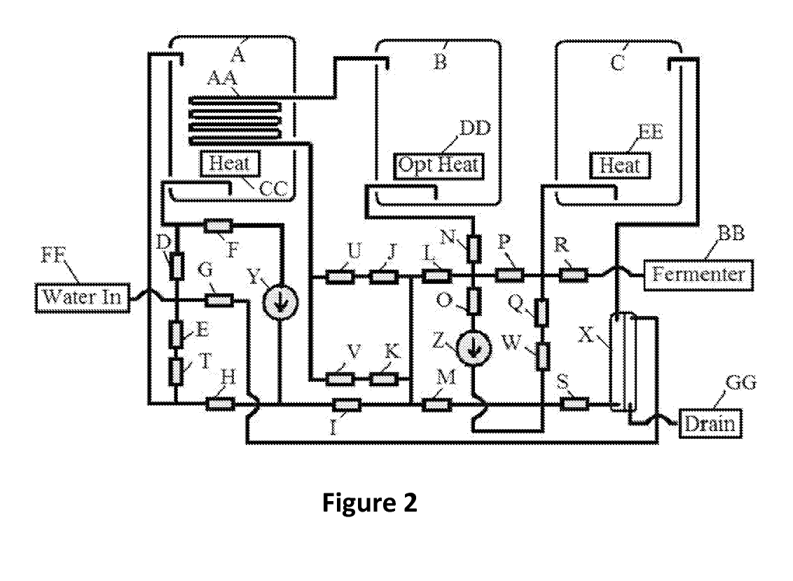

In an exemplary embodiment, in Step 1, a brewing vessel is filled with cold water to be heated and used as strike water. Strike water is the hot water that is added to the crushed grains contained in a second brewing vessel called the Mash Tun (MT). FIGS. 1, 3, 5, and 7 illustrate exemplary brewing systems that require the user to manually fill the Hot Liquor Tank (HLT) with water to the proper level. Exemplary brewing systems with automated fill (as illustrated in FIGS. 2, 4, 6, and 8) do not require a pump, since the water source is pressurized such as in an ordinary or typical tap water connection. In exemplary brewing systems with a HLT to MT Heat exchanger Coil located physically inside the HLT vessel, (as illustrated in FIGS. 2, 4, 6, and 8), enough water needs to be added such that after addition of the strike water to the MT, enough water is left in the HLT to completely submerge the heat exchanger coil. Completely submerging the HLT to MT Heat Exchanger Coil is necessary to provide proper heat transfer to, and temperature control of, the liquid MT contents in subsequent steps.

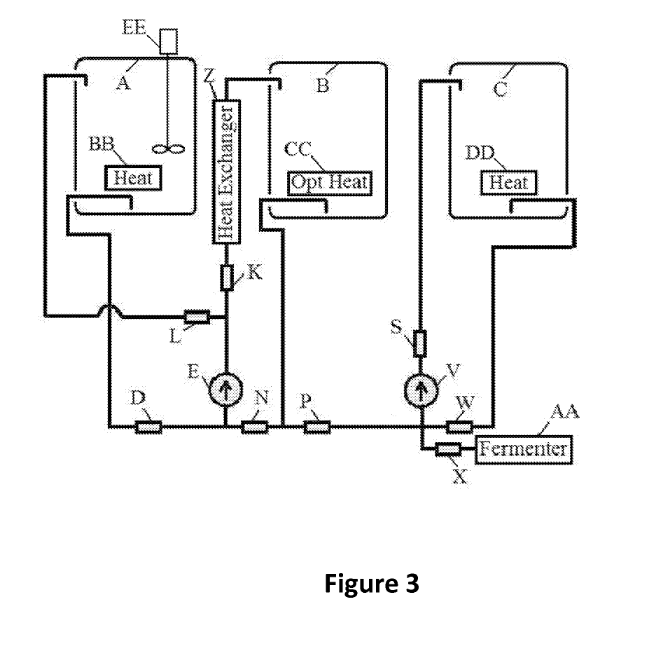

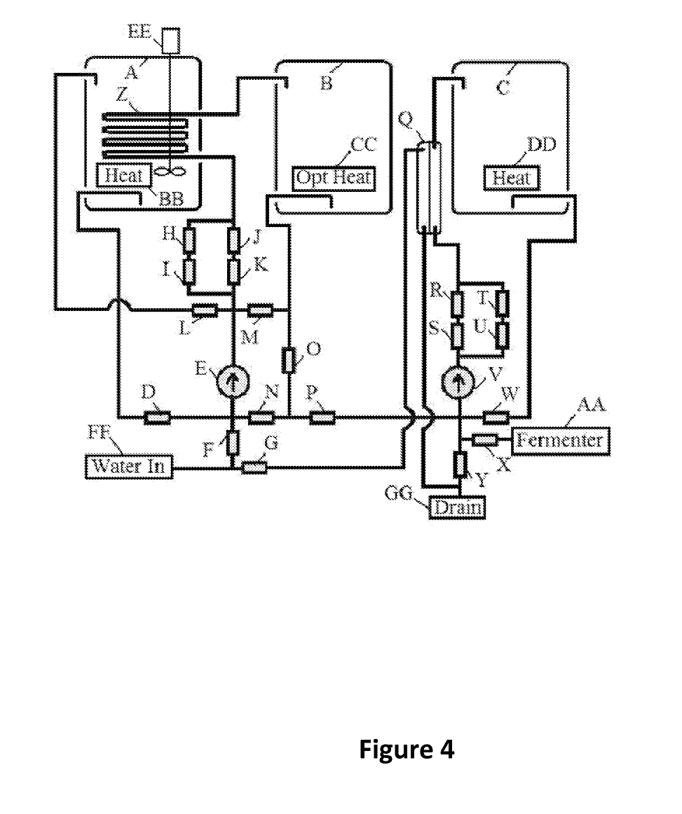

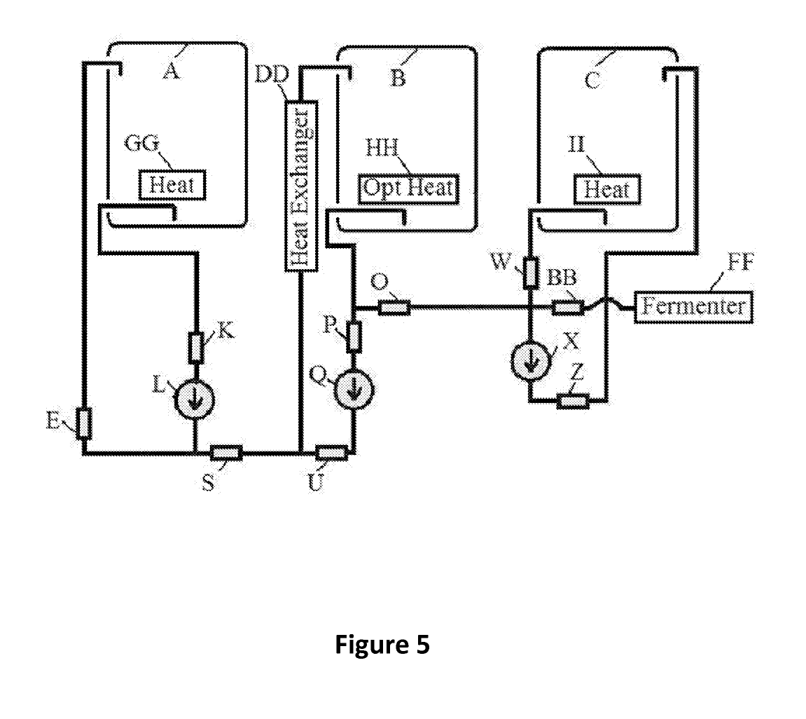

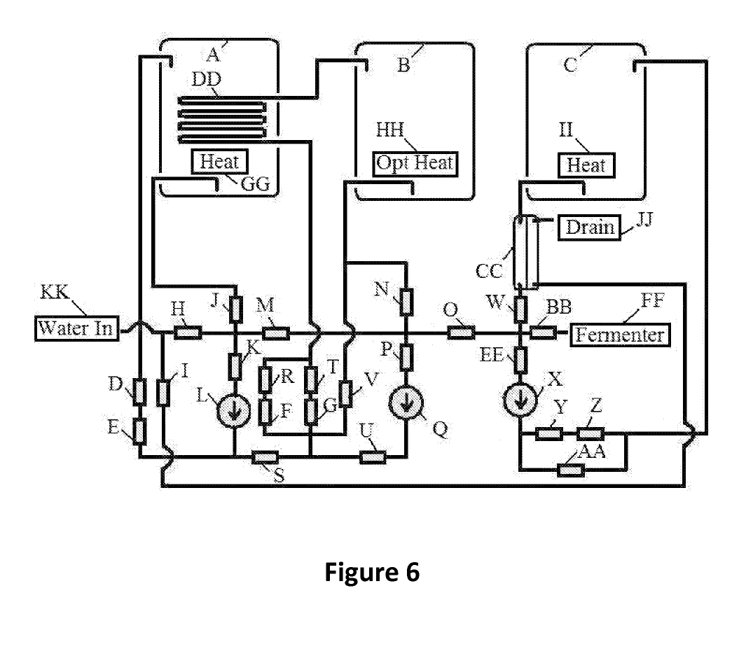

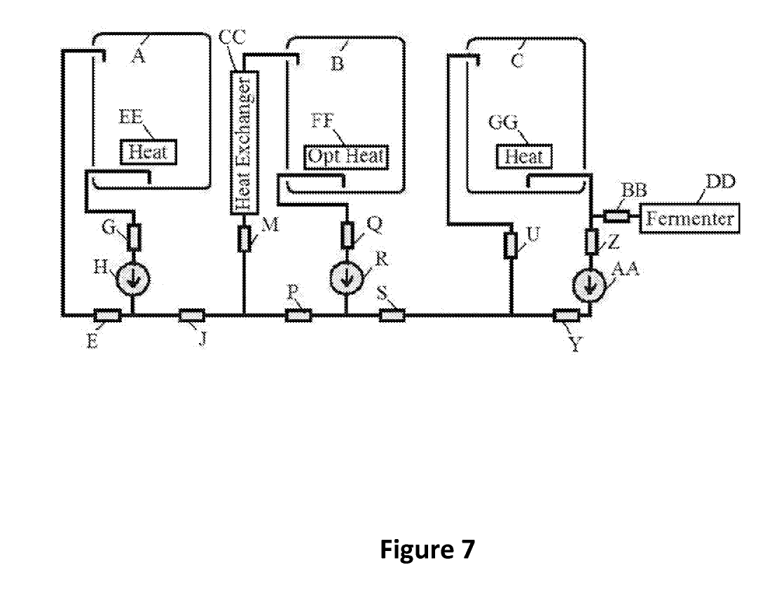

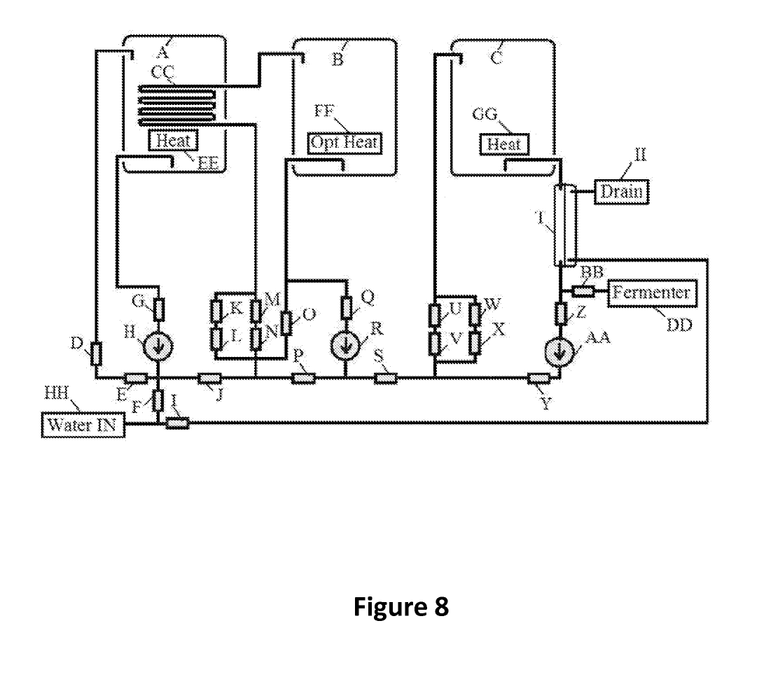

In an exemplary embodiment, this HLT to MT Heat Exchanger Coil is component AA in FIG. 2, component Z in FIG. 4, component DD in FIG. 6, and component CC in FIG. 8. Also, depending on the heat exchanger type selected, this HLT to MT Heat Exchanger coil as described above may be component AA in FIG. 1, component Z in FIG. 3, component DD in FIG. 5, and component CC in FIG. 7. Exemplary brewing system embodiments in FIGS. 6 and 8 allow for the optional use of the Boil Kettle (BK) to contain and heat the strike water. It should be noted that in these exemplary embodiments, if the BK is used to contain and heat the strike water for the grains, the HLT is still filled with enough water to submerge the HLT to MT Heat Exchanger coil (component DD in FIG. 6, and component CC in FIG. 8), and to provide sparge water to rinse the grains during the sparge. Typically, smaller size batches of beers of average alcoholic strength may be made using the HLT as the only vessel that provides the strike water, the water to submerge the HLT to MT Heat Exchanger Coil, and the sparge water. However, if the user decides to brew a batch of beer in a very large volume or with high alcohol content, the HLT may not have sufficient capacity to provide the increased amount of strike water needed while still ensuring the coil is submerged and that there is sufficient sparge water. Accordingly, using the BK as the source of sparge water leads to less wait time for these larger volume or more alcoholic batches.

Step 1 in FIG. 1 Exemplary Brewing System:

In this exemplary embodiment, filling the HLT with cold water for use as strike water is manually performed.

Step 1 in FIG. 2 Exemplary Brewing System:

In this exemplary embodiment, bottom filling the HLT with cold water for use as strike water is accomplished by opening valve 1 (valve D) and allowing the pressurized water from the Water In Connection (FF) to fill the HLT (A) from the bottom HLT outlet. The Bottom Fill method in this exemplary system allows for the water to flow more quickly (i.e., the flow of water is not restricted) compared to the Top Fill option of the FIG. 2 exemplary brewing system directly below which entails the water flowing through the HLT Water-In Flow Rate Restrictor (component T in FIG. 2). In an exemplary embodiment, top filling the HLT with cold water for use as strike water is accomplished by opening valve 2 (valve E), allowing cold pressurized water to flow from the Water In Connection (FF) through the opened valve 2 (E) and also through the HLT Water In Flow Restrictor (T) to the top of the HLT (A) through the HLT inlet. Accordingly, top filling the HLT allows the user to adjust the rate at which the water flows into the HLT. If the water is flowing too quickly when the Bottom Fill option is used, the user can Top Fill the HLT and can then adjust the flow rate of the water coming into the HLT with the HLT Water-In Flow Rate Restrictor (component T in FIG. 2).

Step 1 in FIG. 3 Exemplary Brewing System:

In this exemplary embodiment, filling the HLT with cold water for use as strike water is manually performed.

Step 1 in FIG. 4 Exemplary Brewing System:

In this exemplary embodiment, bottom filling the HLT with cold water for use as strike water is accomplished by opening valve 2 (F) and valve 1 (D), allowing the pressurized water from the Water In connection (FF) to fill the HLT (A) from the bottom HLT outlet. There is no pump required in this step, as the water source is already pressurized just like the water flowing to a sink. In an exemplary embodiment, top filling the HLT with cold water for use as strike water is accomplished by opening valve 2 (F), allowing water to flow through pump 1 (E) even though pump 1 (E) is off, opening valve 6 (L), and allowing the water to flow to the top of the HLT (A) through the HLT inlet. In one or more exemplary embodiments, the Top Fill method requires water flow through the pump without the pump being on (some pumps do not allow water to flow through them if they are not on).

Step 1 in FIG. 5 Exemplary Brewing System:

In this exemplary embodiment, filling the HLT with cold water for use as strike water is manually accomplished.

Step 1 in FIG. 6 Exemplary Brewing System:

In this exemplary embodiment, bottom filling the HLT with cold water for use as strike water is accomplished by opening valve 3 (H) and valve 5 (J), and allowing the pressurized cold water to flow from the Pressurized Water Source (KK) to bottom fill the HLT (A) through the bottom HLT outlet. In an exemplary embodiment, top filling the HLT with cold water for use as strike water is accomplished by opening valve 3 (H), valve 6 (K), allowing water to flow through pump 1 (L) even though pump 1 (L) is off, opening valve 1 (E), allowing water to flow through the HLT Recirculation Flow Rate Restrictor (D) to the top of the HLT (A) through the HLT inlet. In an exemplary embodiment, the Top Fill method requires water to flow through the pump without the pump being on (some pumps do not allow water to flow through them if they are not on.) In another exemplary embodiment, pump 1 (L) may be turned on if the pump does not allow water to flow through it when the pump is off. In an exemplary embodiment, filling the BK with cold water for use as strike water is accomplished by opening valve 3 (H), opening valve 7 (M), opening valve 9 (O), opening valve 18 (EE), allowing water to flow through pump 3 (X) and through valve 16 (AA) to the top of the BK (C) through the top BK inlet. It should be noted that since the HLT needs to be filled with enough water to submerge the coil and to provide sparge water, Step 1 in the exemplary embodiment of FIG. 6 for either top filling or bottom filling the HLT with cold water also needs to be performed when the BK is used as the strike water source.

Step 1 in FIG. 7 Exemplary Brewing System:

In this exemplary embodiment, filling the HLT with cold water for use as strike water is manually performed.

Step 1 in FIG. 8 Exemplary Brewing System:

In this embodiment, filling the HLT with cold water for use as strike water is accomplished by opening valve 3 (F), opening valve 2 (E), and allowing water to flow through the HLT Flow Rate Restrictor (D) before flowing into the top HLT (A) through the HLT inlet. In an exemplary embodiment, if the flow rate of the water into the HLT is too fast or slow, the rate can be adjusted by the HLT Flow Rate Restrictor (D). In an exemplary embodiment, filling the BK with cold water for use as strike water is accomplished by opening valve 3 (F), opening valve 6 (J), opening valve 10 (P), opening valve 12 (S), allowing water to flow through the BK Recirculation Flow Rate Restrictor (V), opening valve 13 (U), and allowing the water to flow into the BK (C) through the top BK inlet. It should be noted that since the HLT needs to be filled with enough water to submerge the coil and to provide sparge water, Step 1 in exemplary embodiment of FIG. 8 for filling the HLT with cold water also needs to be performed when the BK is used as the strike water source.

Step 2: Heat Strike Water to Desired Temperature:

In an exemplary embodiment, if the HLT is used as the source of strike water, the HLT is heated using the HLT Direct Heat Source. In one exemplary embodiment, the direct heat source is an electric heating element located inside the HLT. The electric heating element converts electrical energy into heat, which is then transferred to the surrounding water that covers the heating elements inside the HLT, MT, or BK. The strike water temperature is higher than the first mash temperature such that upon manual addition of the room temperature grains to the MT, the temperature of the grist (water and grains) inside the MT equilibrates to the first mash step temperature. Since the HLT is at a higher temperature than the first mash step temperature, cold water is then added to the HLT to decrease its temperature to the first mash step temperature before the MT contents are pumped through the HLT to BK Heat Exchanger Coil. In an exemplary embodiment, this HLT to MT Heat Exchanger Coil is component AA in FIG. 2, component Z in FIG. 4, component DD in FIG. 6, and component CC in FIG. 8. Also, depending on the heat exchanger type selected, in another exemplary embodiment, this HLT to MT Heat Exchanger coil as described above may be component AA in FIG. 1, component Z in FIG. 3, component DD in FIG. 5, and component CC in FIG. 7.

In an exemplary embodiment, if the BK is used as the source of the strike water, both the HLT (source of the water to submerge the heat exchanger coil and of the sparge water) and the BK (source of the strike water) are heated with their respective heating elements located inside the HLT and Boil Kettle, respectively. It should be noted that the HLT and BK contain water at different target temperatures since the HLT is heated to the first mash rest temperature, whereas the BK is heated to the higher temperature strike water. Since the water in the HLT or Boil Kettle is stagnant, greater uniformity of heating of the water and better temperature control are both achieved by recirculating the contents of the HLT and/or BK during heating.

Step 2 in FIG. 1 Exemplary Brewing System:

In this exemplary embodiment, heating the strike water in the HLT is accomplished by turning on the HLT Direct Heat Source located inside the HLT (component CC). In an exemplary embodiment, recirculating the contents of the HLT is accomplished by allowing the water to exit the HLT outlet, opening valve 3 (F), turning on pump 1 (Y), opening valve 5 (H) and allowing the water to return to the HLT (A) through the HLT inlet.

Step 2 in FIG. 2 Exemplary Brewing System:

In this exemplary embodiment, heating the strike water in the HLT is accomplished by turning on the HLT Direct Heat Source located inside the HLT (component CC). In an exemplary embodiment, recirculating the contents of the HLT is accomplished by allowing the water to exit the HLT outlet, opening valve 3 (F), turning on pump 1 (Y), opening valve 5 (H) and allowing the water to return to the HLT (A) through the HLT inlet.

Step 2 in FIG. 3 Exemplary Brewing System:

In this exemplary embodiment, heating the strike water in the HLT is accomplished by turning on the HLT Direct Heat Source located inside the HLT (component BB). In an exemplary embodiment, recirculating the contents of the HLT is accomplished by allowing the water to exit the HLT outlet, opening valve 1 (D), turning on pump 1 (E), opening valve 6 (L) and allowing the water to return to the HLT (A) through the HLT inlet.

Step 2 in FIG. 4 Exemplary Brewing System:

In this exemplary embodiment, heating the strike water in the HLT is accomplished by turning on the HLT Direct Heat Source located inside the HLT (component BB). In an exemplary embodiment, recirculating the contents of the HLT is accomplished by allowing the water to exit the HLT outlet, opening valve 1 (D), turning on pump 1 (E), opening valve 6 (L) and allowing the water to return to the HLT (A) through the HLT inlet.

Step 2 in FIG. 5 Exemplary Brewing System:

In this exemplary embodiment, heating the strike water in the HLT is accomplished by turning on the HLT Direct Heat Source located inside the HLT (component GG). In an exemplary embodiment, recirculating the contents of the HLT is accomplished by allowing the water to exit the HLT outlet, opening valve 6 (K), turning on pump 1 (L), opening valve 1 (E) and allowing the water to return to the HLT (A) through the HLT inlet.

Step 2 in FIG. 6 Exemplary Brewing System:

In this exemplary embodiment, heating the strike water in the HLT is accomplished by turning on the HLT Direct Heat Source located inside the HLT (component GG). In an exemplary embodiment, heating the strike water in the BK is accomplished by turning on the BK Direct Heat Source located inside the BK (component II). In an exemplary embodiment, recirculating the contents of the HLT is accomplished by allowing the water to exit the HLT outlet, opening valve 5 (J), opening valve 6 (K), turning on pump 1 (L), opening valve 1 (E), allowing water to flow through the HLT Recirculation Flow Rate Restrictor (D), and allowing the water to return to the HLT (A) through the HLT inlet. In an exemplary embodiment, recirculating the contents of the BK is accomplished by allowing the water to exit the BK outlet, allowing the water to flow through the Chiller (CC) without the chiller actively chilling, opening valve 14 (W), opening valve 18 (EE), turning on pump 3 (X), allowing the water to flow through the BK Recirculation Flow Rate Restrictor (Y), opening valve 15 (Z), and allowing the water to return to the BK (C) through the BK inlet. In an exemplary embodiment, where BK is used for the strike water, the steps above (i.e., Step 2 in FIG. 6) for heating the strike water in the HLT and for recirculating the contents of the HLT are also performed simultaneously to provide water to submerge the HLT to MT Heat Exchanger Coil and to provide sparge water.

Step 2 in FIG. 7 Exemplary Brewing System:

In this exemplary embodiment, heating the strike water in the HLT is accomplished by turning on the HLT Direct Heat Source located inside the HLT (component EE). In an exemplary embodiment, recirculating the contents of the HLT is accomplished by allowing the water to exit the HLT outlet, opening valve 4 (G), turning on pump 1 (H), opening valve 2 (E), and allowing the water to return to the HLT (A) through the HLT inlet.

Step 2 in FIG. 8 Exemplary Brewing System:

In this exemplary embodiment, heating the strike water in the HLT is accomplished by turning on the HLT Direct Heat Source located inside the HLT (component EE). In an exemplary embodiment, heating the strike water in the BK is accomplished by turning on the BK Direct Heat Source found inside the BK (component GG).

In an exemplary embodiment, recirculating the contents of the HLT is accomplished by opening valve 4 (G), turning on pump 1 (H), opening valve 2 (E), allowing the water to flow through the HLT Recirculation Flow Rate Restrictor (D), and allowing the water to return to the HLT (A) through the HLT inlet. In an exemplary embodiment, recirculating the contents of the BK (C) is accomplished by allowing water to exit the BK outlet, allowing the water to flow through the chiller (T) without the chiller actively chilling, opening valve 16 (Z), turning on pump 3 (AA), opening valve 15 (Y), allowing fluid to flow through the BK Recirculation Flow Rate Restrictor (V), opening valve 13 (U), and allowing the water to flow into the BK (C) through the BK inlet. In an exemplary embodiment, where BK is used for the strike water, the steps above (i.e., Step 2 in FIG. 8) for heating the strike water in the HLT and for recirculating the contents of the HLT are also performed simultaneously to provide water to submerge the HLT to MT Heat Exchanger Coil (CC) and to provide sparge water.

Step 3: Transfer Strike Water to Fill the Mash Tun:

In one or more exemplary embodiments, strike water can be sourced either from the HLT (in all 8 exemplary brewing systems) or from the BK (as illustrated above in Step 2 in FIGS. 6 and 8). In an exemplary embodiment, this strike water is added to the crushed grains that are located in the MT. Since the crushed grains can be loaded in the MT by the user before the brewing cycle is started, adding water from the bottom up allows the grains to be suspended in the water as the grain particles become wet. This leads to a decreased occurrence of “dough balls”. Dough balls are a ball of grain stuck together that prevents the enzymatic conversion of the grain starches to sugars. This enzymatic conversion is prevented since the interior of the dough ball is not exposed to the fluid portion of the mash which contains the mash enzymes responsible for the starch to sugar conversion. Best mash conditions occur when there are no clumps of grain and where all the grain particles are maximally exposed to the fluid portion of the mash. In one or more exemplary embodiments, bottom filling the MT is a method used as illustrated in FIGS. 2, 4, 6, and 8 exemplary brewing systems. In one or more exemplary embodiments, where bottom filling the MT is not employed (as illustrated in FIGS. 1, 3, 5, and 7 exemplary brewing systems), the user has to manually stir the water and grain mixture (grist) to ensure no dough balls form before continuing the brewing cycle. For exemplary brewing systems of FIGS. 6 and 8, the strike water may be sourced from either the HLT or from the BK, depending on the strike water source the user has selected.

Step 3 in FIG. 1 Exemplary Brewing System:

In this exemplary embodiment, top filling of the MT with strike water from the HLT is accomplished by opening valve 3 (F), turning on pump 1 (Y), opening valve 6 (I), opening valve 7 (J), allowing the water to flow through the Heat Exchanger (AA), and allowing the water to enter the MT (B) through the MT inlet.

Step 3 in FIG. 2 Exemplary Brewing System:

In this exemplary embodiment, bottom filling of the MT with strike water from the HLT is accomplished by opening valve 3 (F), turning on pump 1 (Y), opening valve 6 (I), opening valve 9 (L), opening valve 11 (N), and allowing the water to enter the MT (B) from the bottom MT outlet. In an exemplary embodiment, the flow restrictors, and the HLT coil are bypassed, and the MT is quickly filled with strike water using the bottom fill method.

In an exemplary embodiment, top filling of the MT with strike water from the HLT is accomplished by opening valve 3 (F), turning on pump 1 (Y), opening valve 6 (I), opening valve 8 (K), adjusting the flow rate by opening or closing the MT Recirculation Flow Rate Restrictor (V), allowing the water to travel through the HLT to MT Heat Exchanger Coil (AA), and allowing the water to enter the MT (B) from the MT inlet. In an exemplary embodiment, by selecting the flow to follow the path that includes MT Recirculation Flow Rate Restrictor (V) and valve 8 (K) instead of going through Valve 7 (J) and the HLT to MT Flow Rate Restrictor (U), allows the MT to be filled with strike water faster since the MT Recirculation Rate Restrictor (V) has a faster flow rate. Although, the flow rate for top filling the MT is controlled, whereas the flow rate for bottom filling this system (i.e., FIG. 2 exemplary brewing system) is not rate controlled, dough balls may be generated since the water is added from the top of the grains rather than suspending the grains from the bottom.

Step 3 in FIG. 3 Exemplary Brewing System:

In this exemplary embodiment, top filling the MT with strike water from the HLT is accomplished by opening valve 1 (D), turning on pump 1 (E), opening valve 5 (K) and allowing the water to travel through the Heat Exchanger (Z) and into the MT (B) by the top MT inlet.

Step 3 in FIG. 4 Exemplary Brewing System:

In this exemplary embodiment, bottom filling of the MT with strike water from the HLT is accomplished by opening valve 1 (D), turning on pump 1 (E), opening valve 7 (M) and allowing the water to enter the MT (B) from the bottom MT outlet. In an exemplary embodiment, the flow restrictors and the HLT to MT Heat Exchanger Coil are bypassed, and the MT is quickly filled with strike water. In an exemplary embodiment, top filling the MT with strike water from the HLT is accomplished by opening valve 1 (D), turning on pump 1 (E), opening valve 5 (K), adjusting the flow rate by opening or closing the MT Recirculation Flow Rate Restrictor (J), and allowing the water to travel through the HLT to MT Heat Exchanger Coil (Z) and into the MT (B) by the top MT inlet. In an exemplary embodiment, selecting the flow to follow the path that includes the MT Recirculation Flow Rate Restrictor (J) and valve 5 (K) instead of going through the HLT to MT Sparge Flow Rate Restrictor (I) and valve 4 (H) provides faster filling of the MT with strike water since the MT Recirculation Flow Rate Restrictor flows at a faster flow rate than the MT to BK Sparge Flow Rate Restrictor.

Step 3 in FIG. 5 Exemplary Brewing System:

In this exemplary embodiment, top Filling the MT with strike water from the HLT is accomplished by opening valve 6 (K), turning on pump 1 (L), opening valve 11 (S), allowing the water to flow through the Heat Exchanger (DD) and into the top of the MT (B) through the MT inlet.

Step 3 in FIG. 6 Exemplary Brewing System:

In this exemplary embodiment, bottom filling of the MT with strike water from the HLT is accomplished by opening valve 5 (J), opening valve 6 (K), turning on pump 1 (L), opening valve 11 (S), opening valve 13 (V), and allowing the water to enter the MT (B) from the bottom MT outlet. In an exemplary embodiment, all of the flow restrictors and the HLT coil are bypassed, thus allowing for the fastest filling of the MT with strike water while also reducing the likelihood of dough ball formation.

In an exemplary embodiment, top filling the MT with strike water from the HLT is accomplished by opening valve 5 (J), opening valve 6 (K), turning on pump 1 (L), opening valve 11 (S), opening valve 2 (G), allowing the water to flow through the MT Recirculation Flow Rate Restrictor (T), allowing the water to flow through the HLT to MT Heat Exchanger Coil (DD), and allowing the water to enter the MT (B) from the top MT inlet. In an exemplary embodiment, by selecting the flow path that includes valve 2 (G) and the MT Recirculation Flow Rate Restrictor (T) instead of going through valve 19 (F) and the HLT to MT Sparge Flow Rate Restrictor (R) allows for faster filling of the MT with strike water since the MT Recirculation Flow Rate Restrictor (T) has a faster flow rate than the HLT to MT Sparge Flow Rate Restrictor (R).

In an exemplary embodiment, bottom filling of the MT with strike water from the Boil Kettle is accomplished by allowing the water to flow through the chiller (CC) without active chilling, opening valve 14 (W), opening valve 9 (O), opening valve 10 (P), turning on pump 2 (Q), opening valves 12 (U) and 13 (V), and allowing the water to enter the MT (B) from the bottom MT outlet. In an exemplary embodiment, the flow restrictors and the HLT coil are bypassed, allowing the fastest filling of the MT with strike water and reducing dough ball formation. In an exemplary embodiment, top filling the MT with strike water from the Boil Kettle is accomplished by allowing the water to flow through the chiller (CC) without active chilling, opening valve 14 (W), opening valve 9 (O), opening valve 10 (P), turning on pump 2 (Q), opening valve 12 (U), opening valve 2 (G), allowing water to flow through the MT Recirculation Flow Rate Restrictor (T), allowing the water to travel through the HLT to MT Heat Exchanger Coil (DD) and into the MT (B) by the top MT inlet. In an exemplary embodiment, by selecting the flow path that includes valve 2 (G) and the MT Recirculation Flow Rate Restrictor (T) instead of going through valve 19 (F) and the HLT to MT Flow Rate Restrictor (R) allows for faster filling of the MT with strike water since the MT Recirculation Flow Rate Restrictor (T) has a faster flow rate than the HLT to MT Sparge Flow Rate Restrictor (R).

Step 3 in FIG. 7 Exemplary Brewing System:

In this exemplary embodiment, top filling the MT with strike water from the HLT is accomplished by opening valve 4 (G), turning on pump 1 (H), opening valve 6 (J), opening valve 8 (M), allowing the water to flow through the Heat Exchanger (CC) and into the MT (B) from the top MT inlet.

Step 3 in FIG. 8 Exemplary Brewing System:

In this exemplary embodiment, bottom filling of the MT with strike water from the HLT is accomplished by opening valve 4 (G), turning on pump 1 (H), opening valve 6 (J), opening valve 9 (O), and allowing the strike water to enter the MT (B) from the bottom MT outlet. In an exemplary embodiment, top filling the MT with strike water from the HLT is accomplished by opening valve 4 (G), turning on pump 1 (H), opening valve 6 (J), allowing the water to flow through the MT Recirculation Flow Rate Restrictor (N), opening valve 8 (M), allowing the water to flow through the HLT to MT Heat Exchanger Coil (CC), and into the MT (B) from the top MT inlet. In an exemplary embodiment, selecting the flow to follow the path that includes the MT Recirculation Flow Rate Restrictor (N) and valve 8 (M) instead of going through the HLT to MT Sparge Flow Rate Restrictor (L) and valve 7 (K), allows for faster filling of the MT with strike water since the MT Recirculation Flow Rate Restrictor (N) has a faster flow rate than the HLT to MT Sparge Flow Rate Restrictor (L).

In an exemplary embodiment, bottom filling of the MT with strike water from the Boil Kettle is accomplished by allowing water to flow through the chiller (T) while chiller is not actively chilling, opening valve 16 (Z), turning on pump 3 (AA), opening valve 15 (Y), opening valve 12 (S), opening valve 10 (P), opening valve 9 (O), and allowing the strike water to enter the MT (B) from the bottom MT outlet. In an exemplary embodiment, top filling the MT with strike water from the Boil Kettle is accomplished by allowing the water to flow through the Chiller (T) without active chilling, opening valve 16 (Z), turning on pump 3 (AA), opening valve 15 (Y), opening valve 12 (S), opening valve 10 (P), allowing the water to flow through the MT Recirculation Flow Rate Restrictor (N), opening valve 8 (M), allowing the water to flow through the HLT to MT Heat Exchanger Coil (CC), and into the MT (B) from the top MT inlet. In an exemplary embodiment, selecting the flow to follow the path that the MT Recirculation Flow Rate Restrictor (N) and valve 8 (M) instead of going through the HLT to MT Sparge Flow Rate Restrictor (L) and valve 7 (K), allows for faster filling of the MT with strike water since the MT Recirculation Flow Rate Restrictor (N) has a faster flow rate than the HLT to MT Sparge Flow Rate Restrictor (L)

Step 4: Cool HLT Water to First Mash Step Temperature:

In one or more exemplary embodiments, this step is only used if the HLT is selected as the source for strike water. In one or more exemplary embodiments, Step 4 is either performed manually or is performed automatically using the automation controller. In an exemplary embodiment, if this step is performed automatically, cooling of HLT water may need to be alternated with HLT recirculation if performing them simultaneously damages a pump. Pump damage may occur if the cold water is added to the brewing system against the pump's working direction.

Step 4 in FIG. 1 Exemplary Brewing System:

In an exemplary embodiment, this step is accomplished by manually adding cold water to the HLT.

Step 4 in FIG. 2 Exemplary Brewing System:

In an exemplary embodiment, this step is accomplished by opening valve 3 (F), turning on pump 1 (Y), opening valve 5 (H) and allowing the water to travel back up to the top of the HLT. In an exemplary embodiment, while the HLT water is being re-circulated, valve 2 (E) is opened and the flow rate of the cold water is adjusted by the HLT Water-In Flow Rate Restrictor (T) while the temp of the HLT is being read. In an exemplary embodiment, if the water in the HLT is decreased too much, the HLT Direct Heat Source (CC) is used to increase the temperature to the first mash rest temp. Valve 2 (E) remains open if the temperature of the HLT is too high or if the level of the water in the HLT is too low to properly submerge the coil (AA). Valve 2 (E) is closed once the temperature is sufficiently cool and the level is sufficiently high to properly submerge the coil (AA). In an exemplary embodiment, volume measurements and temperature control are controlled by the automation controller. In an exemplary embodiment, the HLT Water-In Flow Rate Restrictor (T) is used to slow the addition of the cold water such that pump 1 (Y) is not damaged by the addition of the highly pressurized cold water. In an exemplary embodiment, volume measurements and temperature are controlled by the automation controller.

Step 4 in FIG. 3 Exemplary Brewing System:

In an exemplary embodiment, this step is accomplished by manually adding cold water to the HLT.

Step 4 in FIG. 4 Exemplary Brewing System:

In an exemplary embodiment, this step is accomplished by opening valve 1 (D), turning on pump 1 (E), opening valve 6 (L) and allowing the water to travel back up to the top of the HLT. In an exemplary embodiment, while the HLT water is being re-circulated, valve 2 (F) is then opened while the temp of the HLT is read. In an exemplary embodiment, if the water in the HLT is decreased too much, the HLT Direct Heat Source (BB) is then used to increase the temperature to the first mash rest temperature. Valve 2 (F) remains open if the temperature of the HLT is too high or if the level of the water in the HLT is too low to properly submerge the coil (Z). Valve 2 (F) is closed once the temperature is sufficiently cool and the level is sufficiently high to properly submerge the coil (Z). In an exemplary embodiment, volume measurements and temperature control are controlled by the automation controller.

Step 4 in FIG. 5 Exemplary Brewing System:

In an exemplary embodiment, this step is accomplished by manually adding cold water to the HLT.

Step 4 in FIG. 6 Exemplary Brewing System:

In an exemplary embodiment, cooling HLT water to first mash step temperature is accomplished by recirculating the HLT contents while adding cold water to the HLT and reading the temperature. In an exemplary embodiment, recirculating the HLT is accomplished by opening valve 5 (J), opening valve 6 (K), turning on pump 1 (L), opening valve 1 (E), allowing water to flow through the HLT Recirculation Flow Rate Restrictor (D) and into the top of the HLT through the HLT inlet. In an exemplary embodiment, adding cold water to the recirculating HLT contents is accomplished by opening valve 3 (H) and allowing the pressurized cold water to enter. Valve 3 (H) remains open if the temperature of the HLT is too high or if the level of the water in the HLT is too low to properly submerge the coil (DD). Valve 3 (H) is closed once the temperature is sufficiently cool and the level is sufficiently high to properly submerge the coil (DD). In an exemplary embodiment, volume measurements and temperature control are controlled by the automation controller.

Step 4 in FIG. 7 Exemplary Brewing System:

In an exemplary embodiment, this step is accomplished by manually adding cold water to the HLT.

Step 4 in FIG. 8 Exemplary Brewing System:

In an exemplary embodiment, HLT recirculation is accomplished by opening valve 4 (G), turning on pump 1 (H), opening valve 2 (E), and allowing fluid to flow through the HLT Recirculation Flow Rate Restrictor (D) before flowing into the top HLT inlet. In an exemplary embodiment, cold water introduction into the HLT is accomplished by opening valve 3 (F), opening valve 2 (E), and allowing water to flow through the HLT Recirculation Flow Rate Restrictor (D) before flowing into the top HLT inlet. Valve 3 (F) remains open if the temperature of the HLT is too high or if the level of the water in the HLT is too low to properly submerge the coil (CC). Valve 3 (F) is closed once the temperature is sufficiently cool and the level is sufficiently high to properly submerge the coil (CC). In an exemplary embodiment, since cold water flows in the opposite direction of the pump, HLT recirculation and cold water introduction may need to be alternated to prevent pump damage. In an exemplary embodiment, volume measurements and temperature control are controlled by the automation controller.

Step 5: Dual Recirculation During the Mash to Maintain Desired Temperature:

In one or more exemplary embodiments, the contents of the MT are held at the desired mash step temperature by pumping the liquid MT contents through the coil in the HLT. In an exemplary embodiment, only the fluid portion of the mash, not the grains, are re-circulated. Grains are filtered out by a screen (i.e., a false bottom) on the bottom of the MT pot such that only the liquid portion reaches the MT outlet and is re-circulated. The water in the HLT is temperature controlled by heating with the electric heating elements in the HLT to maintain the proper mash temperature. In an exemplary embodiment, if the mash temperature needs to be increased, the HLT heating element is used to increase the temperature of the HLT water and consequently the temperature of the mash since it is cycled through the heat exchanger submerged in HLT water. Accordingly, there is no chance of caramelizing, darkening, or burning the contents of the MT as those contents never come into contact with a direct heating source. The HLT to MT Heat Exchanger Coil contains the recirculating fluid portion of the mash inside the coil and is surrounded by the heated HLT water on the outside of the coil. In an exemplary embodiment, this HLT to MT Heat Exchanger Coil is component AA in FIG. 2, component Z in FIG. 4, component DD in FIG. 6, and component CC in FIG. 8. Also, in one or more exemplary embodiments, depending on the heat exchanger type selected, this HLT to MT Heat Exchanger coil as described above can be component AA in FIG. 1, component Z in FIG. 3, component DD in FIG. 5, and component CC in FIG. 7. In an exemplary embodiment, simultaneous recirculation of HLT water and MT contents is preformed such that the temperature in each vessel is more consistent (i.e., less temperature fluctuation and decreased chances of developing hot spots in the mash). HLT recirculation also affords more efficient heat transfer from the HLT water through the coil wall to the MT contents inside the coil since it eliminates any potential for temperature gradients surrounding the exterior of the coil. In an exemplary embodiment, recirculation rate of the HLT and MT can be controlled by the MT Recirculation Flow Rate Restrictor (component U in FIG. 2, component J in FIG. 4, component T in FIG. 6, and component N in FIG. 8) and the HLT Recirculation Flow Rate Restrictor (component D in FIG. 6, and component D in FIG. 8), respectively.

Step 5 in FIG. 1 Exemplary Brewing System:

In this exemplary embodiment, HLT recirculation is accomplished by opening valve 3 (F), turning on pump 1 (Y), opening valve 5 (H), and allowing fluid to flow into the top HLT inlet. Heat is applied as needed by computer control to the HLT by the HLT Direct Heat Source (CC). In an exemplary embodiment, MT recirculation is accomplished by opening valve 11 (N), turning on pump 2 (Z), opening valve 10 (M), opening valve 7 (J), allowing fluid to flow through the Heat Exchanger (AA), and allowing fluid to flow into the MT inlet at the top of the MT (B). In an exemplary embodiment, heat is applied to the MT by either the optional MT Direct Heat Source (DD) or by the Heat Exchanger (AA). In an exemplary embodiment, heat can be applied by the HLT Direct Heat Source (CC) to heat the HLT contents.

Step 5 in FIG. 2 Exemplary Brewing System:

In this exemplary embodiment, HLT recirculation is accomplished by opening valve 3 (F), turning on pump 1 (Y), opening valve 5 (H), and allowing fluid to flow into the top HLT inlet. In an exemplary embodiment, heat is applied as needed by computer control to the HLT by the HLT Direct Heat Source (CC). MT recirculation is accomplished by opening valve 11 (N), opening valve 12 (O), turning on pump 2 (Z), opening valve 10 (M), opening valve 8 (K), allowing fluid to flow through the MT Recirculation Flow Rate Restrictor (V), allowing fluid to flow through the HLT to MT Heat Exchanger Coil (AA), and allowing fluid to flow into the MT inlet at the top of the MT (B). In an exemplary embodiment, heat can be applied to the MT by the optional MT Direct Heat Source (DD). In an exemplary embodiment, heat can be applied by the HLT Direct Heat Source (CC) to heat the HLT contents. In another exemplary embodiment, the heated HLT contents can also be used as a heat source for the MT contents via the HLT to MT Heat Exchanger Coil (AA).

Step 5 in FIG. 3 Exemplary Brewing System:

In this exemplary embodiment, HLT recirculation is accomplished by turning on the HLT Agitator (EE). In an exemplary embodiment, MT recirculation is accomplished by opening valve 8 (N), turning on pump 1 (E), opening valve 5 (K), allowing the fluid to flow through the Heat Exchanger (Z) before returning to the MT (B) through the MT inlet. In an exemplary embodiment, heat can be applied to the MT contents by the optional MT Direct Heat Source (CC) or by the Heat Exchanger (Z). In an exemplary embodiment, heat can be applied by the HLT Direct Heat Source (BB) to heat the HLT contents.

Step 5 in FIG. 4 Exemplary Brewing System:

In this exemplary embodiment, HLT recirculation is accomplished by turning on the HLT Agitator (EE). In an exemplary embodiment, MT recirculation is accomplished by opening valve 9 (O), opening valve 8 (N), turning on pump 1 (E), opening valve 5 (K), allowing the fluid to flow through the MT Recirculation Flow Rate Restrictor (J) and then the HLT to MT Heat Exchanger Coil (Z) before returning to the MT (B) through the MT inlet. In an exemplary embodiment, heat can be applied to the MT by the MT Optional Direct Heat Source (CC). In an exemplary embodiment, heat may be applied by the HLT Direct Heat Source (BB) to heat the HLT contents. In another exemplary embodiment, the heated HLT contents may also be used as a heat source for the MT contents via the HLT to MT Heat Exchanger Coil (Z).

Step 5 in FIG. 5 Exemplary Brewing System:

In an exemplary embodiment, HLT recirculation is accomplished by opening valve 6 (K), turning on pump 1 (L), opening valve 1 (E), and allowing the water to flow into the HLT through the top HLT inlet. In an exemplary embodiment, MT recirculation is accomplished by opening valve 10 (P), turning on pump 2 (Q), opening valve 12 (U), allowing the water to flow through the Heat Exchanger (DD), and allowing the water to flow into the MT through the top MT inlet. In an exemplary embodiment, heat can be applied to the MT contents by the MT Optional Direct Heat Source (HH) or by the Heat Exchanger (DD). In another exemplary embodiment, heat can be applied by the HLT Direct Heat Source (GG) to heat the HLT contents.

Step 5 in FIG. 6 Exemplary Brewing System:

In this exemplary embodiment, HLT recirculation is accomplished by opening valve 5 (J), opening valve 6 (K), turning on pump 1 (L), opening valve 1 (E), allowing the water to flow through the HLT Recirculation Flow Rate Restrictor (D), and allowing the water to flow into the HLT through the top HLT inlet. In an exemplary embodiment, MT recirculation is accomplished by opening valve 8 (N), opening valve 10 (P), turning on pump 2 (Q), opening valve 12 (U), opening valve 2 (G), allowing the water to flow through the MT Recirculation Flow Rate Restrictor (T), allowing the water to flow through the HLT to MT Heat Exchanger Coil (DD), and allowing the water to flow into the MT (B) through the top MT inlet. In an exemplary embodiment, heat can be applied to the MT by the optional MT Direct Heat Source (HH). In an exemplary embodiment, heat can be applied by the HLT Direct Heat Source (GG) to heat the HLT contents. In an exemplary embodiment, the heated HLT contents can also be used as a heat source for the MT contents via the HLT to MT Heat Exchanger Coil (DD).

Step 5 in FIG. 7 Exemplary Brewing System:

In an exemplary embodiment, HLT recirculation is accomplished by opening valve 4 (G), turning on pump 1 (H), opening valve 2 (E), and allowing fluid to flow into the top HLT inlet. In an exemplary embodiment, MT recirculation is accomplished by opening valve 11 (Q), turning on pump 2 (R), opening valve 10 (P), opening valve 8 (M), and allowing fluid to flow through the Heat Exchanger (CC) before flowing into the top MT inlet. In an exemplary embodiment, heat can be applied to the MT contents by the Optional MT Direct Heat Source (FF) or by the Heat Exchanger (CC). In an exemplary embodiment, heat can be applied by the HLT Direct Heat Source (EE) to heat the HLT contents.

Step 5 in FIG. 8 Exemplary Brewing System:

In this exemplary embodiment, HLT recirculation is accomplished by opening valve 4 (G), turning on pump 1 (H), opening valve 2 (E), and allowing fluid to flow through the HLT Recirculation Flow Rate Restrictor (D) before flowing into the top HLT inlet. In an exemplary embodiment, MT recirculation is accomplished by opening valve 11 (Q), turning on pump 2 (R), opening valve 10 (P), allowing fluid to flow through the MT Recirculation Flow Rate Restrictor (N), opening valve 8 (M), and allowing fluid to flow through the HLT to MT Heat Exchanger Coil (CC) before flowing into the top MT inlet. Heat can be applied to the MT by the Optional MT Direct Heat Source (FF). In an exemplary embodiment, heat can be applied by the HLT Direct Heat Source (EE) to heat the HLT contents. In an exemplary embodiment, the heated HLT contents can also be used as a heat source for the MT contents via the HLT to MT Heat Exchanger Coil (CC).

Step 6: Sparge (i.e., Lauter):

In one or more exemplary embodiments, the sparging or lautering process (i.e., draining the sugary wort from the MT and transferring it to the Boil kettle while simultaneously transferring HLT water to the top of the mash to rinse all the residual sugars off the grains) is a process that takes between about 1-1.5 hours. Accordingly, there are separate Sparge rate restrictors that are separate from the Recirculation rate restrictors that control the sparge rate of the MT to BK leg and the sparge rate of the HLT to MT leg. In one or more exemplary embodiments, these sparge flow rate restrictors are set such that the rates exactly match so that one vessel does not fill faster or slower than the other vessel and to ensure the proper sparge duration. In one or more exemplary embodiments, bottom filling the BK from the MT during the sparge is possible in one or more exemplary embodiments and can decrease undesired wort oxygenation (i.e., hot side aeration).

Step 6 on FIG. 1 Exemplary Brewing System:

In this exemplary embodiment, MT to BK sparge top fill is accomplished by opening valve 11 (N), turning on pump 2 (Z), opening valve 16 (S), and allowing the liquid to fill the BK (C) from the top BK inlet. In an exemplary embodiment, HLT to MT top fill sparge is accomplished by opening valve 3 (F), turning on pump 1 (Y), opening valve 6 (I), opening valve 7 (J), allowing the liquid to flow through the Heat Exchanger (AA), and allowing the fluid to flow into the MT (B) via the top MT inlet.

Step 6 in FIG. 2 Exemplary Brewing System:

In this exemplary embodiment, MT to BK sparge bottom fill option is accomplished by opening valve 11 (N), opening valve 12 (O), turning on pump 2 (Z), allowing the liquid to flow through the MT to BK Sparge Flow Rate Restrictor (W), opening valve 14 (Q), and allowing the liquid to fill the BK from the bottom up. In an exemplary embodiment, MT to BK sparge top fill option is accomplished by opening valve 11 (N), opening valve 12 (O), turning on pump 2 (Z), opening valve 16 (S), allowing the liquid to flow through the chiller (X) without active chilling, and allowing the liquid to fill the BK (C) from the top BK inlet. In an exemplary embodiment, HLT to MT sparge is accomplished by opening valve 3 (F), turning on pump 1 (Y), opening valve 6 (I), opening valve 7 (J), allowing the liquid to flow through the HLT to MT Flow Rate Restrictor (U), allowing the liquid to flow through the HLT to MT Heat Exchanger Coil (AA), and allowing the liquid to flow to the top of the MT (B) via the top MT inlet.

Step 6 in FIG. 3 Exemplary Brewing System:

In this exemplary embodiment, MT to BK sparge is accomplished by opening valve 10 (P), turning on pump 2 (V), opening valve 11 (S), and allowing the liquid to flow into the BK (C) from the top BK inlet. In an exemplary embodiment, HLT to MT sparge is accomplished by opening valve 1 (D), turning on pump 1 (E), opening valve 5 (K), and allowing the liquid to travel through the Heat Exchanger (Z) and then to the top of the MT (B) via the top MT inlet.

Step 6 in FIG. 4 Exemplary Brewing System:

In an exemplary embodiment, MT to BK sparge is accomplished by opening valves 9 (O) and 10 (P), turning on pump 2 (V), opening valve 11 (S), allowing the liquid to flow through the MT to BK Sparge Flow Rate Restrictor (R), and allowing the liquid to flow through the Counter Flow Plate Chiller (Q) without chilling before filling the BK (C) from the top BK inlet. In an exemplary embodiment, HLT to MT sparge is accomplished by opening valve 1 (D), turning on pump 1 (E), allowing the liquid to flow through the HLT to MT Flow Rate Restrictor (I), opening valve 4 (H), and allowing the liquid to travel through the HLT to MT Heat Exchanger Coil (Z) and then to the top of the MT (B) via the top MT inlet.

Step 6 in FIG. 5 Exemplary Brewing System:

In an exemplary embodiment, MT to BK Sparge is accomplished by opening valve 9 (O), turning on pump 3 (X), opening valve 15 (Z), and allowing the liquid to flow into the BK (C) through the top BK inlet. In an exemplary embodiment, HLT to MT sparge is accomplished by opening valve 6 (K), turning on pump 1 (L), opening valve 11 (S), allowing the water to flow through the Heat Exchanger Coil (DD), and allowing the water to flow into the MT (B) through the top MT inlet.

Step 6 in FIG. 6 Exemplary Brewing System:

In this exemplary embodiment, MT to BK sparge is accomplished by opening valves 8 (N), 9 (O), and 18 (EE), turning on pump 3 (X), allowing the wort to flow through the MT to BK Sparge Flow Rate Restrictor (Y), opening valve 15 (Z), and allowing the wort to flow into the BK(C) through the top BK inlet. In an exemplary embodiment, HLT to MT sparge is accomplished by opening valves 5 (J), and 6 (K), turning on pump 1 (L), opening valves 11 (S) and 19 (F), allowing the water to flow through the HLT to MT Sparge Flow Rate Restrictor (R), allowing the water to flow through the HLT to MT Heat Exchanger Coil (DD) and into the MT (B) through the top MT inlet.

Step 6 in FIG. 7 Exemplary Brewing System:

In this exemplary embodiment, HLT to MT sparge is accomplished by opening valve 4 (G), turning on pump 1 (H), opening valves 6 (J) and 8 (M), and allowing fluid to flow through the Heat Exchanger (CC) before flowing to the top MT inlet and then the top of the grain bed. In an exemplary embodiment, MT to BK sparge is accomplished by opening valve 11 (Q), turning on pump 2 (R), opening valves 12 (S) and 13 (U), and allowing fluid to flow to the top BK inlet.

Step 6 in FIG. 8 Exemplary Brewing System:

In an exemplary embodiment, the HLT to MT sparge is accomplished by opening valve 4 (G), turning on pump 1 (H), opening valve 6 (J), allowing fluid to flow through the HLT to MT Sparge Flow Rate Restrictor (L), opening valve 7 (K), and allowing fluid to flow through the HLT to MT Heat Exchanger Coil (CC) before flowing to the top MT inlet and then the top of the grain bed. In an exemplary embodiment, MT to BK sparge is accomplished by opening valve 11 (Q), turning on pump 2 (R), opening valve 12 (S), allowing fluid to flow through the MT to BK Sparge Flow Rate Restrictor (X), opening valve 14 (W), and allowing fluid to flow to the top BK inlet.

Step 7: Boil Contents of BK and Addition of Hops at Specified Times:

In one or more exemplary embodiments, the wort is boiled in the Boil Kettle for about 60 to 90 minutes and hops are added throughout the boil at various times depending on hop characteristics desired in the final beer. Hops added at the beginning of the boil are boiled the longest and impart mostly bitterness with little to no flavor or aroma. Hops added with about 30 minutes of boil time left impart slight bitterness, mostly flavor, and very little aroma. Hops added at the end of the boil (with about 5 minutes of boil time left or less) impart very little bitterness, very little flavor, and mostly aroma to the finished beer. In one or more exemplary embodiments, these hop additions may be performed manually, but may also be performed by a “hop rack” that contains a number of cups for holding the various hop additions. Each cup may have a mechanism that individually tips each cup, thus adding that cup's contents to the open boil kettle. The lid of the boil kettle may also contain a mechanism for opening and closing the lid of the boil kettle such that the kettle contents can be kept sterile during cooling. In one or more exemplary embodiments, all these functions (tipping the hop cups and opening/closing the kettle lid) may be performed by servo motors, but other mechanisms may also be used. In this way, the mechanisms controlling the cup tipping and opening/closing the kettle lid can be linked to the automation controller as outputs. For example, to operate the tipping of cup A, the automation controller may be programmed to send the output signal to cup A's servo motor, thus activating the servo motor and causing the cup's contents to be added to the boil. The automation controller is thus programmed with which of the various cup(s) to add to the boil kettle at specified time(s) during the boil. For example, if the user wishes for cups A and B to be added to the boil kettle when there are 60 minutes left in the boil, the user programs the automation controller using the software to tip cups A and B at 60 minutes remaining in the boil. In one or more exemplary embodiments, the user interface may be a computer screen of a tablet PC, laptop PC, or possibly a smart phone to enter the various parameters (time and temp rests, boil duration, hop addition times and amounts) unique to the user's recipe. The programming of the automation controller then takes that user's recipe specific parameters and executes it using the automation controller program logic. At the programmed time, the cup contents are then added to the Boil Kettle. At the end of the boil, the hop rack then closes the lid of the Boil Kettle, likely using a separate Boil kettle lid servo motor, such that the Boil Kettle contents are kept in a closed system and are sterile before, during, and after cooling. In an exemplary embodiment, sterility of this closed system is accomplished if the lid is closed and the contents of the boil kettle are boiled for a few minutes to ensure no potential microbial contamination survives (steam sanitation from the heat of the boil) in the closed system before the contents are cooled.

Step 7 in ALL 8 Exemplary Brewing Systems:

In this exemplary embodiment, heat is applied to the BK using the BK Direct Heat Source (component EE in FIGS. 1 and 2, component DD in FIGS. 3 and 4, component II in FIGS. 5 and 6, and component GG in FIGS. 7 and 8). In an exemplary embodiment, hops may either be added manually or may be added automatically by the automation controller using the “hop rack” device described herein.

Step 8: Sanitize Chiller without Cooling:

In an exemplary embodiment equipped with a chiller (such as those illustrated in FIGS. 2, 4, 6, and 8), occasionally, debris may get caught in the counter-flow plate chiller. This debris may potentially cause an infection of the wort in the Boil Kettle if the debris is not sterilized before the wort is cooled. In an exemplary embodiment, this step runs boiling wort through the plumbing and the chiller, such that the entire plumbing system and chiller that come into contact with chilled beer, is free from any possible microbial contamination. Additionally, the boil kettle inlet may be aimed to inject the wort back into the Boil Kettle in either a counter-clockwise or clockwise direction such that a whirlpool is generated during this step. A whirlpool is beneficial as it gathers all the hop debris and solid particles into the center of the Boil Kettle and facilitates draining of the fluid Boil Kettle contents. Step 8 cannot be accomplished on exemplary brewing systems depicted in FIGS. 1, 3, 5, and 7, as these systems lack a chiller. In one or more exemplary embodiments, throughout this step, the boil is maintained in the BK using the BK Direct Heat Source (component EE in FIG. 2, component DD in FIG. 4, component II in FIG. 6, and component GG in FIG. 8.)

Step 8 in FIGS. 1, 3, 5 and 7 Exemplary Brewing Systems:

This step may not be performed on these exemplary brewing systems as depicted, as they lack a chiller.

Step 8 in FIG. 2 Exemplary Brewing System:

In this exemplary embodiment, this step is accomplished by opening valve 13 (P), opening valve 12 (O), turning on pump 2 (Z), opening valve 16 (S), allowing the boiling hot wort to circulate through the chiller (X) without the chiller actively chilling, and allowing the boiling hot wort to be added back to the top of the Boil Kettle.

Step 8 in FIG. 4 Exemplary System:

In this exemplary embodiment, Boil Kettle Recirculation without cooling is accomplished by opening valve 13 (W), turning on pump 2 (V), allowing the wort to pass through the BK recirculation restrictor (U), opening valve 12 (T), and allowing the boiling hot wort to circulate through the chiller (Q) without cooling and be added back to the top of the Boil Kettle.

Step 8 in FIG. 6 Exemplary Brewing System:

In this exemplary embodiment, Boil Kettle Recirculation without cooling is accomplished by allowing the boiling wort to flow through the chiller (CC) without active chilling, opening valve 14 (W), opening valve 18 (EE), turning on pump 3 (X), opening valve 16 (AA), and allowing the boiling hot wort to flow into the Boil Kettle through the top Boil Kettle inlet.

Step 8 in FIG. 8 Exemplary Brewing System:

In this exemplary embodiment, this step is accomplished by allowing the fluid to flow through the chiller (T) without active chilling, opening valve 16 (Z), turning on pump 3 (AA), opening valve 15 (Y), allowing fluid to flow through the BK recirculation flow rate restrictor (V), opening valve 13 (U), and allowing fluid to flow back to the BK (C) through the top BK inlet.

Step 9: Chill contents of BK:

In an exemplary embodiment, this step is the same as Step 8 above, but with the addition of cooling water valve being turned on to supply cooling water from the pressurized water source to the water side of the chiller. In an exemplary embodiment, a whirlpool is still generated if Boil Kettle inlet is aimed correctly. In an exemplary embodiment, wort is recirculated with the Boil Kettle lid on to prevent microbial contamination from airborne organisms. Once the wort reaches temperatures below 160° F., there is a very HIGH risk of microbial contamination so the system must stay sterile and closed until the brewer is ready to transfer the cooled wort to a fermenter and pitch the yeast. In this step, beer can be chilled to temperatures a few degrees higher than the temperature of the cooling water used. In other exemplary embodiments, any additional cooling desired requires other cooling means (refrigeration, etc.)

Step 9 in FIGS. 1, 3, 5 and 7 Exemplary Brewing Systems:

In these exemplary embodiments, this step may not be performed on these exemplary brewing systems as depicted on the figures as they lack a chiller.

Step 9 in FIG. 2 Exemplary Brewing System:

In this exemplary embodiment, this step is accomplished by opening valve 13 (P), opening valve 12 (O), turning on pump 2 (Z), opening valve 16 (S), allowing the boiling hot wort to circulate through the chiller (X), providing active cooling by opening valve 4 (G) and allowing the cooling water from the pressurized water source to flow through the water side of the chiller, and allowing cooled wort to flow back to the BK (C) through the top BK inlet.

Step 9 in FIG. 4 Exemplary Brewing System:

In this exemplary embodiment, Boil Kettle Recirculation with cooling is accomplished by opening valve 13 (W), turning on pump 2 (V), allowing the wort to pass through the BK recirculation restrictor (U), opening valve 12 (T), and allowing the boiling hot wort to circulate through the chiller (Q), providing active cooling by opening valve 3 (G) and allowing the cooling water from the pressurized water source to flow through the water side of the chiller and out the drain, and allowing cooled wort to flow back to the BK (C) through the top BK inlet.

Step 9 in FIG. 6 Exemplary Brewing System:

In this exemplary embodiment, Boil Kettle Recirculation with cooling is accomplished by allowing the boiling wort to flow through the beer side of the chiller (CC), providing active cooling by opening valve 4 (I) and allowing the cooling water from the pressurized water source to flow through the water side of the chiller and into the drain, opening valve 14 (W), opening valve 18 (EE), turning on pump 3 (X), opening valve 16 (AA), and allowing cooled wort to flow back to the BK (C) through the top BK inlet.

Step 9 in FIG. 8 Exemplary Brewing System:

In this exemplary embodiment, this step is accomplished by allowing the fluid to flow through the chiller (T), providing active cooling by opening valve 5 (I) and allowing the cooling water from the pressurized water source to flow through the water side of the chiller and into the drain, opening valve 16 (Z), turning on pump 3 (AA), opening valve 15 (Y), allowing fluid to flow through the BK recirculation flow rate restrictor (V), opening valve 13 (U), and allowing cooled wort to flow back to the BK (C) through the top BK inlet.

Step 10: Drain Contents of BK into Fermenter

Step 10 in FIG. 1 Exemplary Brewing System:

In this exemplary embodiment, this step is accomplished by opening valve 15 (R) and allowing the wort to flow into the sanitized Fermenter (BB).

Step 10 in FIG. 2 Exemplary Brewing System:

In this exemplary embodiment, this step is accomplished by opening valve 15 (R) and allowing the cooled wort to flow into the sanitized Fermenter (BB).

Step 10 in FIG. 3 Exemplary Brewing System:

In this exemplary embodiment, draining wort into the sanitized fermenter is accomplished by opening valve 13 (W), opening valve 14 (X), and allowing the wort to fill the fermenter (AA).

Step 10 in FIG. 4 Exemplary Brewing System:

In this exemplary embodiment, draining cooled wort into the sanitized fermenter is accomplished by opening valve 13 (W), opening valve 14 (X), and allowing the cooled wort to fill the fermenter (AA).

Step 10 in FIG. 5 Exemplary Brewing System:

In this exemplary embodiment, draining wort into the sanitized fermenter is accomplished by opening valve 14 (W), opening valve 17 (BB), and allowing the wort to flow into the sanitized fermenter (FF).

Step 10 on FIG. 6 Exemplary Brewing System:

In this exemplary embodiment, draining cooled wort into the sanitized fermenter is accomplished by allowing the cooled wort to flow through the Chiller (CC) without active chilling, opening valve 14 (W), opening valve 17 (BB), and allowing the cooled wort to flow into the sanitized fermenter (FF).

Step 10 in FIG. 7 Exemplary Brewing System:

In this exemplary embodiment, this step is accomplished by allowing the wort to flow through the opened valve 17 (BB), and allowing the BK contents to flow into the sanitized fermenter (DD).

Step 10 in FIG. 8 Exemplary Brewing System:

In this exemplary embodiment, this step is accomplished by allowing the fluid to flow through the chiller (T) without active chilling, opening valve 17 (BB), and allowing the cooled wort to flow into the sanitized fermenter (DD).

Step 11: Add Yeast to Fermenter:

In an exemplary embodiment, addition of the yeast is manually done. The contents of the fermenter are then fermented at a controlled temperature until complete. In an exemplary embodiment, this fermentation step may take place in a temperature-controlled refrigerated cabinet that this exemplary brew system is mounted on and which is operated by the same automation controller as the exemplary brewing systems.

Thus, exemplary embodiments of a traditional automated brewing system have been disclosed. It should be apparent, however, to those skilled in the art that many more modifications besides those already described are possible without departing from the inventive concepts herein. The disclosed subject matter, therefore, is not to be restricted in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. An automated beer brewing system comprising:
a hot liquor tank comprising a tank inlet and a tank outlet, wherein said hot liquor tank comprises a means for heating liquid;
a mash tun having a tun inlet and a tun outlet; wherein said mash tun optionally comprises a means for heating liquid;
a boil kettle comprising a kettle inlet and a kettle outlet, wherein said boil kettle comprises a means for heating liquid;
a valve 6 comprising an inlet in fluid communication with said hot liquor tank outlet, and further comprising an outlet in fluid communication with a pump 1;
a valve 1 comprising an inlet in fluid communication with said pump 1, and further comprising an outlet in fluid communication with said hot liquor tank inlet;
a valve 11 comprising an inlet in fluid communication with said pump 1, and further comprising an outlet in fluid communication with said mash tun inlet;
said pump 1 disposed between the outflow side of said valve 6, and the inflow side of said valves 1 and 11;
a valve 10 comprising an inlet in fluid communication with said mash tun outlet, and further comprising an outlet in fluid communication with a pump 2;
a valve 12 comprising an inlet in fluid communication with said pump 2, and further comprising an outlet in fluid communication with said mash tun inlet;
wherein said pump 2 disposed between the outflow side of said valve 10, and the inflow side of said valve 12;
a heat exchanger located between the outflow side of said valve 12 and said mash tun inlet; said heat exchanger containing means for heating liquid as it travels from said mash tun outlet to said mash tun inlet;
a valve 9 comprising an inlet in fluid communication with said mash tun outlet, and further comprising an outlet in fluid communication with a pump 3;
a valve 15 comprising an inlet in fluid communication with said pump 3, and further comprising an outlet in fluid communication with said boil kettle inlet;
a valve 14 comprising an inlet in fluid communication with said boil kettle outlet, and further comprising an outlet in fluid communication with said pump 3;
wherein said pump 3 disposed between the outflow side of said valves 9 and 14, and the inflow side of said valve 15;
a fermenter comprising a fermenter inlet, and a fermenter outlet, and a means for fermenting beer wort with yeast;
a valve 17 comprising an inlet in fluid communication with the output of said valve 14, and further comprising an outlet in fluid communication with said fermenter inlet;
a first T-connection comprising (i) an inlet from the output of said pump 1, (ii) a first outlet to the input of said valve 11, and (iii) a second outlet to the input of said valve 1;
a second T-connection comprising (i) a first inlet from the output of said 11, (ii) a second inlet from the output of said valve 12, and (iii) an outlet to the input of said mash tun inlet;
a third T-connection comprising (i) an inlet from the output of said mash tun outlet, (ii) a first outlet to the input of said valve 9, and (iii) a second outlet to the input of said valve 10; and
a first four-way cross connection comprising (i) a first inlet from the output of said valve 9, (ii) a second inlet from the output of said valve 14, (iii) an outlet to the input of said pump 3, and (iv) a second outlet to the input of said valve 17;
wherein said hot liquor tank, mash tun, boil kettle, valves and pumps are all electrically interconnected to a power source.

2. An automated beer brewing system, comprising:
a hot liquor tank comprising a tank inlet and a tank outlet, wherein said hot liquor tank comprises a HLT to MT heat exchanger and comprises a means for heating liquid;
wherein said HLT to MT heat exchanger comprising a coil physically located inside the hot liquor tank and where the fluid-in and fluid-out connections to the coil are physically located outside the hot liquor tank, wherein said HLT to MT heat exchanger comprises a means for heating liquid;
a mash tun comprising a tun inlet and a tun outlet, wherein said mash tun optionally comprises a means for heating liquid;
a boil kettle comprising a kettle inlet and a kettle outlet, wherein said boil kettle comprises a means for heating liquid;
a water source, wherein said water source comprises a means for dispensing water;
a drain, wherein said drain comprises a means for draining liquid;
a chiller comprising a series of alternating plates containing counter-flow beer and water, wherein said chiller plates contain a means for heat exchange between said beer and said water without mixing said fluids;
a valve 3 comprising an inlet in fluid communication with said water source, and further comprises an outlet in fluid communication with a bi-directional valve 7, a valve 6, and a bi-directional valve 5;
wherein said bi-directional valve 5 comprises an inlet in fluid communication with said valve 3, and further comprises an outlet in fluid communication with said hot liquor tank outlet;
wherein said bi-directional valve 7 comprises an inlet in fluid communication with said valve 3, and further comprises an outlet in fluid communication with a bi-directional valve 9;
wherein said bi-directional valve 9 comprises an inlet in fluid communication with said bi-directional valve 7, and further comprises an outlet in fluid communication with a valve 18;
wherein said valve 18 comprises an inlet in fluid communication with said bi-directional valve 9 and a bi-directional valve 14, and further comprises an outlet in fluid communication with a pump 3;
a valve 16 comprising an inlet in fluid communication with said pump 3, and further comprises an outlet in fluid communication with said boil kettle inlet;
wherein said bi-directional valve 5 comprises an inlet in fluid communication with said hot liquor tank outlet, and further comprises an outlet in fluid communication with said valve 6;
wherein said valve 6 comprises an inlet in fluid communication with said bi-directional valve 5 and said valve 3, and further comprises an outlet in fluid communication with a pump 1;
a valve 1 comprising an inlet in fluid communication with said pump 1, and further comprises an outlet in fluid communication with a HLT Recirculation Flow Rate Restrictor;
wherein said HLT Recirculation Flow Rate Restrictor comprises an inlet in fluid communication with said valve 1, and further comprises an outlet in fluid communication with said hot liquor tank inlet;
wherein said chiller is in fluid communication with said boil kettle outlet, said bi-directional valve 14, said drain, and a valve 4;
wherein said valve 4 comprises an inlet in fluid communication with said water source, and further comprises an outlet in fluid communication with said counter-flow water chiller plates;
wherein said bi-directional valve 14 comprises an inlet in fluid communication with said chiller, and further comprises an outlet in fluid communication with said valve 18, said bi-directional valve 9, and a valve 17;
a valve 11 comprises an inlet in fluid communication with said pump 1, and further comprises an outlet in fluid communication with a valve 2, a valve 13, and a valve 19;
wherein said valve 13 comprises an inlet in fluid communication with said valve 11 and a valve 12, and further comprises an outlet in fluid communication with said mash tun outlet;
wherein said valve 2 comprises an inlet in fluid communication with said valve 11 and said valve 12, and further comprises an outlet in fluid communication with a MT Recirculation Flow Rate Restrictor;
wherein said MT Recirculation Flow Rate Restrictor comprises an inlet in fluid communication with said valve 2, and further comprises an outlet in fluid communication with said HLT to MT heat exchanger fluid-in connector;
wherein said HLT to MT heat exchanger fluid-in connector is in fluid communication with said MT Recirculation Flow Rate Restrictor and a HLT to MT Sparge Flow Rate Restrictor, and said HLT to MT heat exchanger fluid-out connector is in fluid communication with said mash tun inlet;
wherein said bi-directional valve 9 comprises an inlet in fluid communication with said bi-directional valve 14, and further comprises an outlet in fluid communication with a valve 10 and a valve 8;
wherein said valve 10 comprises an inlet in fluid communication with said bi-directional valve 9 and said valve 8, and further comprises an outlet in fluid communication with a pump 2;
wherein said valve 12 comprises an inlet in fluid communication with said pump 2, and further comprises an outlet in fluid communication with said valves 2, 19, and 13;
wherein said valve 8 comprises an inlet in fluid communication with said mash tun outlet, and further comprises an outlet in fluid communication with said valve 10 and said bi-directional valve 9;
a MT to BK Sparge Flow Rate Restrictor comprising an inlet in fluid communication with said pump 3, and further comprises an outlet in fluid communication with a valve 15;
wherein said valve 15 comprises an inlet in fluid communication with said MT to BK Sparge Flow Rate Restrictor, and further comprises an outlet in fluid communication with said boil kettle inlet;
wherein said valve 19 comprises an inlet in fluid communication with said valve 11, and further comprises an outlet in fluid communication with said HLT to MT Sparge Flow Rate Restrictor;
wherein said HLT to MT Sparge Flow Rate Restrictor comprises an inlet in fluid communication with said valve 19, and further comprises an outlet in fluid communication with said HLT to MT heat exchanger fluid-in connector;
a fermenter comprising a fermenter inlet and a fermenter outlet, wherein said fermenter comprises a means for fermenting beer wort with yeast;
wherein said valve 17 comprises an inlet in fluid communication with said bi-directional valve 14, and further comprises an outlet in fluid communication with said fermenter inlet;
wherein said pump 3 disposed between the outflow side of said valve 18, and the inflow sides of said MT to BK Sparge Flow Rate Restrictor and said valve 16;
wherein said pump 2 disposed between the outflow side of said valve 10, and the inflow side of said valve 12;
wherein said pump 1 disposed between the outflow side of said valve 6, and the inflow side of said valves 1 and 11;
a first T-connection comprising: (i) an inlet from the output of said water source, (ii) a first outlet to the input of said valve 3, and (iii) a second outlet to the input of said valve 4;
a second T-connection comprising: (i) an inlet from the output of said pump 1, (ii) a first outlet to the input of said valve 11, and (iii) a second outlet to the input of said valve 1;
a third T-connection comprising: (i) an inlet from the output of said pump 3, (ii) a first outlet to the input of said MT to BK Sparge Flow Rate Restrictor, (iii) a second outlet to the input of said valve 16;
a fourth T-connection comprising: (i) a first inlet from the output of said valve 16, (ii) a second inlet from the output of said valve 15, and (iii) an outlet in fluid communication with said boil kettle inlet;
a fifth T-connection comprising: (i) a first inlet from the output of said MT Recirculation Flow Rate Restrictor, (ii) a second inlet from the output of said HLT to MT Sparge Flow Rate Restrictor, and (iii) an outlet to the input of said HLT to MT heat exchanger fluid-in connector;
a sixth T-connection comprising: (i) a first inlet from the output of said valve 11, (ii) a second inlet from the output of said valve 12, and (iii) an outlet to the first four-way connection;
a seventh T-connection comprises: (i) an inlet from the output of said valve 13, (ii) a bi-directional connection to the mash tun bottom outlet, (iii) and an outlet to the input of said valve 8;
wherein said first four-way connection comprising: (i) an inlet from the output of said sixth T-connection, (ii) a first outlet to the input of said valve 19, (iii) a second outlet to the input of said valve 2, (iv) and a third outlet to the input of said valve 13;
a second four-way connection comprising: (i) a first connection to said bi-directional valve 7, (ii) a second connection to said bi-directional valve 9, (iii) an inlet from the output of said valve 8, (iv) and an outlet to the input of said valve 10;
a third four-way connection comprising: (i) a first connection to said bi-directional valve 14, (ii) a second connection to said bi-directional valve 9, (ii) a first outlet to the input of said valve 18, and (iii) a second outlet to the input of said valve 17; and
a fourth four-way connection comprising: (i) a first connection to said bi-directional valve 7, (ii) an inlet from the output of said valve 3, (ii) a second connection to said bi-directional valve 5, and (iii) an outlet to the input of said valve 6;
wherein said hot liquor tank, mash tun, boil kettle, valves, flow-rate restrictors, heat exchanger, direct heat sources, water source, chiller, drain, and pumps are all electrically interconnected to a power source.

3. The automatic beer brewing system according to claim 2, wherein:
said water source is on;
said valve 3 is open, providing a fluid flow path from said water source to said inlet of bi-directional valve 5;
said bi-directional valve 5 is open, providing a fluid flow path from said outlet of bi-directional valve 5 to said hot liquor tank outlet; and
said valves 1, 2, 4, 6, 7, 8, 9, 10, 11, 12, 13, 14, 15, 16, 17, 18, and 19 are closed, said HLT Recirculation, MT Recirculation, HLT to MT Sparge, and MT to BK Sparge Flow Rate Restrictors are not in use, and said pumps 1, 2, and 3 are off, providing a non-recirculating fluid flow path from said water source to said hot liquor tank outlet.

4. The automatic beer brewing system according to claim 2, wherein:
said water source is on;
said valve 3 is open, providing a fluid flow path from said water source to said inlet of bi-directional valve 7;
said bi-directional valve 7 is open, providing a fluid flow path from said outlet of bi-directional valve 7 to said inlet of bi-directional valve 9;
said bi-directional valve 9 is open, providing a fluid flow path from said outlet of bi-directional valve 9 to said inlet of valve 18;
said valve 18 is open, providing a fluid flow path from said outlet of valve 18 to said pump 3;
said pump 3 pumps said liquid to said inlet of valve 16; said valve 16 is open, providing a fluid flow path from said outlet of valve 16 to said boil kettle inlet; and
said valves 1, 2, 4, 5, 6, 8, 10, 11, 12, 13, 14, 15, 17, and 19 are closed, said HLT Recirculation, MT Recirculation, HLT to MT Sparge, and MT to BK Sparge Flow Rate Restrictors are not in use, and said pumps 1 and 2 are off, providing a non-recirculating fluid flow path from said water source to said boil kettle inlet.

5. The automatic beer brewing system according to claim 2, wherein:
said bi-directional valve 5 is open, providing a fluid flow path from said hot liquor tank outlet to said inlet of valve 6;
said valve 6 is open, providing a fluid flow path from said outlet of valve 6 to said pump 1;
said pump 1 pumps said liquid to said inlet of valve 1;
said valve 1 is open, providing a fluid flow path from said outlet of valve 1 to said inlet of the HLT Recirculation Flow Rate Restrictor;
said HLT Recirculation Flow Rate Restrictor is open, providing a fluid flow path from said outlet of the HLT Recirculation Flow Rate Restrictor to said hot liquor tank inlet; and
said valves 2, 3, 4, 7, 8, 9, 10, 11, 12, 13, 14, 15, 16, 17, 18, and 19 are closed, said HLT to MT Sparge, MT Recirculation, and MT to BK Sparge Flow Rate Restrictors are not in use, and said pumps 2 and 3 are off, providing a recirculating fluid flow path from said hot liquor tank outlet to said hot liquor tank inlet.

6. The automatic beer brewing system according to claim 2, wherein:
said counter-flow water chiller plates are in fluid communication with said boil kettle outlet and said valve 14;
said valve 14 is open, providing a fluid flow path from said counter-flow beer chiller plates to said inlet of valve 18;
said valve 18 is open, providing a fluid flow path from said outlet of valve 18 to said pump 3;
said pump 3 pumps said liquid to said inlet of valve 16;
said valve 16 is open, providing a fluid flow path from said outlet of valve 16 to said boil kettle inlet; and
said valves 1, 2, 3, 4, 5, 6, 7, 8, 9, 10, 11, 12, 13, 15, 17, and 19 are closed, said HLT Recirculation, MT Recirculation, HLT to MT Sparge, and MT to BK Sparge Flow Rate Restrictors are not in use, and said pumps 1 and 2 are off, providing a recirculating fluid flow path from said boil kettle outlet to said boil kettle inlet.

7. The automatic beer brewing system according to claim 2, wherein:
said bi-directional valve 5 is open, providing a fluid flow path from said hot liquor tank outlet to said inlet of valve 6;
said valve 6 is open, providing a fluid flow path from said outlet of valve 6 to said pump 1;
said pump 1 pumps said liquid to said inlet of valve 11;
said valve 11 is open, providing a fluid flow path from said outlet of valve 11 to said inlet of valve 13;
said valve 13 is open, providing a fluid flow path from said outlet of valve 13 to said mash tun outlet; and
said valves 1, 2, 3, 4, 7, 8, 9, 10, 12, 14, 15, 16, 17, 18, and 19 are closed, said HLT Recirculation, MT Recirculation, HLT to MT Sparge, and MT to BK Sparge Flow Rate Restrictors are not in use, and said pumps 2 and 3 are off, providing a non-recirculating fluid flow path from said hot liquor tank outlet to said mash tun outlet.

8. The automatic beer brewing system according to claim 2, wherein:
said bi-directional valve 5 is open, providing a fluid flow path from said hot liquor tank outlet to said inlet of valve 6;
said valve 6 is open, providing a fluid flow path from said outlet of valve 6 to said pump 1;
said pump 1 pumps said liquid to said inlet of valve 11;
said valve 11 is open, providing a fluid flow path from said outlet of valve 11 to said inlet of valve 2;
said valve 2 is open, providing a fluid flow path from said outlet of valve 2 to said inlet of the MT Recirculation Flow Rate Restrictor;
said MT Recirculation Flow Rate Restrictor is open, providing a fluid flow path from said outlet of the MT Recirculation Flow Rate Restrictor to said HLT to MT heat exchanger fluid-in connector;
said HLT to MT heat exchanger fluid-in connector is in fluid communication with said HLT to MT heat exchanger fluid-out connector, providing a fluid flow path from said HLT to MT heat exchanger fluid-in connector to said mash tun inlet; and
said valves 1, 3, 4, 7, 8, 9, 10, 12, 13, 14, 15, 16, 17, 18, and 19 are closed, said HLT Recirculation, HLT to MT Sparge, and MT to BK Sparge Flow Rate Restrictors are not in use, and said pumps 2 and 3 are off, providing a non-recirculating fluid flow path from said hot liquor tank outlet to said mash tun inlet.

9. The automatic beer brewing system according to claim 2, wherein:
said counter-flow water chiller plates are in fluid communication with said boil kettle outlet and said valve 14;
said valve 14 is open, providing a fluid flow path from said counter-flow beer chiller plates to said inlet of bi-directional valve 9;
said bi-directional valve 9 is open, providing a fluid flow path from said inlet of bi-directional valve 9 to said valve 10;
said valve 10 is open, providing a fluid flow path from said outlet of valve 10 to said pump 2;
said pump 2 pumps said liquid to said inlet of valve 12;
said valve 12 is open, providing a fluid flow path from said outlet of valve 12 to said inlet of valve 13;
said valve 13 is open, providing a fluid flow path from said outlet of valve 13 to said mash tun outlet; and
said valves 1, 2, 3, 4, 5, 6, 7, 8, 11, 15, 16, 17, 18, and 19 are closed, said HLT Recirculation, MT Recirculation, HLT to MT Sparge, and MT to BK Sparge Flow Rate Restrictors are not in use, and said pumps 1 and 3 are off, providing a non-recirculating fluid flow path from said boil kettle outlet to said mash tun outlet.

10. The automatic beer brewing system according to claim 2, wherein:
said counter-flow water chiller plates are in fluid communication with said boil kettle outlet and said valve 14;
said valve 14 is open, providing a fluid flow path from said counter-flow beer chiller plates to said inlet of bi-directional valve 9;
said bi-directional valve 9 is open, providing a fluid flow path from said inlet of bi-directional valve 9 to said valve 10;
said valve 10 is open, providing a fluid flow path from said outlet of valve 10 to said pump 2;
said pump 2 pumps said liquid to said inlet of valve 12;
said valve 12 is open, providing a fluid flow path from said outlet of valve 12 to said inlet of valve 2;
said valve 2 is open, providing a fluid flow path from said outlet of valve 2 to said inlet of the MT Recirculation Flow Rate Restrictor;
said MT Recirculation Flow Rate Restrictor is open, providing a fluid flow path from said outlet of the MT Recirculation Flow Rate Restrictor to said HLT to MT heat exchanger fluid-in connector;
said HLT to MT heat exchanger fluid-in connector is in fluid communication with said HLT to MT heat exchanger fluid-out connector, providing a fluid flow path from said HLT to MT heat exchanger fluid-in connector to said mash tun inlet; and
said valves 1, 3, 4, 5, 6, 7, 8, 11, 13, 15, 16, 17, 18, and 19 are closed, said HLT Recirculation, HLT to MT Sparge, and MT to BK Sparge Flow Rate Restrictors are not in use, and said pumps 1 and 3 are off, providing a non-recirculating fluid flow path from said boil kettle outlet to said mash tun inlet.

11. The automatic beer brewing system according to claim 2, wherein:
said water source is on;
said valve 3 is open, providing a fluid flow path from said water source to said inlet of valve 6;
said bi-directional valve 5 is open, providing a fluid flow path from said hot liquor tank outlet to said inlet of valve 6;
said valve 6 is open, providing a fluid flow path from said outlet of valve 6 to said pump 1;
said pump 1 pumps said liquid to said inlet of valve 1;
said valve 1 is open, providing a fluid flow path from said outlet of valve 1 to said inlet of the HLT Recirculation Flow Rate Restrictor;
said HLT Recirculation Flow Rate Restrictor is open, providing a fluid flow path from said outlet of the HLT Recirculation Flow Rate Restrictor to said hot liquor tank inlet; and
said valves 2, 4, 7, 8, 9, 10, 11, 12, 13, 14, 15, 16, 17, 18, and 19 are closed, said MT Recirculation, HLT to MT Sparge, and MT to BK Sparge Flow Rate Restrictors are not in use, and said pumps 2 and 3 are off, providing a first non-recirculating fluid flow path from said water source to said hot liquor tank inlet, and a second recirculating fluid flow path from said hot liquor tank outlet to said hot liquor tank inlet. Fluid flow paths one and two can be alternated such that only one or the other is flowing at a given time.

12. The automatic beer brewing system according to claim 2, wherein:
said bi-directional valve 5 is open, providing a fluid flow path from said hot liquor tank outlet to said inlet of valve 6;
said valve 6 is open, providing a fluid flow path from said outlet of valve 6 to said pump 1;
said pump 1 pumps said liquid to said inlet of valve 1;
said valve 1 is open, providing a fluid flow path from said outlet of valve 1 to said inlet of the HLT Recirculation Flow Rate Restrictor;
said HLT Recirculation Flow Rate Restrictor is open, providing a fluid flow path from
said outlet of the HLT Recirculation Flow Rate Restrictor to said hot liquor tank inlet;
said valve 8 is open, providing a fluid flow path from said mash tun outlet to said inlet of valve 10;
said valve 10 is open, providing a fluid flow path from said outlet of valve 10 to said pump 2;
said pump 2 pumps said liquid to said inlet of valve 12;
said valve 12 is open, providing a fluid flow path from said outlet of valve 12 to said inlet of valve 2;
said valve 2 is open, providing a fluid flow path from said outlet of valve 2 to said inlet of the MT Recirculation Flow Rate Restrictor;
said MT Recirculation Flow Rate Restrictor is open, providing a fluid flow path from said outlet of the MT Recirculation Flow Rate Restrictor to said HLT to MT heat exchanger fluid-in connector;
said HLT to MT heat exchanger fluid-in connector is in fluid communication with said HLT to MT heat exchanger fluid-out connector, providing a fluid flow path from said HLT to MT heat exchanger fluid-in connector to said mash tun inlet; and
said valves 3, 4, 7, 9, 11, 13, 14, 15, 16, 17, 18, and 19 are closed, said HLT to MT Sparge, and MT to BK Sparge Flow Rate Restrictors are not in use, and said pump 3 is off, providing a first recirculating fluid flow path from said hot liquor tank outlet to said hot liquor tank inlet, and a second recirculating fluid flow path from said mash tun outlet to said mash tun inlet.

13. The automatic beer brewing system according to claim 2, wherein:
said bi-directional valve 5 is open, providing a fluid flow path from said hot liquor tank outlet to said inlet of valve 6;
said valve 6 is open, providing a fluid flow path from said outlet of valve 6 to said pump 1;
said pump 1 pumps said liquid to said inlet of valve 11;
said valve 11 is open, providing a fluid flow path from said outlet of valve 11 to said inlet of valve 19;
said valve 19 is open, providing a fluid flow path from said outlet of valve 19 to said inlet of the HLT to MT Sparge Flow Rate Restrictor;
said HLT to MT Sparge Flow Rate Restrictor is open, providing a fluid flow path from said outlet of the HLT to MT Sparge Flow Rate Restrictor to said HLT to MT heat exchanger fluid-in connector;
said HLT to MT heat exchanger fluid-in connector is in fluid communication with said HLT to MT heat exchanger fluid-out connector, providing a fluid flow path from said HLT to MT heat exchanger fluid-in connector to said mash tun inlet;
said valve 8 is open, providing a fluid flow path from said mash tun outlet to said inlet of bi-directional valve 9;
said bi-directional valve 9 is open, providing a fluid flow path from said outlet of bi-directional valve 9 to said inlet of valve 18;
said valve 18 is open, providing a fluid flow path from said outlet of valve 18 to said pump 3;
said pump 3 pumps said liquid to said inlet of the MT to BK Sparge Flow Rate Restrictor;
said MT to BK Sparge Flow Rate Restrictor is open, providing a fluid flow path from said outlet of the MT to BK Sparge Flow Rate Restrictor to said inlet of valve 15;
said valve 15 is open, providing a fluid flow path from said outlet of valve 15 to said boil kettle inlet; and
said valves 1, 2, 3, 4, 7, 10, 12, 13, 14, 16, and 17 are closed, said HLT Recirculation, MT Recirculation Flow Rate Restrictors are not in use, and said pump 2 is off, providing a first non-recirculating fluid flow path from said hot liquor tank outlet to said mash tun inlet, and a second non-recirculating fluid flow path from said mash tun outlet to said boil kettle inlet.

14. The automatic beer brewing system according to claim 2, wherein:
said counter-flow beer chiller plates are in fluid communication with said boil kettle outlet and said inlet of valve 14;
said valve 14 is open, providing a fluid flow path from said counter-flow beer chiller plates to said inlet of valve 18;
said valve 18 is open, providing a fluid flow path from said inlet of valve 18 to said pump 3;
said pump 3 pumps said liquid to said inlet of valve 16;
said valve 16 is open, providing a fluid flow path from said outlet of valve 16 to said boil kettle inlet; and
said valves 1, 2, 3, 4, 5, 6, 7, 8, 9, 10, 11, 12, 13, 15, 17, and 19 are closed, said HLT Recirculation, MT Recirculation, HLT to MT Sparge, and MT to BK Sparge Flow Rate Restrictors are not in use, and said pumps 1 and 2 are off, providing a recirculating fluid flow path from said boil kettle outlet to said boil kettle inlet.

15. The automatic beer brewing system according to claim 2, wherein:
said counter-flow beer chiller plates are in fluid communication with said boil kettle outlet and said inlet of valve 14;
said valve 14 is open, providing a fluid flow path from said counter-flow beer chiller plates to said inlet of valve 18;
said valve 18 is open, providing a fluid flow path from said inlet of valve 18 to said pump 3;
said pump 3 pumps said liquid to said inlet of valve 16;
said valve 16 is open, providing a fluid flow path from said outlet of valve 16 to said boil kettle inlet;
said water source is on;
said valve 4 is open, providing a fluid flow path from said outlet of valve 4 to said counter-flow water chiller plates;
said counter-flow water chiller plates are in fluid communication with said drain, providing a fluid flow path from said counter-flow water chiller plates to said drain; and
said valves 1, 2, 3, 5, 6, 7, 8, 9, 10, 11, 12, 13, 15, 17, and 19 are closed, said HLT Recirculation, MT Recirculation, HLT to MT Sparge, and MT to BK Sparge Flow Rate Restrictors are not in use, and said pumps 1 and 2 are off, providing a first recirculating fluid flow path from said boil kettle outlet to said boil kettle inlet, and a second non-recirculating fluid flow path from said water source to said drain.

16. The automatic beer brewing system according to claim 2, wherein:
said counter-flow beer chiller plates are in fluid communication with said boil kettle outlet and said inlet of valve 14;
said valve 14 is open, providing a fluid flow path from said counter-flow beer chiller plates to said inlet of valve 17;
said valve 17 is open, providing a fluid flow path from said outlet of valve 14 to said fermenter inlet; and
said valves 1, 2, 3, 4, 5, 6, 7, 8, 9, 10, 11, 12, 13, 15, 16, 18, and 19 are closed, said HLT Recirculation, MT Recirculation, HLT to MT Sparge, and MT to BK Sparge Flow Rate Restrictors are not in use, and said pumps 1, 2, and 3 are off, providing a non-recirculating fluid flow path from said boil kettle outlet to said fermenter inlet.

17. An automated beer brewing system comprising:
a hot liquor tank comprising a tank inlet and a tank outlet, wherein said hot liquor tank comprises a means for heating liquid;
a mash tun having a tun inlet and a tun outlet; wherein said mash tun optionally comprises a means for heating liquid;
a boil kettle comprising a kettle inlet and a kettle outlet, wherein said boil kettle comprises a means for heating liquid;
a valve 4 comprising an inlet in fluid communication with said hot liquor tank outlet, and further comprising an outlet in fluid communication with a pump 1;
a valve 2 comprising an inlet in fluid communication with said pump 1, and further comprising an outlet in fluid communication with said hot liquor tank inlet;
a valve 6 comprises an inlet in fluid communication with said pump 1, and further comprising an outlet in fluid communication with a valve 8;
wherein said pump 1 disposed between the outflow side of said valve 4, and the inflow sides of said valves 2 and 6;
wherein said valve 8 comprises an inlet in fluid communication with said valve 6 and a valve 10, and further comprises an outlet in fluid communication with said heat exchanger and said mash tun inlet;
a valve 11 comprising an inlet in fluid communication with said mash tun outlet, and further comprising an outlet in fluid communication with a pump 2;
wherein said valve 10 comprises an inlet in fluid communication with said pump 2, and an further comprises outlet in fluid communication with said valve 8;
a heat exchanger located between said valve 8 and said mash tun inlet, said heat exchanger containing means for heating liquid;
a valve 12 comprising an inlet in fluid communication with said pump 2, and further comprising an outlet in fluid communication with a valve 13;
wherein said pump 2 disposed between the outflow side of said valve 11, and the inflow side of said valves 10 and 12;
wherein said valve 13 comprises an inlet in fluid communication with said valve 12 and a valve 15, and further comprises an outlet in fluid communication with said boil kettle inlet;
wherein said valve 15 comprises an inlet in fluid communication with a pump 3, and further comprises an outlet in fluid communication with said valve 13;
a valve 16 comprising an inlet in fluid communication with said boil kettle outlet, and further comprising an outlet in fluid communication with said pump 3;
wherein said pump 3 disposed between the outflow side of said valve 16, and the inflow side of said valve 15;
a fermenter comprising a fermenter inlet, a fermenter outlet, and a means for fermenting beer wort with yeast;
a valve 17 comprising an inlet in fluid communication with said boil kettle outlet, and further comprising an outlet in fluid communication with said fermenter inlet;
a first T-connection comprising: (i) an inlet from the output of said pump 1, (ii) a first outlet to the input of said valve 2, and (iii) a second outlet to the input of said valve 6;
a second T-connection comprising: (i) a first inlet from the output of said valve 6, (ii) a second inlet from the output of said valve 10, (iii) an outlet to the input of said valve 8;
a third T-connection comprising: (i) an inlet from the output of said pump 2, (ii) a first outlet to the input of said valve 10, and (iii) a second outlet to the input of said valve 12;
a fourth T-connection comprising: (i) a first inlet from the output of said valve 12, (ii) a second inlet from the output of said valve 15 and (iii) an outlet to the input of said valve 13; and
a fifth T-connection comprising: (i) an inlet from the output of said boil kettle outlet, (ii) a first outlet to the input of said valve 17, and (iii) a second outlet to the input of said valve 16; wherein said hot liquor tank, mash tun, boil kettle, valves, direct heat sources, and pumps are all electrically interconnected to a power source.

18. An automated beer brewing system, comprising:
a hot liquor tank comprising a tank inlet and a tank outlet, wherein said hot liquor tank comprises a HLT to MT heat exchanger and comprises a means for heating liquid;
wherein said HLT to MT Heat Exchanger comprises a coil physically located inside said hot liquor tank and where the fluid-in and fluid-out connections to said coil are physically located outside said hot liquor tank, wherein said HLT to MT Heat Exchanger comprises a means for heating liquid;
a mash tun comprising a tun inlet and a tun outlet, wherein said mash tun optionally comprises a means for heating liquid;
a boil kettle comprising a kettle inlet and a kettle outlet, wherein said boil kettle comprises a means for heating liquid;
a fermenter comprising a fermenter inlet and a fermenter outlet, wherein said fermenter comprises a means for fermenting beer wort with yeast;
a water source, wherein said water source comprises a means for dispensing water;
a drain, wherein said drain comprises a means for draining liquid;
a chiller comprising a series of alternating plates containing counter-flow beer and water, wherein said chiller plates contain a means for heat exchange between said beer and said water without mixing said fluids;
a valve 3 comprising an inlet in fluid communication with said water source, and further comprising an outlet in fluid communication with a valve 2 and a valve 6;
wherein said valve 2 comprises an inlet in fluid communication with said valve 3 and a pump 1, and further comprises an outlet in fluid communication with a HLT Recirculation Flow Rate Restrictor;
wherein said HLT Recirculation Flow Rate Restrictor comprises an inlet in fluid communication with said valve 2, and further comprises an outlet in fluid communication with said hot liquor tank inlet;
wherein said valve 6 comprises an inlet in fluid communication with said valve 3 and said pump 1, and further comprises an outlet in fluid communication with a valve 9, a MT Recirculation Flow Rate Restrictor, and a bi-directional valve 10;
wherein said bi-directional valve 10 comprises an inlet in fluid communication with said valve 6, and further comprises an outlet in fluid communication with a bi-directional valve 12;
wherein said bi-directional valve 12 comprises an inlet in fluid communication with said bi-directional valve 10, and further comprises an outlet in fluid communication with a BK Recirculation Flow Rate Restrictor;
wherein said BK Recirculation Flow Rate Restrictor comprises an inlet in fluid communication with said bi-directional valve 12 and a valve 15, and further comprises an outlet in fluid communication with a valve 13;
wherein said valve 13 comprises an inlet in fluid communication with said BK Recirculation Flow Rate Restrictor, and further comprises an outlet in fluid communication with said boil kettle inlet;
a valve 4 comprising an inlet in fluid communication with said hot liquor tank outlet, and further comprising an outlet in fluid communication with said pump 1;
wherein said pump 1 disposed between the outflow side of said valve 4 and the inflow side of said valves 2 and 6;
wherein said valve 15 comprises an inlet in fluid communication with a pump 3, and further comprises an outlet in fluid communication with said BK Recirculation Flow Rate Restrictor and said bi-directional valve 12;
a valve 16 comprising an inlet in fluid communication with said alternating beer chiller plates, and further comprising an outlet in fluid communication with said pump 3;
wherein said alternating beer chiller plates are in fluid communication with said boil kettle outlet and a valve 17;
wherein said pump 3 disposed between the outflow side of said valve 16, and the inflow side of said valve 15;
wherein said valve 9 comprises an inlet in fluid communication with said valve 6 and said bi-directional valve 10, and further comprises an outlet in fluid communication with said mash tun outlet;
wherein said bi-directional valve 12 comprises an inlet in fluid communication with said valve 15, and further comprises an outlet in fluid communication with said bi-directional valve 10;
wherein said bi-directional valve 10 comprises an inlet in fluid communication with said bi-directional valve 12 and said pump 2, and further comprises an outlet in fluid communication with said valve 9 and a MT Recirculation Flow Rate Restrictor;
a valve 11 comprising an inlet in fluid communication with said mash tun outlet, and further comprising an outlet in fluid communication with a pump 2;
wherein said MT Recirculation Flow Rate Restrictor comprises an inlet in fluid-communication with said bi-directional valve 10, and further comprises an outlet in fluid communication with a valve 8;
wherein said valve 8 comprises an inlet in fluid communication with said MT Recirculation Flow Rate Restrictor, and further comprises an outlet in fluid communication with said HLT to MT Heat Exchanger fluid-in connector;
wherein said HLT to MT Heat Exchanger fluid-out connector is in fluid communication with said mash tun inlet;
wherein said MT to BK Sparge Flow Rate Restrictor comprises an inlet in fluid communication with said bi-directional valve 12, and further comprises an outlet in fluid communication with a valve 14;
wherein said valve 14 comprises an inlet in fluid communication with said MT to BK Sparge Flow Rate Restrictor, and further comprises an outlet in fluid communication with said boil kettle inlet;
wherein said HLT to MT Sparge Flow Rate Restrictor comprises an inlet in fluid communication with said valve 6, and further comprises an outlet in fluid communication with a valve 7;
wherein said valve 7 comprises an inlet in fluid communication with said HLT to MT Sparge Flow Rate Restrictor, and further comprises an outlet in fluid communication with said HLT to MT Heat Exchanger fluid-in connector;
a valve 5 comprising an inlet in fluid communication with said water source, and further comprising an outlet in fluid communication with said alternating water chiller plates;
wherein said alternating water chiller plates are in fluid communication with said drain;
wherein said valve 17 comprises an inlet in fluid communication with said alternating beer chiller plates, and further comprises an outlet in fluid communication with said fermenter inlet;
wherein said pump 2 disposed between the outflow side of said valve 11 and the inflow side of said bi-directional valves 12 and 10;
a first T-connection comprising: (i) an inlet from the output of said water source, (ii) a first outlet to the input of said valve 3, and (iii) a second outlet to the input of said valve 5;
a second T-connection comprising: (i) an inlet from the output of said pump 2, (ii) a first outlet to the input of said bi-directional valve 10, and (iii) a second outlet to the input of said bi-directional valve 12;
a third T-connection comprising: (i) an inlet from the output of said alternating beer chiller plates, (ii) a first outlet to the input of said valve 17, and (iii) a second outlet to the input of said valve 16;
a fourth T-connection comprising: (i) a first inlet from the output of said valve 7, (ii) a second inlet from the output of said valve 8, and (iii) an outlet to the input of said HLT to MT Heat Exchanger fluid-in connector;
a fifth T-connection comprising: (i) a first inlet from the output of said valve 13, (ii) a second inlet from the output of said valve 14, and (iii) an outlet to the input of said boil kettle inlet;
a sixth T-connection comprising: (i) a first inlet from the output of said valve 15, (ii) a second inlet from the output of said bi-directional valve 12, and (iii) a first outlet to the input of a seventh T-connection;
a seventh T-connection comprising: (i) an inlet from the output of said sixth T-connection, (ii) a first outlet to the input of said BK Recirculation Flow Rate Restrictor, and (iii) a second outlet to the input of said MT to BK Sparge Flow Rate Restrictor;
an eighth T-connection comprising: (i) an inlet from the output of said bi-directional valve 10, (ii) a second inlet from the output of said valve 6, and (iii) an outlet to the input of a first four-way connection;
a first four-way connection comprising: (i) an inlet from the output of said eighth T-connection, (ii) a first outlet to the input of said HLT to MT Sparge Flow Rate Restrictor, (ii) a second outlet to the input of said MT Recirculation Flow Rate Restrictor, and (iii) a third outlet to the input of said valve 9;
a ninth T-connection comprising (i) a bi-directional connection to said mash tun outlet, (ii) an outlet to the input of said valve 11; and (iii) an inlet from the output of said valve 9; and
a second four-way connection comprising: (i) a first inlet from the output of said valve 3, (ii) a second inlet from the output of said pump 1, (ii) a first outlet to the input of said valve 2, and (iii) a second outlet to the input of said valve 6;
wherein said hot liquor tank, mash tun, boil kettle, valves, flow-rate restrictors, heat exchanger, water source, direct heat sources, chiller, drain, and pumps are all electrically interconnected to a power source.

19. The automatic beer brewing system according to claim 18, wherein:
said water source is on;
said valve 3 is open, providing a fluid flow path from said water source to said inlet of valve 2;
said valve 2 is open, providing a fluid flow path from said outlet of valve 2 to said inlet of the HLT Recirculation Flow Rate Restrictor;
said HLT Recirculation Flow Rate Restrictor is open, providing a fluid flow path from said outlet of the HLT Recirculation Flow Rate Restrictor to said hot liquor tank inlet; and
said valves 4, 5, 6, 7, 8, 9, 10, 11, 12, 13, 14, 15, 16, and 17 are closed, said MT Recirculation, BK Recirculation, HLT to MT Sparge, and MT to BK Sparge Flow Rate Restrictors are not in use, and said pumps 1, 2, and 3 are off, providing a non-recirculating fluid flow path from said water source to said hot liquor tank inlet.

20. The automatic beer brewing system according to claim 18, wherein:
said water source is on;
said valve 3 is open, providing a fluid flow path from said water source to said inlet of valve 6;
said valve 6 is open, providing a fluid flow path from said outlet of valve 6 to said inlet of bi-directional valve 10;
said bi-directional valve 10 is open, providing a fluid flow path from said outlet of bi-directional valve 10 to said inlet of bi-directional valve 12;
said bi-directional valve 12 is open, providing a fluid flow path from said outlet of bi-directional valve 12 to said inlet of the BK Recirculation Flow Rate Restrictor;
said BK Recirculation Flow Rate Restrictor is open, providing a fluid flow path from said outlet of the BK Recirculation Flow Rate Restrictor to said inlet of valve 13;
said valve 13 is open, providing a fluid flow path from said outlet of valve 13 to said boil kettle inlet;
said valves 2, 4, 5, 7, 8, 9, 11, 14, 15, 16, and 17 are closed, said HLT Recirculation, MT Recirculation, HLT to MT Sparge, and MT to BK Sparge Flow Rate Restrictors are not in use, and said pumps 1, 2, and 3 are off, providing a non-recirculating fluid flow path from said water source to said boil kettle inlet.

21. The automatic beer brewing system according to claim 18, wherein:
said valve 4 is open, providing a fluid flow path from said hot liquor tank outlet to pump 1;
said pump 1 pumps said liquid to said inlet of valve 2;
said valve 2 is open, providing a fluid flow path from said outlet of valve 2 to said inlet of the HLT Recirculation Flow Rate Restrictor;
said HLT Recirculation Flow Rate Restrictor is open, providing a fluid flow path from said outlet of the HLT Recirculation Flow Rate Restrictor to said hot liquor tank inlet; and
said valves 3, 5, 6, 7, 8, 9, 10, 11, 12, 13, 14, 15, 16, and 17 are closed, said MT Recirculation, BK Recirculation, HLT to MT Sparge, and MT to BK Sparge Flow Rate Restrictors are not in use, and said pumps 2 and 3 are off, providing a recirculating fluid flow path from said hot liquor tank outlet to said hot liquor tank inlet.

22. The automatic beer brewing system according to claim 18, wherein:
said counter-flow water chiller plates are in fluid communication with said boil kettle outlet and said inlet of valve 16;
said valve 16 is open, providing a fluid flow path from said counter-flow water chiller plates to said pump 3;
said pump 3 pumps said liquid to said inlet of valve 15;
said valve 15 is open, providing a fluid flow path from said outlet of valve 15 to said inlet of the BK Recirculation Flow Rate Restrictor;
said BK Recirculation Flow Rate Restrictor is open, providing a fluid flow path from said outlet of the BK Recirculation Flow Rate Restrictor to said inlet of valve 13;
said valve 13 is open, providing a fluid flow path from said outlet of valve 13 to said boil kettle inlet;
said valves 2, 3, 4, 5, 6, 7, 8, 9, 10, 11, 12, 14, and 17 are closed, said HLT Recirculation, MT Recirculation, HLT to MT Sparge, and MT to BK Sparge Flow Rate Restrictors are not in use, and said pumps 1 and 2 are off, providing a recirculating fluid flow path from said boil kettle outlet to said boil kettle inlet.

23. The automatic beer brewing system according to claim 18, wherein:
said valve 4 is open, providing a fluid flow path from said hot liquor tank outlet to said pump 1;
said pump 1 pumps said liquid to said inlet of valve 6;
said valve 6 is open, providing a fluid flow path from said outlet of valve 6 to said inlet of valve 9;
said valve 9 is open, providing a fluid flow path from said outlet of valve 9 to said mash tun outlet; and
said valves 2, 3, 5, 7, 8, 10, 11, 12, 13, 14, 15, 16, and 17 are closed, said HLT Recirculation, MT Recirculation, BK Recirculation, HLT to MT Sparge, and MT to BK Sparge Flow Rate Restrictors are not in use, and said pumps 2 and 3 are off, providing a non-recirculating fluid flow path from said hot liquor tank outlet to said mash tun outlet.

24. The automatic beer brewing system according to claim 18, wherein:
said counter-flow water chiller plates are in fluid communication with said boil kettle outlet and said inlet of valve 16;
said valve 16 is open, providing a fluid flow path from said counter-flow water chiller plates to said pump 3;
said pump 3 pumps said liquid to said inlet of valve 15;
said valve 15 is open, providing a fluid flow path from said outlet of valve 15 to said inlet of bi-directional valve 12;
said bi-directional valve 12 is open, providing a fluid flow path from said outlet of valve 12 to said inlet of bi-directional valve 10;
said bi-directional valve 10 is open, providing a fluid flow path from said outlet of bi-directional valve 10 to said inlet of valve 9;
said valve 9 is open, providing a fluid flow path from said outlet of valve 9 to said mash tun outlet; and
said valves 2, 3, 4, 5, 6, 7, 8, 11, 13, 14, and 17 are closed, said HLT Recirculation, MT Recirculation, BK Recirculation, HLT to MT Sparge, and MT to BK Sparge Flow Rate Restrictors are not in use, and said pumps 1 and 2 are off, providing a non-recirculating fluid flow path from said boil kettle outlet to said mash tun outlet.

25. The automatic beer brewing system according to claim 18, wherein:
said valve 3 is open, providing a fluid flow path from said water source to said inlet of valve 2;
said valve 4 is open, providing a fluid flow path from said hot liquor tank outlet to pump 1;
said pump 1 pumps said liquid to said inlet of valve 2;
said valve 2 is open, providing a fluid flow path from said outlet of valve 2 to said inlet of the HLT Recirculation Flow Rate Restrictor;
said HLT Recirculation Flow Rate Restrictor is open, providing a fluid flow path from said outlet of the HLT Recirculation Flow Rate Restrictor to said hot liquor tank inlet; and
said valves 5, 6, 7, 8, 9, 10, 11, 12, 13, 14, 15, 16, and 17 are closed, said MT Recirculation, BK Recirculation, HLT to MT Sparge, and MT to BK Sparge Flow Rate Restrictors are not in use, and said pumps 2 and 3 are off, providing a first non-recirculating fluid flow path from said water source to said hot liquor tank inlet, and a second recirculating fluid flow path from said hot liquor outlet to said hot liquor tank inlet.

26. The automatic beer brewing system according to claim 18, wherein:
said valve 4 is open, providing a fluid flow path from said hot liquor tank outlet to pump 1;
said pump 1 pumps said liquid to said inlet of valve 2;
said valve 2 is open, providing a fluid flow path from said outlet of valve 2 to said inlet of the HLT Recirculation Flow Rate Restrictor;
said HLT Recirculation Flow Rate Restrictor is open, providing a fluid flow path from said outlet of the HLT Recirculation Flow Rate Restrictor to said hot liquor tank inlet;
said valve 11 is open, providing a fluid flow path from said mash tun outlet to said pump 2;
said pump 2 pumps said liquid to said inlet of bi-directional valve 10;
said bi-directional valve 10 is open, providing a fluid flow path from said outlet of bi-directional valve 10 to said inlet of the MT Recirculation Flow Rate Restrictor;
said MT Recirculation Flow Rate Restrictor is open, providing a fluid flow path from said outlet of the MT Recirculation Flow Rate Restrictor to said inlet of valve 8;
said valve 8 is open, providing a fluid flow path from said outlet of valve 8 to said HLT to MT Heat Exchanger fluid-in connector;
said HLT to MT Heat Exchanger fluid-in connector is in fluid communication with said HLT to MT Heat Exchanger fluid-out connector, providing a fluid flow path from said HLT to MT Heat Exchanger fluid-in connector to said mash tun inlet; and
said valves 3, 5, 6, 7, 9, 12, 13, 14, 15, 16, and 17 are closed, said BK Recirculation, HLT to MT Sparge, and MT to BK Sparge Flow Rate Restrictors are not in use, and said pump 3 is off, providing a first recirculating fluid flow path from said hot liquor tank outlet to said hot liquor tank inlet, and a second recirculating fluid flow path from said mash tun outlet to said mash tun inlet.

27. The automatic beer brewing system according to claim 18, wherein:
said valve 4 is open, providing a fluid flow path from said hot liquor tank outlet to said pump 1;
said pump 1 pumps said liquid to said inlet of valve 6;
said valve 6 is open, providing a fluid flow path from said outlet of valve 6 to said inlet of the HLT to MT Sparge Flow Rate Restrictor;
said HLT to MT Sparge Flow Rate Restrictor is open, providing a fluid flow path from said outlet of the HLT to MT Sparge Flow Rate Restrictor to said inlet of valve 7;
said valve 7 is open, providing a fluid flow path from said outlet of valve 7 to said HLT to MT Heat Exchanger fluid-in connector;
said HLT to MT Heat Exchanger fluid-in connector is in fluid communication with said HLT to MT Heat Exchanger fluid-out connector, providing a fluid flow path from said HLT to MT Heat Exchanger fluid-in connector to said mash tun inlet;
said valve 11 is open, providing a fluid flow path from said mash tun outlet to said pump 2;
said pump 2 pumps said liquid to said inlet of bi-directional valve 12;
said bi-directional valve 12 is open, providing a fluid flow path from said outlet of bi-directional valve 12 to said inlet of the MT to BK Sparge Flow Rate Restrictor;
said MT to BK Sparge Flow Rate Restrictor is open, providing a fluid flow path from said outlet of the MT to BK Sparge Flow Rate Restrictor to said inlet of valve 14;
said valve 14 is open, providing a fluid flow path from said outlet of valve 14 to said boil kettle inlet; and
said valves 2, 3, 5, 8, 9, 10, 13, 15, 16, and 17 are closed, said HLT Recirculation, MT Recirculation, and BK Recirculation Flow Rate Restrictors are not in use, and said pump 3 is off, providing a first non-recirculating fluid flow path from said hot liquor tank outlet to said mash tun inlet, and a second non-recirculating fluid flow path from said mash tun outlet to said boil kettle inlet.

28. The automatic beer brewing system according to claim 18, wherein:
said counter-flow beer chiller plates are in fluid communication with said boil kettle outlet and said inlet of valve 16;
said valve 16 is open, providing a fluid flow path from said counter-flow beer chiller plates to said pump 3;
said pump 3 pumps said liquid to said inlet of valve 15;
said valve 15 is open, providing a fluid flow path from said outlet of valve 15 to said inlet of the BK Recirculation Flow Rate Restrictor;
said BK Recirculation Flow Rate Restrictor is open, providing a fluid flow path from said outlet of the BK Recirculation Flow Rate Restrictor to said inlet of valve 13;
said valve 13 is open, providing a fluid flow path from said outlet of valve 13 to said boil kettle inlet;
said valves 2, 3, 4, 5, 6, 7, 8, 9, 10, 11, 12, 14, and 17 are closed, said HLT Recirculation, MT Recirculation, HLT to MT Sparge, and MT to BK Sparge Flow Rate Restrictors are not in use, and said pumps 1 and 2 are off, providing a recirculating fluid flow path from said boil kettle outlet to said boil kettle inlet.

29. The automatic beer brewing system according to claim 18, wherein:
said counter-flow beer chiller plates are in fluid communication with said boil kettle outlet and said inlet of valve 16;
said valve 16 is open, providing a fluid flow path from said counter-flow beer chiller plates to said pump 3;
said pump 3 pumps said liquid to said inlet of valve 15;
said valve 15 is open, providing a fluid flow path from said outlet of valve 15 to said inlet of the BK Recirculation Flow Rate Restrictor;
said BK Recirculation Flow Rate Restrictor is open, providing a fluid flow path from said outlet of the BK Recirculation Flow Rate Restrictor to said inlet of valve 13;
said valve 13 is open, providing a fluid flow path from said outlet of valve 13 to said boil kettle inlet;
said water source is on;
said valve 5 is open, providing a fluid flow path from said outlet of valve 5 to said counter-flow water chiller plates;
said counter-flow water chiller plates are in fluid communication with said drain, providing a fluid flow path from said counter-flow water chiller plates to said drain; and
said valves 2, 3, 4, 6, 7, 8, 9, 10, 11, 12, 14, and 17 are closed, said HLT Recirculation, MT Recirculation, HLT to MT Sparge, and MT to BK Sparge Flow Rate Restrictors are not in use, said pumps 1 and 2 are off, providing a first recirculating fluid flow path from said boil kettle outlet to said boil kettle inlet, and a second non-recirculating fluid flow path from said water source to said drain.

30. The automatic beer brewing system according to claim 18, wherein:
said valve 17 is open, providing a fluid flow path from said boil kettle outlet to said inlet of valve 17; and
said valves 2, 3, 4, 5, 6, 7, 8, 9, 10, 11, 12, 13, 14, 15, and 16 are closed, said HLT Recirculation, MT Recirculation, BK Recirculation, HLT to MT Sparge, and MT to BK Sparge Flow Rate Restrictors are not in use, and said pumps 1, 2, and 3 are off, providing a non-recirculating fluid flow path from said boil kettle outlet to said fermenter inlet.

31. The automated beer brewing system according to any one of claim 1, claim 2, claim 17, and claim 18 wherein said heating means is selected from a heat exchanger, electric heating element, direct fire, steam, and glycol heat.

32. The automated beer brewing system according to any one of claim 1, claim 2, claim 17, and claim 18 wherein said heat exchanger is selected from: a counter-flow plate heat exchanger, a counter-flow coil heat exchanger, and an external heat exchanger.

33. The automated beer brewing system according to any one of claim 1, claim 2, claim 17, and claim 18 further comprising a remote control device wherein operation of the device requires no further human intervention after the initial device setup.
